(19) United States
(12) Patent Application Publication
(10) Pub. No.: US 2017/0054770 A1
(43) Pub. Date: Feb. 23, 2017

(54) MULTIMEDIA TELECONFERENCE STREAMING ARCHITECTURE BETWEEN HETEROGENEOUS COMPUTER SYSTEMS

(71) Applicant: One Touch Brands, Fairlawn, OH (US)

(72) Inventors: Carrie Chitsey Wells, Fairlawn, OH (US); Kacy Wells, Fairlawn, OH (US)

(73) Assignee: TORNADITECH LLC, FAIRLAWN, OH (US)

(21) Appl. No.: 14/833,141

(22) Filed: Aug. 23, 2015

(51) Int. Cl. H04L 29/06; H04L 29/08

(52) U.S. Cl. CPC H04L 65/403; H04L 65/60; H04L 65/608; H04L 65/1006; H04L 67/2842

(57) ABSTRACT

In one implementation, an apparatus includes a detector of capabilities of each of heterogeneous computing systems, the capabilities including a model, existence of a microphone, video controls, specifications of a camera, a processor speed, a bus speed, an amount of cache memory, an amount of non-cache memory, a telecom carrier and an operating system, a determiner of the minimum sufficiency of the capabilities of the each of the heterogeneous computing systems; the determiner being operably coupled to the detector, the determiner being operable to set a state in a memory location indicating an affirmative or a negative state of the minimum sufficiency of the capabilities of the each of the heterogeneous computing systems, and an initiator of a multimedia teleconference between the heterogeneous computing systems, the initiator being operably coupled to the determiner, the initiator being operable to initiate the multimedia teleconference in reference to the memory location indicating an affirmative or a negative state of the minimum sufficiency of the capabilities of the each of the heterogeneous computing systems.

### FIELD

This invention relates generally to an architecture of multimedia exchange between computer systems, and more particularly to managing status of multimedia data between heterogeneous computer systems.

### BACKGROUND

In the current environment of ubiquitous computing between heterogeneous smartphones, tablets and personal computers, the heterogeneous computing systems have significant differences in all capabilities, including differences in operating systems, screen devices, carriers and performance of the hardware that can have significantly detrimental effects on the data interaction between the computing systems. One prior technique of data interchange is exchange of email between computers, using standard email protocols such as in Internet standards RFC 5321 and RFC 5322, and extensions such RFC 6531. While email is quite a bit faster and more interactive than snail mail or overnight delivery of documents, email seems slow and ponderous in a real-time world.

### BRIEF DESCRIPTION

In one aspect, an apparatus includes a detector of capabilities of each of heterogeneous computing systems, the capabilities including a model, existence of a microphone, video controls, specifications of a camera, a processor speed, a bus speed, an amount of cache memory, an amount of non-cache memory, a telecom carrier and an operating system, a determiner of the minimum sufficiency of the capabilities of the each of the heterogeneous computing systems; the determiner being operably coupled to the detector, the determiner being operable to set a state in a memory location indicating an affirmative or a negative state of the minimum sufficiency of the capabilities of the each of the heterogeneous computing systems, and an initiator of a multimedia teleconference between the heterogeneous computing systems, the initiator being operably coupled to the determiner, the initiator being operable to initiate the multimedia teleconference in reference to the memory location indicating an affirmative or a negative state of the minimum sufficiency of the capabilities of the each of the heterogeneous computing systems.

Apparatus, systems, and methods of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a block diagram of an overview of a system of multimedia streaming between heterogeneous computer systems, according to an implementation.

FIG. 2 is a block diagram of an apparatus of multimedia streaming between heterogeneous computer systems, according to a first implementation.

FIG. 3 is a block diagram of apparatus of multimedia streaming between heterogeneous computer systems, according to a second implementation.

FIG. 4 is a block diagram of apparatus of multimedia streaming between heterogeneous computer systems, according to a third implementation.

FIG. 5 is a block diagram of apparatus of multimedia streaming between heterogeneous computer systems, according to a fourth implementation.

FIG. 6 is a block diagram of apparatus of multimedia streaming between heterogeneous computer systems, according to a fifth implementation.

FIG. 7 is a block diagram of apparatus of multimedia streaming between heterogeneous computer systems, according to a sixth implementation.

FIG. 8 is a block diagram of apparatus of multimedia streaming between heterogeneous computer systems, according to a seventh implementation.

FIG. 9 is a block diagram of apparatus of multimedia streaming between heterogeneous computer systems, according to an eighth implementation.

FIG. 10 is a block diagram of apparatus of multimedia streaming between heterogeneous computer systems, according to a ninth implementation.

FIG. 11 is a flowchart of a method of multimedia streaming between heterogeneous computer systems, according to an implementation.

FIG. 12 is a flowchart of a method of multimedia streaming between heterogeneous computer systems, according to a first implementation.

FIG. 13 is a flowchart of a method of multimedia streaming between heterogeneous computer systems, according to a second implementation.

FIG. 14 is a flowchart of a method of multimedia streaming between heterogeneous computer systems, according to a third implementation.

FIG. 15 is a flowchart of a method of multimedia streaming between heterogeneous computer systems, according to a fourth implementation.

FIG. 16 is a flowchart of a method of multimedia streaming between heterogeneous computer systems, according to a fifth implementation.

FIG. 17 is a flowchart of a method of multimedia streaming between heterogeneous computer systems, according to a sixth implementation.

FIG. 18 is a flowchart of a method of multimedia streaming between heterogeneous computer systems, according to a seventh implementation.

FIG. 19 is a flowchart of a method of multimedia streaming between heterogeneous computer systems, according to an eighth implementation.

FIG. 20 is a flowchart of a method of management of multimedia teleconference consultation(s), according to a first implementation.

FIG. 21 is a flowchart of a method of management of multimedia teleconference consultation(s), according to a second implementation.

FIG. 22 is a flowchart of a method of management of multimedia teleconference consultation(s), according to a third implementation.

FIG. 23 is a flowchart of a method of management of multimedia teleconference consultation(s), according to a fourth implementation.

FIG. 24 is a flowchart of a method of management of multimedia teleconference consultation(s), according to a fifth implementation.

FIG. 25 is a flowchart of a method of management of multimedia teleconference consultation(s), according to a sixth implementation.

FIG. 26 is a flowchart of a method of management of multimedia teleconference consultation(s), according to a seventh implementation.

FIG. 27 is a flowchart of a method of management of multimedia teleconference consultation(s), according to an eighth implementation.

FIG. 28 is a flowchart of a method of management of multimedia teleconference consultation(s), according to a ninth implementation.

FIG. 29 is a user-flow diagram of multimedia streaming between heterogeneous computer systems, according to a first implementation.

FIG. 30 is a user-flow diagram of multimedia streaming between heterogeneous computer systems, according to a second implementation.

FIG. 31 is a user-flow diagram of multimedia streaming between heterogeneous computer systems, according to a third implementation.

FIG. 32 is a user-flow diagram of multimedia streaming between heterogeneous computer systems, according to a fourth implementation.

FIG. 33 is a user-flow diagram of multimedia streaming between heterogeneous computer systems, according to a fifth implementation.

FIG. 34 is a user-flow diagram of multimedia streaming between heterogeneous computer systems, according to a sixth implementation.

FIG. 35 is a user-flow diagram of multimedia streaming between heterogeneous computer systems, according to a seventh implementation.

FIG. 36 is a user-flow diagram of multimedia streaming between heterogeneous computer systems, according to an eighth implementation.

FIG. 37 is a user-flow diagram of multimedia streaming between heterogeneous computer systems, according to a ninth implementation.

FIG. 38 is a block diagram of a hand-held device, according to an implementation.

FIG. 39 illustrates an example of a computer environment that implements the processes and components in FIGS. 1-37, according to an implementation.

FIG. 40 is a block diagram of the communication subsystem that implements the processes and components in FIGS. 1-37, according to an implementation.

FIG. 41 illustrates an example of a tablet computer that implements the processes and components in FIGS. 1-37, in accordance with an implementation.

### DETAILED DESCRIPTION

In the following detailed description, reference is made to the accompanying drawings that form a part hereof, and in which is shown by way of illustration specific implementations which may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

The detailed description is divided into seven sections. In the first section, an overview is shown. In the second section, apparatus of multimedia teleconference protocols between heterogeneous computer systems is described. In the third section, apparatus of multimedia streaming between heterogeneous computer systems are described. In the fourth section, methods of multimedia streaming between heterogeneous computer systems are described. In the fifth section, user flow diagrams of multimedia streaming between heterogeneous computer systems are described. In the sixth section, hardware and operating environments of the multimedia streaming between heterogeneous computer systems are described. In the seventh section, a conclusion of the detailed description is provided.

### 1. OVERVIEW

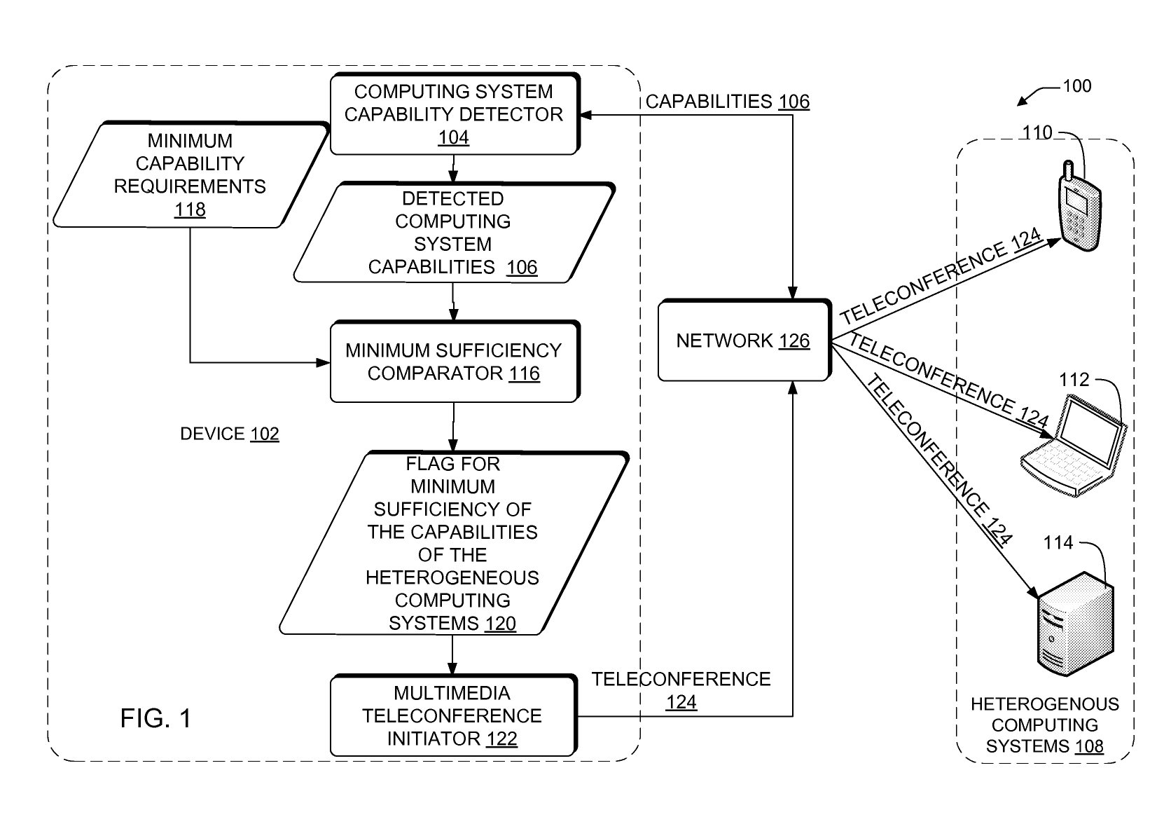

FIG. 1 is a block diagram of an overview of a system 100 of multimedia streaming between heterogeneous computer systems, according to an implementation.

The system 100 of multimedia streaming between heterogeneous computer systems includes a device 102. The device 102 includes a detector 104 of a plurality of capabilities 106 of each of a plurality of heterogeneous computing systems 108. The plurality of capabilities 106 of each of the plurality of heterogeneous computing systems 108 includes information describing or representative of a model, existence of a microphone/audio controls, (given that the speaker for video and in-ear for audio are different calls), video controls, specifications of a camera, a processor speed, a bus speed, an amount of cache memory, an amount of non-cache memory, a telecom carrier and an operating system of each of the plurality of capabilities 106 of each of the plurality of heterogeneous computing systems 108.

The device 102 also includes a minimum sufficiency determiner 116 of the plurality of capabilities 106 of the each of the plurality of heterogeneous computing systems 108. The minimum sufficiency determiner 116 determines whether the capabilities at least meet minimum sufficiency requirements 118. The minimum sufficiency determiner 116 is operably coupled to the detector 104. The minimum sufficiency determiner 116 can set a state in a memory location 120 indicating an affirmative or a negative state of the minimum sufficiency of the plurality of capabilities 106 of the each of the plurality of heterogeneous computing systems 108. Examples of the heterogeneous computing systems 108 include a smartphone 110, a tablet computer 112 and a desktop computer 114.

### 2. APPARATUS OF MULTIMEDIA TELECONFERENCE PROTOCOLS BETWEEN HETEROGENEOUS COMPUTER SYSTEMS

A multimedia teleconference 122 initiates a multimedia teleconference 124 between the heterogeneous computing systems 108 over a network 126. The multimedia teleconference 122 is operably coupled to the heterogeneous computing systems 108 and the minimum sufficiency determiner 116. The multimedia teleconference 124 is operable to initiate the multimedia teleconference 124 via Session Initiation Protocol (SIP) in reference to the memory location 120 indicating an affirmative or a negative state of the minimum sufficiency of the plurality of capabilities of the each of the plurality of heterogeneous computing systems 108. In some implementations, the multimedia teleconference 124 is selected from a group consisting of a teleconference in conformity with an MPEG standard and a teleconference in conformance with a VOIP standard, in reference to the in reference to the memory location 120 indicating an affirmative or a negative state of the minimum sufficiency of the plurality of capabilities of the each of the plurality of heterogeneous computing systems 108.

The multimedia teleconference 124 of FIG. 1 involves conducting a teleconference over the Internet or another wide Area network. One key technology in multimedia teleconferencing is the voice over internet protocol (VOIP).

Voice over IP (VoIP) is a methodology and group of technologies for the delivery of voice communications and multimedia sessions over Internet Protocol (IP) networks, such as the Internet. Other terms commonly associated with VoIP are IP telephony, Internet telephony, broadband telephony, and broadband phone service.

The term Internet telephony specifically refers to the provisioning of communications services (voice, fax, SMS, voice-messaging) over the public Internet, rather than via the public switched telephone network (PSTN). The steps and principles involved in originating VoIP telephone calls are similar to traditional digital telephony and involve signaling, channel setup, digitization of the analog voice signals, and encoding. Instead of being transmitted over a circuit-switched network, however, the digital information is packetized, and transmission occurs as IP packets over a packet-switched network. Such transmission entails careful considerations about resource management different from time-division multiplexing (TDM) networks.

Protocols of VOIP. Voice over IP has been implemented in various ways using both proprietary protocols and protocols based on open standards. Examples of the VoIP protocols include H.323, Media Gateway Control Protocol (MGCP), Session Initiation Protocol (SIP), H.248 (also known as Media Gateway Control (Megaco)), Real-time Transport Protocol (RTP), Real-time Transport Control Protocol (RTCP), Secure Real-time Transport Protocol (SRTP), Session Description Protocol (SDP), Inter-Asterisk eXchange (IAX), Jingle XMPP VoIP extensions, Skype protocol and TeamSpeak

### H.323

H.323 is a recommendation from the ITU Telecommunication Standardization Sector (ITU-T) that defines the protocols to provide audio-visual communication sessions on any packet network. The H.323 standard addresses call signaling and control, multimedia transport and control, and bandwidth control for point-to-point and multi-point conferences.

H.323 is widely implemented by voice and videoconferencing equipment manufacturers, is used within various Internet real-time applications such as GnuGK and NetMeeting and is widely deployed worldwide by service providers and enterprises for both voice and video services over IP networks.

H.323 is a part of the ITU-T H.32x series of protocols, which also address multimedia communications over ISDN, the PSTN or SS7, and 3G mobile networks.

H.323 call signaling is based on the ITU-T Recommendation Q.931 protocol and is suited for transmitting calls across networks using a mixture of IP, PSTN, ISDN, and QSIG over ISDN. A call model, similar to the ISDN call model, eases the introduction of IP telephony into existing networks of ISDN-based PBX systems, including transitions to IP-based PBXs.

Within the context of H.323, an IP-based PBX might be a gatekeeper or other call control element which provides service to telephones or videophones. Such a device may provide or facilitate both basic services and supplementary services, such as call transfer, park, pick-up, and hold.

H.323 is a system specification that describes the use of several ITU-T and IETF protocols. The protocols that comprise the core of almost any H.323 system are:

H.225.0 Registration, Admission and Status (RAS), which is used between an H.323 endpoint and a Gatekeeper to provide address resolution and admission control services.

H.225.0 Call Signaling, which is used between any two H.323 entities in order to establish communication (Based on Q.931).

H.245 control protocol for multimedia communication, which describes the messages and procedures used for capability exchange, opening and closing logical channels for audio, video and data, control and indications.

Real-time Transport Protocol (RTP), which is used for sending or receiving multimedia information (voice, video, or text) between any two entities.

Many H.323 systems also implement other protocols that are defined in various ITU-T Recommendations to provide supplementary services support or deliver other functionality to the user. Some of those Recommendations are:

H.235 series describes security within H.323, including security for both signaling and media.

H.239 describes dual stream use in videoconferencing, usually one for live video, the other for still images.

H.450 series describes various supplementary services.

H.460 series defines optional extensions that might be implemented by an endpoint or a Gatekeeper, including ITU-T Recommendations H.460.17, H.460.18, and H.460.19 for Network address translation (NAT)/Firewall (FW) traversal.

In addition to those ITU-T Recommendations, H.323 implements various IETF Request for Comments (RFCs) for media transport and media packetization, including the Real-time Transport Protocol (RTP).

H.323 utilizes both ITU-defined codecs and codecs defined outside the ITU. Codecs that are widely implemented by H.323 equipment include:

Audio codecs: G.711, G.729 (including G.729a), G.723.1, G.726, G.722, G.728, Speex, AAC-LD

Text codecs: T.140

Video codecs: H.261, H.263, H.264

All H.323 terminals providing video communications shall be capable of encoding and decoding video according to H.261 QCIF. All H.323 terminals shall have an audio codec and shall be capable of encoding and decoding speech according to ITU-T Rec. G.711. All terminals shall be capable of transmitting and receiving A-law and μ-law. Support for other audio and video codecs is optional.

The H.323 system defines several network elements that work together in order to deliver rich multimedia communication capabilities. Those elements are Terminals, Multipoint Control Units (MCUs), Gateways, Gatekeepers, and Border Elements. Collectively, terminals, multipoint control units and gateways are often referred to as endpoints.

While not all elements are required, at least two terminals are required in order to enable communication between two people. In most H.323 deployments, a gatekeeper is employed in order to, among other things, facilitate address resolution.

Terminals in an H.323 network are the most fundamental elements in any H.323 system, as those are the devices that users would normally encounter. They might exist in the form of a simple IP phone or a powerful high-definition videoconferencing system.

Inside an H.323 terminal is something referred to as a Protocol stack, which implements the functionality defined by the H.323 system. The protocol stack would include an implementation of the basic protocol defined in ITU-T Recommendation H.225.0 and H.245, as well as RTP or other protocols described above.

A Multipoint Control Unit (MCU) is responsible for managing multipoint conferences and is composed of two logical entities referred to as the Multipoint Controller (MC) and the Multipoint Processor (MP). In more practical terms, an MCU is a conference bridge not unlike the conference bridges used in the PSTN today. The most significant difference, however, is that H.323 MCUs might be capable of mixing or switching video, in addition to the normal audio mixing done by a traditional conference bridge. Some MCUs also provide multipoint data collaboration capabilities. What this means to the end user is that, by placing a video call into an H.323 MCU, the user might be able to see all of the other participants in the conference, not only hear their voices.

Gateways are devices that enable communication between H.323 networks and other networks, such as PSTN or ISDN networks. If one party in a conversation is utilizing a terminal that is not an H.323 terminal, then the call must pass through a gateway in order to enable both parties to communicate.

Gateways are widely used today in order to enable the legacy PSTN phones to interconnect with the large, international H.323 networks that are presently deployed by services providers. Gateways are also used within the enterprise in order to enable enterprise IP phones to communicate through the service provider to users on the PSTN.

Gateways are also used in order to enable videoconferencing devices based on H.320 and H.324 to communicate with H.323 systems. Most of the third generation (3G) mobile networks deployed today utilize the H.324 protocol and are able to communicate with H.323-based terminals in corporate networks through such gateway devices.

A Gatekeeper is an optional component in the H.323 network that provides a number of services to terminals, gateways, and MCU devices. Those services include endpoint registration, address resolution, admission control, user authentication, and so forth. Of the various functions performed by the gatekeeper, address resolution is the most important as it enables two endpoints to contact each other without either endpoint having to know the IP address of the other endpoint.

Gatekeepers may be designed to operate in one of two signaling modes, namely “direct routed” and “gatekeeper routed” mode. Direct routed mode is the most efficient and most widely deployed mode. In this mode, endpoints utilize the RAS protocol in order to learn the IP address of the remote endpoint and a call is established directly with the remote device. In the gatekeeper routed mode, call signaling always passes through the gatekeeper. While the latter requires the gatekeeper to have more processing power, it also gives the gatekeeper complete control over the call and the ability to provide supplementary services on behalf of the endpoints.

H.323 endpoints use the RAS protocol to communicate with a gatekeeper. Likewise, gatekeepers use RAS to communicate with other gatekeepers.

A collection of endpoints that are registered to a single Gatekeeper in H.323 is referred to as a “zone”. This collection of devices does not necessarily have to have an associated physical topology. Rather, a zone may be entirely logical and is arbitrarily defined by the network administrator.

Gatekeepers have the ability to neighbor together so that call resolution can happen between zones. Neighboring facilitates the use of dial plans such as the Global Dialing Scheme. Dial plans facilitate “inter-zone” dialing so that two endpoints in separate zones can still communicate with each other.

Border Elements and Peer Elements are optional entities similar to a Gatekeeper, but that does not manage endpoints directly and provide some services that are not described in the RAS protocol. The role of a border or peer element is understood via the definition of an “administrative domain”.

An administrative domain is the collection of all zones that are under the control of a single person or organization, such as a service provider. Within a service provider network there may be hundreds or thousands of gateway devices, telephones, video terminals, or other H.323 network elements. The service provider might arrange devices into “zones” that enable the service provider to best manage all of the devices under its control, such as logical arrangement by city. Taken together, all of the zones within the service provider network would appear to another service provider as an “administrative domain”.

The border element is a signaling entity that generally sits at the edge of the administrative domain and communicates with another administrative domain. This communication might include such things as access authorization information; call pricing information; or other important data necessary to enable communication between the two administrative domains.

Peer elements are entities within the administrative domain that, more or less, help to propagate information learned from the border elements throughout the administrative domain. Such architecture is intended to enable large-scale deployments within carrier networks and to enable services such as clearinghouses.

H.323 is defined as a binary protocol, which allows for efficient message processing in network elements. The syntax of the protocol is defined in ASN.1 and uses the Packed Encoding Rules (PER) form of message encoding for efficient message encoding on the wire. Below is an overview of the various communication flows in H.323 systems.

Once the address of the remote endpoint is resolved, the endpoint will use H.225.0 Call Signaling in order to establish communication with the remote entity. H.225.0 messages include: Setup and Setup acknowledge, Call Proceeding, Connect, Alerting, Information, Release Complete, Facility, Progress, Status and Status Inquiry, and Notify.

In the simplest form, an H.323 call may be established as follows.

In this example, the endpoint (EP) on the left initiated communication with the gateway on the right and the gateway connected the call with the called party. In reality, call flows are often more complex than the one shown, but most calls that utilize the Fast Connect procedures defined within H.323 can be established with as few as 2 or 3 messages. Endpoints must notify their gatekeeper (if gatekeepers are used) that they are in a call.

Once a call has concluded, a device will send a Release Complete message. Endpoints are then required to notify their gatekeeper (if gatekeepers are used) that the call has ended.

Endpoints use the RAS protocol in order to communicate with a gatekeeper. Likewise, gatekeepers use RAS to communicate with peer gatekeepers. RAS is a fairly simple protocol composed of just a few messages. Namely: Gatekeeper request, reject and confirm messages (GRx), Registration request, reject and confirm messages (RRx), Unregister request, reject and confirm messages (URx), Admission request, reject and confirm messages (ARx), Bandwidth request, reject and confirm message (BRx), Disengage request, reject and confirm (DRx), Location request, reject and confirm messages (LRx), Info request, ack, nack and response (IRx), Nonstandard message, Unknown message response, Request in progress (RIP), Resource availability indication and confirm (RAx), and Service control indication and response (SCx).

When an endpoint is powered on, it will generally send a gatekeeper request (GRQ) message to “discover” gatekeepers that are willing to provide service. Gatekeepers will then respond with a gatekeeper confirm (GCF) and the endpoint will then select a gatekeeper to work with. Alternatively, it is possible that a gatekeeper has been predefined in the system's administrative setup so there is no need for the endpoint to discover one.

Once the endpoint determines the gatekeeper to work with, it will try to register with the gatekeeper by sending a registration request (RRQ), to which the gatekeeper responds with a registration confirm (RCF). At this point, the endpoint is known to the network and can make and place calls.

When an endpoint wishes to place a call, it will send an admission request (ARQ) to the gatekeeper. The gatekeeper will then resolve the address (either locally, by consulting another gatekeeper, or by querying some other network service) and return the address of the remote endpoint in the admission confirm message (ACF). The endpoint can then place the call.

Upon receiving a call, a remote endpoint will also send an ARQ and receive an ACF in order to get permission to accept the incoming call. This is necessary, for example, to authenticate the calling device or to ensure that there is available bandwidth for the call.

Once a call has initiated (but not necessarily fully connected) endpoints may initiate H.245 call control signaling in order to provide more extensive control over the conference. H.245 is a rather voluminous specification with many procedures that fully enable multipoint communication, though in practice most implementations only implement the minimum necessary in order to enable point-to-point voice and video communication.

H.245 provides capabilities such as capability negotiation, master/slave determination, opening and closing of “logical channels” (i.e., audio and video flows), flow control, and conference control. It has support for both unicast and multicast communication, allowing the size of a conference to theoretically grow without bound.

Of the functionality provided by H.245, capability negotiation is arguably the most important, as it enables devices to communicate without having prior knowledge of the capabilities of the remote entity. H.245 enables rich multimedia capabilities, including audio, video, text, and data communication. For transmission of audio, video, or text, H.323 devices utilize both ITU-defined codecs and codecs defined outside the ITU. Codecs that are widely implemented by H.323 equipment include: Video codecs: H.261, H.263, H.264; Audio codecs: G.711, G.729, G.729a, G.723.1, G.726; and Text codecs: T.140.

H.245 also enables real-time data conferencing capability through protocols like T.120. T.120-based applications generally operate in parallel with the H.323 system, but are integrated to provide the user with a seamless multimedia experience. T.120 provides such capabilities as application sharing T.128, electronic whiteboard T.126, file transfer T.127, and text chat T.134 within the context of the conference.

When an H.323 device initiates communication with a remote H.323 device and when H.245 communication is established between the two entities, the Terminal Capability Set (TCS) message is the first message transmitted to the other side.

After sending a TCS message, H.323 entities (through H.245 exchanges) will attempt to determine which device is the “master” and which is the “slave.” This process, referred to as Master/Slave Determination (MSD), is important, as the master in a call settles all “disputes” between the two devices. For example, if both endpoints attempt to open incompatible media flows, it is the master who takes the action to reject the incompatible flow.

Once capabilities are exchanged and master/slave determination steps have completed, devices may then open “logical channels” or media flows. This is done by simply sending an Open Logical Channel (OLC) message and receiving an acknowledgement message. Upon receipt of the acknowledgement message, an endpoint may then transmit audio or video to the remote endpoint.

After this exchange of messages, the two endpoints (EP) in this figure would be transmitting audio in each direction. The number of message exchanges is numerous; each has an important purpose, but nonetheless takes time.

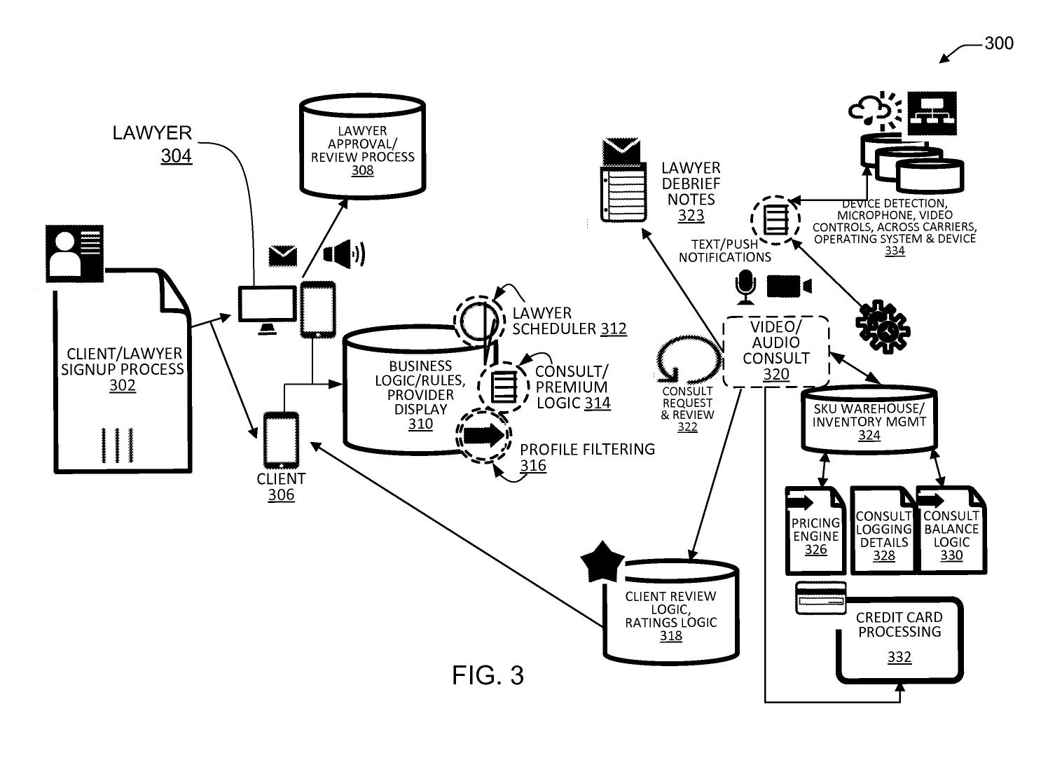

For this reason, H.323 version 2 (published in 1998) introduced a concept called Fast Connect, which enables a device to establish bi-directional media flows as part of the H.225.0 call establishment procedures. With Fast Connect, it is possible to establish a call with bi-directional media flowing with no more than two messages, like in FIG. 3.

Fast Connect is widely supported in the industry. Even so, most devices still implement the complete H.245 exchange as shown above and perform that message exchange in parallel to other activities, so there is no noticeable delay to the calling or called party.

### Media Gateway Control Protocol (MGCP)

The Media Gateway Control Protocol (MGCP) is an implementation of the Media Gateway Control Protocol architecture for controlling media gateways on Internet Protocol (IP) networks connected to the public switched telephone network (PSTN). The protocol architecture and programming interface is described in RFC 2805 and the current specific MGCP definition is RFC 3435 which overrides RFC 2705. It is a successor to the Simple Gateway Control Protocol (SGCP) which was developed by Bellcore and Cisco. In November 1998, the Simple Gateway Control Protocol (SGCP) was combined with Level 3 Communications Internet Protocol Device Control (IPDC) to form the Media Gateway Control Protocol (MGCP).

MGCP is a text-based signaling and call control communications protocol used in Voice over IP (VoIP) systems. It implements a model similar to the structure of the PSTN with the power of the network residing in a call control center soft switch which is analogous to the central office in the telephone networks. The endpoints are low-intelligence devices, mostly executing control commands. The protocol represents a decomposition of other VoIP models, such as H.323, in which the H.323 Gatekeeper, have higher levels of signaling intelligence.

MGCP uses the Session Description Protocol (SDP) for specifying and negotiating the media streams to be transmitted in a call session and the Real-time Transport Protocol (RTP) for framing of the media streams.

The Media Gateway Control Protocol architecture and its methodologies and programming interfaces are described in RFC 2805.

MGCP is a master/slave protocol that allows a call control device such as a Call Agent to take control of a specific port on a Media Gateway. In MGCP context Media Gateway Controller is referred to as Call Agent. This has the advantage of centralized gateway administration and provides for largely scalable IP Telephony solutions. The distributed system is composed of a Call Agent, at least one Media Gateway (MG) that performs the conversion of media signals between circuits and packets switched networks, and at least one Signaling gateway (SG) when connected to the PSTN.

MGCP assumes a call control architecture where there is limited intelligence at the edge (endpoints, Media Gateways) and intelligence at the core Call Agent. The MGCP assumes that Call Agents, will synchronize with each other to send coherent commands and responses to the gateways under their control.

The Call Agent uses MGCP to tell the Media Gateway which events should be reported to the Call Agent, how endpoints should be inter-connected, and which signals should be activated on the endpoints.

MGCP also allows the Call Agent to audit the current state of endpoints on a Media Gateway.

The Media Gateway uses MGCP to report events, such as off-hook or dialed digits, to the Call Agent.

While any signaling gateway is usually on the same physical switch as a media gateway, there is no such need. The Call Agent does not use MGCP to control the Signaling Gateway; rather, SIGTRAN protocols are used to backhaul signaling between the Signaling Gateway and Call Agent.

Typically, a Media Gateway is configured with a list of Call Agents from which it may accept programming (where that list normally comprises only one or two Call Agents).

In principle, event notifications may be sent to different Call Agents for each endpoint on the gateway (as programmed by the Call Agents, by setting the NotifiedEntity parameter). In practice, however, it is usually desirable that at any given moment all endpoints on a gateway should be controlled by the same Call Agent; other Call Agents are available only to provide redundancy in the event that the primary Call Agent fails, or loses contact with the Media Gateway. In the event of such a failure it is the backup Call Agent's responsibility to reprogram the MG so that the gateway comes under the control of the backup Call Agent. Care is needed in such cases; two Call Agents may know that they have lost contact with one another, but this does not guarantee that they are not both attempting to control the same gateway. The ability to audit the gateway to determine which Call Agent is currently controlling can be used to resolve such conflicts.

MGCP assumes that the multiple Call Agents will maintain knowledge of device state among themselves (presumably with an unspecified protocol) or rebuild it if necessary (in the face of catastrophic failure). Its failover features take into account both planned and unplanned outages.

MGCP packets are unlike those generated by many other protocols. Usually wrapped in UDP port 2427, the MGCP datagrams are formatted with whitespace, much like you would expect to find in TCP protocols.

An MGCP packet is either a command or a response. Every issued MGCP command has a transaction ID and receives a response. Commands begin with a four-letter verb. Responses begin with a three number response code.

There are nine (9) command verbs: AUEP, AUCX, CRCX, DLCX, EPCF, MDCX, NTFY, RQNT, and RSIP. Both AUEP (Audit Endpoint) and AUCX (Audit Connection) are used by a Call Agent to query (the state of) a Media Gateway. The next three verbs, CRCX (Create Connection), DLCX (Delete Connection), and MDCX (Modify Connection), are used by a Call Agent to manage an RTP connection on a Media Gateway (a Media Gateway can also send a DLCX when it needs to delete a connection for its self-management). RQNT (Request for Notification) is used by a Call Agent to request notification of events on the Media Gateway, and to request a Media Gateway to apply signals. EPCF (Endpoint Configuration) is used by a Call Agent to modify coding characteristics expected by the “line-side” on the Media Gateway. NTFY (Notify) is used by a Media Gateway to indicate to the Call Agent that it has detected an event for which the Call Agent had previously requested notification of (via the RQNT command verb). RSIP (Restart in Progress) is used by a Media Gateway to indicate to the Call Agent that it is in the process of restarting.

RFCs for Media Gateway Control Protocol include RFC 3435 (Media Gateway Control Protocol (MGCP) Version 1.0 (which supersedes RFC 2705)), RFC 3660 (Basic Media Gateway Control Protocol (MGCP) Packages (informational)), RFC 3661 (Media Gateway Control Protocol (MGCP) Return Code Usage), RFC 3064 (MGCP CAS Packages), (RFC 3149-MGCP Business Phone Packages), RFC 3991 (Media Gateway Control Protocol (MGCP) Redirect and Reset Package),(RFC 3992 (Media Gateway Control Protocol (MGCP) Lockstep State Reporting Mechanism), RFC 2805 (Media Gateway Control Protocol Architecture and Requirements) and RFC 2897 (MGCP Advanced Audio Package).

### Session Initiation Protocol (SIP)

The Session Initiation Protocol (SIP) is a communications protocol for signaling and controlling multimedia communication sessions. The most common applications of SIP are in Internet telephony for voice and video calls, as well as instant messaging all over Internet Protocol (IP) networks.

The protocol defines the messages that are sent between endpoints, which govern establishment, termination and other essential elements of a call. SIP can be used for creating, modifying and terminating sessions consisting of one or several media streams. SIP is an application layer protocol designed to be independent of the underlying transport layer. It is a text-based protocol, incorporating many elements of the Hypertext Transfer Protocol (HTTP) and the Simple Mail Transfer Protocol (SMTP).

SIP works in conjunction with several other application layer protocols that identify and carry the session media. Media identification and negotiation is achieved with the Session Description Protocol (SDP). For the transmission of media streams (voice, video) SIP typically employs the Real-time Transport Protocol (RTP) or Secure Real-time Transport Protocol (SRTP). For secure transmissions of SIP messages, the protocol may be encrypted with Transport Layer Security (TLS).

SIP is independent from the underlying transport protocol. It runs on the Transmission Control Protocol (TCP), the User Datagram Protocol (UDP) or the Stream Control Transmission Protocol (SCTP). SIP can be used for two-party (unicast) or multiparty (multicast) sessions.

SIP employs design elements similar to the HTTP request/response transaction model. Each transaction consists of a client request that invokes a particular method or function on the server and at least one response. SIP reuses most of the header fields, encoding rules and status codes of HTTP, providing a readable text-based format.

Each resource of a SIP network, such as a user agent or a voicemail box, is identified by a uniform resource identifier (URI), based on the general standard syntax also used in Web services and e-mail. The URI scheme used for SIP is sip: and a typical SIP URI is of the form: sip:username:password@host:port. If secure transmission is required, the scheme sips: is used and mandates that each hop over which the request is forwarded up to the target domain must be secured with Transport Layer Security (TLS). The last hop from the proxy of the target domain to the user agent has to be secured according to local policies. TLS protects against attackers who try to listen on the signaling link but it does not provide real end-to-end security to prevent espionage and law enforcement interception, as the encryption is only hop-by-hop and every single intermediate proxy has to be trusted.

SIP works in concert with several other protocols and is only involved in the signaling portion of a communication session. SIP clients typically use TCP or UDP on port numbers 5060 or 5061 to connect to SIP servers and other SIP endpoints. Port 5060 is commonly used for non-encrypted signaling traffic whereas port 5061 is typically used for traffic encrypted with Transport Layer Security (TLS). SIP is primarily used in setting up and tearing down voice or video calls. It also allows modification of existing calls. The modification can involve changing addresses or ports, inviting more participants, and adding or deleting media streams. SIP has also found applications in messaging applications, such as instant messaging, and event subscription and notification. A suite of SIP-related Internet Engineering Task Force (IETF) rules define behavior for such applications. The voice and video stream communications in SIP applications are carried over another application protocol, the Real-time Transport Protocol (RTP). Parameters (port numbers, protocols, codecs) for these media streams are defined and negotiated using the Session Description Protocol (SDP), which is transported in the SIP packet body.

A motivating goal for SIP was to provide a signaling and call setup protocol for IP-based communications that can support a superset of the call processing functions and features present in the public switched telephone network (PSTN). SIP by itself does not define these features; rather, its focus is call-setup and signaling. The features that permit familiar telephone-like operations (i.e. dialing a number, causing a phone to ring, hearing ring back tones or a busy signal) are performed by proxy servers and user agents. Implementation and terminology are different in the SIP world but to the end-user, the behavior is similar.

SIP-enabled telephony networks can also implement many of the more advanced call processing features present in Signaling System 7 (SS7), though the two protocols themselves are very different. SS7 is a centralized protocol, characterized by complex central network architecture and dumb endpoints (traditional telephone handsets). SIP is a client-server protocol, however most SIP-enabled devices may perform both the client and the server role. In general, session initiator is a client, and the call recipient performs the server function. SIP features are implemented in the communicating endpoints, contrary to traditional SS7 features, which are implemented in the network.

SIP is distinguished by its proponents for having roots in the IP community rather than in the telecommunications industry. SIP has been standardized and governed primarily by the IETF, while other protocols, such as H.323, have traditionally been associated with the International Telecommunication Union (ITU).

SIP defines user-agents as well as several types of server network elements. Two SIP endpoints can communicate without any intervening SIP infrastructure. However, this approach is often impractical for a public service, which needs directory services to locate available nodes on the network.

A SIP user agent (UA) is a logical network end-point used to create or receive SIP messages and thereby manage a SIP session. A SIP UA can perform the role of a User Agent Client (UAC), which sends SIP requests, and the User Agent Server (UAS), which receives the requests and returns a SIP response. These roles of UAC and UAS only last for the duration of a SIP transaction.

A SIP phone is an IP phone that implements SIP user agent and server functions, which provide the traditional call functions of a telephone, such as dial, answer, reject, hold/unhold, and call transfer. SIP phones may be implemented as a hardware device or as a softphone. As vendors increasingly implement SIP as a standard telephony platform, often driven by 4G efforts, the distinction between hardware-based and software-based SIP phones is being blurred and SIP elements are implemented in the basic firmware functions of many IP-capable devices. Examples are devices from Nokia and BlackBerry.

In SIP, as in HTTP, the user agent may identify itself using a message header field ‘User-Agent’, containing a text description of the software/hardware/product involved. The User-Agent field is sent in request messages, which means that the receiving SIP server can see this information. SIP network elements sometimes store this information, and it can be useful in diagnosing SIP compatibility problems.

The proxy server is an intermediary entity that acts as both a server and a client for the purpose of making requests on behalf of other clients. A proxy server primarily plays the role of routing, meaning that its job is to ensure that a request is sent to another entity closer to the targeted user. Proxies are also useful for enforcing policy (for example, making sure a user is allowed to make a call). A proxy interprets, and, if necessary, rewrites specific parts of a request message before forwarding it.

A registrar is a SIP endpoint that accepts REGISTER requests and places the information it receives in those requests into a location service for the domain it handles. The location service links one or more IP addresses to the SIP URI of the registering agent. The URI uses the sip: scheme, although other protocol schemes are possible, such as tel:. More than one user agent can register at the same URI, with the result that all registered user agents receive the calls to the URI.

SIP registrars are logical elements, and are commonly co-located with SIP proxies. But it is also possible and often good for network scalability to place this location service with a redirect server.

A user agent server that generates 3xx (Redirection) responses to requests it receives, directing the client to contact an alternate set of URIs. The redirect server allows proxy servers to direct SIP session invitations to external domains.

Session border controllers serve as middle boxes between UA and SIP servers for various types of functions, including network topology hiding, and assistance in NAT traversal.

Gateways can be used to interface a SIP network to other networks, such as the public switched telephone network, which use different protocols or technologies.

SIP is a text-based protocol with syntax similar to that of HTTP. There are two different types of SIP messages: requests and responses. The first line of a request has a method, defining the nature of the request, and a Request-URI, indicating where the request should be sent. The first line of a response has a response code.

For SIP requests, RFC 3261 defines the following methods: REGISTER, used by a UA to register to the registrar; INVITE, used to establish a media session between user agents; ACK, confirms reliable message exchanges; CANCEL, terminates a pending request; BYE, terminates an existing session; OPTIONS, requests information about the capabilities of a caller without the need to set up a session. Often used as keep-alive messages; REFER, indicates that the recipient (identified by the Request-URI) should contact a third party using the contact information provided in the request. (call transfer)

A new method has been introduced in SIP in RFC 3262: PRACK (Provisional Response Acknowledgement): PRACK improves network reliability by adding an acknowledgement system to the provisional responses (1xx). PRACK is sent in response to provisional response (1xx).

The SIP response types defined in RFC 3261 fall in one of the following categories: Provisional (1xx), request received and being processed; Success (2xx), the action was successfully received, understood, and accepted; Redirection (3xx), further action needs to be taken (typically by sender) to complete the request; Client Error (4xx), the request contains bad syntax or cannot be fulfilled at the server; Server Error (5xx), the server failed to fulfill an apparently valid request; Global Failure (6xx), The request cannot be fulfilled at any server.

### Example

User1's UAC uses an Invite Client Transaction to send the initial INVITE (1) message. If no response is received after a timer controlled wait period the UAC may chose to terminate the transaction or retransmit the INVITE. Once a response is received, User1 is confident the INVITE was delivered reliably. User1's UAC must then acknowledge the response. On delivery of the ACK (2) both sides of the transaction are complete. In this case, a dialog may have been established.

SIP makes use of transactions to control the exchanges between participants and deliver messages reliably. The transactions maintain an internal state and make use of timers. Client Transactions send requests and Server Transactions respond to those requests with one-or-more responses. The responses may include zero-or-more Provisional (1xx) responses and one-or-more final (2xx-6xx) responses.

Transactions are further categorized as either Invite or Non-Invite. Invite transactions differ in that they can establish a long-running conversation, referred to as a Dialog in SIP, and so include an acknowledgment (ACK) of any non-failing final response (e.g. 200 OK).

Because of these transactional mechanisms, SIP can make use of un-reliable transports such as User Datagram Protocol (UDP).

### H.248 (Also Known as Media Gateway Control (Megaco))

Not to be confused with Media Gateway Control Protocol, another Protocol for controlling Media Gateways based on Media Gateway Control Protocol Architecture.

Gateway Control Protocol Relationship. H.248/Megaco is used for downward communication between Media Gateway Controller and Media Gateways. Media Gateway Controller talk with each other using SIP. H.323 or ISUP

H.248 or Megaco or Gateway Control Protocol is a recommendation from ITU Telecommunication Standardization Sector (ITU-T) which defines protocols that are used between elements of a physically decomposed multimedia gateway. It is an implementation of the Media Gateway Control Protocol Architecture (RFC 2805). H.248 is also called Megaco in IETF domain. It is now known as Gateway Control Protocol. The current standard published in March 2013 by ITU-T is H.248.1: Gateway control protocol: Version 3.

H.248/Megaco is standard protocol for controlling the elements of a physically decomposed multimedia gateway, which enables separation of call control from media conversion. H.248/Megaco is a master/slave protocol used to separate the call control logic from the media processing logic in a gateway.

H.248/Megaco follows the guidelines of the API Media Gateway Control Protocol Architecture and Requirements in RFC 2805 (April 2000). Though H.248 performs the same functions as other Media Gateway control protocol namely MGCP, it uses different syntax, commands and processes and supports a broader range of networks. H.248 and MGCP protocols are complementary to H.323 and SIP protocols.

The protocol was the result of collaboration of the MEGACO working group of the Internet Engineering Task Force (IETF) and International Telecommunication Union Telecommunication Study Group 16. The IETF originally published the standard as RFC 3015, which was later replaced by RFC 3525. The term Megaco is the IETF designation. Megaco combines Media Gateway Control Protocol (MGCP) and Media Device Control Protocol (MDCP). Media Gateway Control Protocol (MGCP) in turn was formed by merging Simple Gateway Control Protocol (SGCP) with Internet Protocol Device Control (IPDC).

The ITU later took ownership of the protocol and IETF's version has been reclassified as historic by RFC 5125. The ITU has published three versions of H.248, the most recent in September 2005. H.248 encompasses not only the base protocol specification in H.248.1, but many extensions defined throughout the H.248 Sub-series.

Another implementation of the Media Gateway Control Protocol architecture is Media Gateway Control Protocol. This is used over the same interface and similar in application and service functionality, however, it is a different protocol and the underlying differences make them incompatible.

H.248/Megaco exploded gatekeeper model of H.323 and put signaling control in a Media Gateway Controller (MGC) thereby unbundling call intelligence from media. H.248 is meant to address the relationship between the Media Gateways (MGs), which converts circuit-switched voice to packet-based traffic, and the Media Gateway Controller (MGC). Media Gateway Controller (MGC) using H.248 instructs one or more Media Gateways (MG) s to connect streams coming from outside a packet or cell data network onto a packet or cell stream such as the Real-Time Transport Protocol.

H.248/Megaco due to its master—slave nature does not describe the establishment of calls across domains or across Media Gateway Controllers. H.248/Megaco is used for communication downward, to the media gateways and does not constitute a complete system. The architecture requires a Peer-to-Peer for communication between Media Gateway Controllers.

The device that handles the call control function is referred to as an intelligent Media Gateway Controller (MGC) and the device that handles the media is referred to as a relatively unintelligent Media Gateway (MG). H.248 defines the protocol for Media Gateway Controllers to control Media Gateways for the support of multimedia streams across IP networks and the Public Switched Telephone network (PSTN). It is typically used for providing Voice over Internet Protocol (VoIP) services like voice and fax between IP networks and the PSTN), or entirely within IP networks.

Because of the types of devices targeted for control by H.248/Megaco and the low level of its control structure, H.248 is generally viewed as complementary to H.323 and SIP. While a Media Gateway Controller (MGC) will use H.248/Megaco to manage media establishment and control with a number of Media Gateways (MG), other VoIP protocol such as SIP and H.323 are used for one Media Gateway Controller (MGC) to communicate with another Media Gateway Controller (MGC). From a SIP perspective, the combination of MGC and MGs are treated together as a SIP Gateway.

H.248 messages are used between Media Gateway Control Function (MGCF) control IMS-Media Gateways (IMS-MGW). SIP is used by MGCF to interact with Call Session Control Function (CSCF) and Breakout Gateway Control Function (BGCF)

The H.248/Megaco model describes a connection model that contains the logical entities, or objects, within the Media Gateways (MGs) that can be controlled by the Media Gateway Controller. The main entities are Contexts and Terminations.

These source or sink one or more media streams or control streams. Terminations may be physical or ephemeral.

Physical Terminations represent physical entities that have a semi-permanent existence. For example, a Termination representing ports on the gateway, such as TDM channel or DS0 might exist for as long as it is provisioned in the gateway. Ephemeral Terminations represent Connections or data flows, such as RTP streams, or MP3 streams, and usually exist only for the duration of their use in a particular Context.

Terminations have properties, such as the maximum size of a jitter buffer, which can be inspected and modified by the MGC. A termination is given a name, or Termination ID, by the MG.

These are star connections created by associating multiple terminations. A Context is a logical entity on an MG that is an association between a collection of Terminations. A NULL context contains all non-associated terminations. A Context is a logical entity on an MG that is an association between a collection of Terminations. A ContextID identifies a Context.

The normal, “active” context might have a physical termination (say, one DS0 in a DS3) and one ephemeral one (the RTP stream connecting the gateway to the network). Contexts are created and released by the MG under command of the MGC. A context is created by adding the first termination, and it is released by removing (subtracting) the last termination.

A termination may have more than one stream, and therefore a context may be a multistream context. Audio, video, and data streams may exist in a context among several terminations.

In IP Multimedia Subsystem (IMS), Media Gateway Control Function (MGCF) control Media Gateways (MGW)s to send and receive call to/from the PSTN circuit switched (CS) networks using. H.248. The MGCF uses SIP messages to interact with Call Session Control Function (CSCF) and Breakout Gateway Control Function (BGCF).

Although the modeling of the Media Gateway differs in H.248/Megaco when compared to MGCP, there is a similarity between the semantics of the commands in the two specifications. There is almost a one to one mapping between the commands of MEGACO and MGCP. For example the Create connection command in MGCP has an equivalent ADD termination command in MEGACO, the Modify connection command in MGCP equates to the MODIFY termination command of MEGACO and the Delete connection command equates to the SUBTRACT termination command of MEGACO.

The H.248/Megaco model is a much more complex than the Media Gateway Control Protocol (MGCP) model and it provides far greater flexibility when defining media control. For example, in Media Gateway Control Protocol (MGCP) you can set a mode such as “conference” to manage the stream mixing, but it cannot achieve the fine grain control that H.248/Megaco has, such as how to manage the media streams.

Gateway Control Evolution. H.248/Megaco is standard as defined in RFC 3525. Current version of H.248-Gateway control protocol: Version 3 is standard and in force.

The H.248/Megaco model considerably simplifies connection setup within the MG and to entities outside the MG. It simplifies the mechanism by which the Media Gateway Controller (MGC) can specify associated media streams as well as specify the direction of media flow. H.248/Megaco is therefore able to provide greater application level support than Media Gateway Control Protocol (MGCP). For example, setting up a multi-party conference using H.248/Megaco merely involves adding several terminations to a context. In case of Media Gateway Control Protocol (MGCP) however, the Media Gateway Controller (MGC) needs to establish several connections to a special type of endpoint called the conference bridge.

RFC 3015 (Megaco Protocol Version 1.0, November 2000, (Standard Track)) and RFC 3525 (Gateway Control Protocol Version 1, June 2003 (Obsoletes: RFC 3015) (Standard))

### Real-time Transport Protocol (RTP)

The Real-time Transport Protocol (RTP) is a network protocol for delivering audio and video over IP networks. RTP is used extensively in communication and entertainment systems that involve streaming media, such as telephony, video teleconference applications, television services and web-based push-to-talk features.

RTP is used in conjunction with the RTP Control Protocol (RTCP). While RTP carries the media streams (e.g., audio and video), RTCP is used to monitor transmission statistics and quality of service (QoS) and aids synchronization of multiple streams. RTP is one of the technical foundations of Voice over IP and in this context is often used in conjunction with a signaling protocol such as the Session Initiation Protocol (SIP) which establishes connections across the network.

RTP was developed by the Audio-Video Transport Working Group of the Internet Engineering Task Force (IETF) and first published in 1996 as RFC 1889, superseded by RFC 3550 in 2003.

RTP is designed for end-to-end, real-time, transfer of streaming media. The protocol provides facilities for jitter compensation and detection of out of sequence arrival in data, which are common during transmissions on an IP network. RTP allows data transfer to multiple destinations through IP multicast. RTP is regarded as the primary standard for audio/video transport in IP networks and is used with an associated profile and payload format.

Real-time multimedia streaming applications require timely delivery of information and often can tolerate some packet loss to achieve this goal. For example, loss of a packet in audio application may result in loss of a fraction of a second of audio data, which can be made unnoticeable with suitable error concealment algorithms. The Transmission Control Protocol (TCP), although standardized for RTP use, is not normally used in RTP applications because TCP favors reliability over timeliness. Instead the majority of the RTP implementations are built on the User Datagram Protocol (UDP). Other transport protocols specifically designed for multimedia sessions are SCTP and DCCP, although, as of 2010, they are not in widespread use.

RTP was developed by the Audio/Video Transport working group of the IETF standards organization. RTP is used in conjunction with other protocols such as H.323 and RTSP. The RTP standard defines a pair of protocols, RTP and RTCP. RTP is used for transfer of multimedia data, and the RTCP is used to periodically send control information and QoS parameters.

The RTP specification describes two sub-protocols, RTP and RTCP.

The data transfer protocol, RTP, facilitates the transfer of real-time data. Information provided by this protocol include timestamps (for synchronization), sequence numbers (for packet loss and reordering detection) and the payload format which indicates the encoded format of the data.

The control protocol RTCP is used to specify quality of service (QoS) feedback and synchronization between the media streams. The bandwidth of RTCP traffic compared to RTP is small, typically around 5%.

RTP sessions are typically initiated between communicating peers using a signaling protocol, such as H.323, the Session Initiation Protocol (SIP), or Jingle (XMPP). These protocols may use the Session Description Protocol to negotiate the parameters for the sessions.

An RTP session is established for each multimedia stream. A session consists of an IP address with a pair of ports for RTP and RTCP. For example, audio and video streams use separate RTP sessions, enabling a receiver to deselect a particular stream. The ports which form a session are negotiated using other protocols such as RTSP (using SDP in the setup method) and SIP. According to the specification, an RTP port should be even and the RTCP port is the next higher odd port number. RTP and RTCP typically use unprivileged UDP ports (1024 to 65535), but may use other transport protocols (most notably, SCTP and DCCP) as well, as the protocol design is transport independent.

One of the design considerations of RTP was to carry a range of multimedia formats (such as H.264, MPEG-4, MJPEG, MPEG, etc.) and allow new formats to be added without revising the RTP standard. The design of RTP is based on the architectural principle known as application level framing (ALF). The information required by a specific application's needs is not included in the generic RTP header, but is instead provided through RTP profiles and payload formats. For each class of application (e.g., audio, video), RTP defines a profile and one or more associated payload formats. A complete specification of RTP for a particular application usage will require a profile and payload format specification(s).

The profile defines the codecs used to encode the payload data and their mapping to payload format codes in the Payload Type (PT) field of the RTP header (see below). Each profile is accompanied by several payload format specifications, each of which describes the transport of a particular encoded data. The audio payload formats include G.711, G.723, G.726, G.729, GSM, QCELP, MP3, and DTMF, and the video payload formats include H.261, H.263, H.264, and MPEG-4.

The RTP profile for Audio and video conferences with minimal control (RFC 3551) defines a set of static payload type assignments, and a mechanism for mapping between a payload format, and a payload type identifier (in header) using Session Description Protocol (SDP).

The Secure Real-time Transport Protocol (SRTP) (RFC 3711) defines a profile of RTP that provides cryptographic services for the transfer of payload data.

The experimental Control Data Profile for RTP (RTP/CDP) for machine-to-machine communications.

The RTP header has a minimum size of 12 bytes. After the header, optional header extensions may be present. This is followed by the RTP payload, the format of which is determined by the particular class of application. The fields in the header are as follows: Version, (2 bits) indicates the version of the protocol. Current version is 2; P (Padding), (1 bit) Used to indicate if there are extra padding bytes at the end of the RTP packet. A padding might be used to fill up a block of certain size, for example as required by an encryption algorithm. The last byte of the padding contains the number of padding bytes that were added (including itself); X (Extension), (1 bit) Indicates presence of an Extension header between standard header and payload data. This is application or profile specific; CC (CSRC Count), (4 bits) Contains the number of CSRC identifiers (defined below) that follow the fixed header; M (Marker), (1 bit) Used at the application level and defined by a profile. If it is set, it means that the current data has some special relevance for the application; PT (Payload Type), (7 bits) indicates the format of the payload and determines its interpretation by the application. This is specified by an RTP profile. For example, see RTP Profile for audio and video conferences with minimal control (RFC 3551); Sequence Number, (16 bits) The sequence number is incremented by one for each RTP data packet sent and is to be used by the receiver to detect packet loss and to restore packet sequence. The RTP does not specify any action on packet loss; it is left to the application to take appropriate action. For example, video applications may play the last known frame in place of the missing frame. According to RFC 3550, the initial value of the sequence number should be random to make known-plaintext attacks on encryption more difficult. RTP provides no guarantee of delivery, but the presence of sequence numbers makes it possible to detect missing packets; Timestamp, (32 bits) Used to enable the receiver to play back the received samples at appropriate intervals. When several media streams are present, the timestamps are independent in each stream, and may not be relied upon for media synchronization. The granularity of the timing is application specific. For example, an audio application that samples data once every 125 μs (8 kHz, a common sample rate in digital telephony) would use that value as its clock resolution. The clock granularity is one of the details that are specified in the RTP profile for an application; SSRC, (32 bits) Synchronization source identifier uniquely identifies the source of a stream. The synchronization sources within the same RTP session will be unique; CSRC, (32 bits each) Contributing source IDs enumerate contributing sources to a stream which has been generated from multiple sources; Header extension, (optional) The first 32-bit word contains a profile-specific identifier (16 bits) and a length specifier (16 bits) that indicates the length of the extension (EHL=extension header length) in 32-bit units, excluding the 32 bits of the extension header.

A functional network-based system includes other protocols and standards in conjunction with RTP. Protocols such as SIP, Jingle, RTSP, H.225 and H.245 are used for session initiation, control and termination. Other standards, such as H.264, MPEG and H.263, are used to encode the payload data as specified via RTP Profile.

An RTP sender captures the multimedia data, then encodes, frames and transmits it as RTP packets with appropriate timestamps and increasing sequence numbers. Depending on the RTP profile in use, the sender may set the Payload Type field. The RTP receiver captures the RTP packets, detects missing packets, and may reorder packets. It decodes the frames according to the payload format and presents the stream to its user.

There are several different RFC protocols which include: RFC 1889, RTP: A Transport Protocol for Real-Time Applications, Obsoleted by RFC 3550; RFC 3550, Standard 64, RTP: A Transport Protocol for Real-Time Application; RFC 3551, Standard 65, RTP Profile for Audio and Video Conferences with Minimal Control; RFC 3190, RTP Payload Format for 12-bit DAT Audio and 20- and 24-bit Linear Sampled Audio; RFC 6184, RTP Payload Format for H.264 Video; RFC 4103, RTP Payload Format for Text Conversation; RFC 3640, RTP Payload Format for Transport of MPEG-4 Elementary Streams; RFC 6416, RTP Payload Format for MPEG-4 Audio/Visual Streams; RFC 2250, RTP Payload Format for MPEG1/MPEG2 Video; RFC 4175, RTP Payload Format for Uncompressed Video; and RFC 6295, RTP Payload Format for MIDI; RFC 4696, An Implementation Guide for RTP MIDI; RFC 7587, RTP Payload Format for the Opus Speech and Audio Codec.

### Real-Time Transport Control Protocol (RTCP)

Not to be confused with Real Time Streaming Protocol.

The RTP Control Protocol (RTCP) is a sister protocol of the Real-time Transport Protocol (RTP). Its basic functionality and packet structure is defined in RFC 3550. RTCP provides out-of-band statistics and control information for an RTP session. It partners with RTP in the delivery and packaging of multimedia data, but does not transport any media data itself. The primary function of RTCP is to provide feedback on the quality of service (QoS) in media distribution by periodically sending statistics information to participants in a streaming multimedia session.

RTCP transports statistics for a media connection and information such as transmitted octet and packet counts, packet loss, packet delay variation, and round-trip delay time. An application may use this information to control quality of service parameters, perhaps by limiting flow, or using a different codec.

Typically RTP will be sent on an even-numbered UDP port, with RTCP messages being sent over the next higher odd-numbered port.

RTCP itself does not provide any flow encryption or authentication methods. Such mechanisms may be implemented, for example, with the Secure Real-time Transport Protocol (SRTP) defined in RFC 3711.

RTCP provides basic functions expected to be implemented in all RTP sessions:

The primary function of RTCP is to gather statistics on quality aspects of the media distribution during a session and transmit this data to the session media source and other session participants. Such information may be used by the source for adaptive media encoding (codec) and detection of transmission faults. If the session is carried over a multicast network, this permits non-intrusive session quality monitoring.

RTCP provides canonical end-point identifiers (CNAME) to all session participants. Although a source identifier (SSRC) of an RTP stream is expected to be unique, the instantaneous binding of source identifiers to end-points may change during a session. The CNAME establishes unique identification of end-points across an application instance (multiple use of media tools) and for third-party monitoring.

Provisioning of session control functions. RTCP is a convenient means to reach all session participants, whereas RTP itself is not. RTP is only transmitted by a media source.

RTCP reports are expected to be sent by all participants, even in a multicast session which may involve thousands of recipients. Such traffic will increase proportionally with the number of participants. Thus, to avoid network congestion, the protocol must include session bandwidth management. This is achieved by dynamically controlling the frequency of report transmissions. RTCP bandwidth usage should generally not exceed 5% of total session bandwidth. Furthermore, 25% of the RTCP bandwidth should be reserved to media sources at all times, so that in large conferences new participants can receive the CNAME identifiers of the senders without excessive delay.

The RTCP reporting interval is randomized to prevent unintended synchronization of reporting. The recommended minimum RTCP report interval per station is 5 seconds. Stations should not transmit RTCP reports more often than once every 5 seconds.

RTCP distinguishes several types of packets: sender report, receiver report, source description, and goodbye. In addition, the protocol is extensible and allows application-specific RTCP packets. A standards-based extension of RTCP is the extended report packet type introduced by RFC 3611.

The sender report is sent periodically by the active senders in a conference to report transmission and reception statistics for all RTP packets sent during the interval. The sender report includes an absolute timestamp, which is the number of seconds elapsed since midnight on Jan. 1, 1900. The absolute timestamp allows the receiver to synchronize RTP messages. It is particularly important when both audio and video are transmitted simultaneously, because audio and video streams use independent relative timestamps.

The receiver report is for passive participants, those that do not send RTP packets. The report informs the sender and other receivers about the quality of service.

The Source Description message is used to send the CNAME item to session participants. It may also be used to provide additional information such as the name, e-mail address, telephone number, and address of the owner or controller of the source.

A source sends a BYE message to shut down a stream. It allows an endpoint to announce that it is leaving the conference. Although other sources can detect the absence of a source, this message is a direct announcement. It is also useful to a media mixer.

The application-specific message provides a mechanism to design application-specific extensions to the RTCP protocol.

In large-scale applications, such as in Internet Protocol Television (IPTV), very long delays (minutes to hours) between RTCP reports may occur, because of the RTCP bandwidth control mechanism required to control congestion (see #Protocol functions). Acceptable frequencies are usually less than one per minute. This affords the potential of inappropriate reporting of the relevant statistics by the receiver or cause evaluation by the media sender to be inaccurate relative to the current state of the session. Methods have been introduced to alleviate the problems: RTCP filtering, RTCP biasing and hierarchical aggregation.

The Hierarchical Aggregation (or also known as RTCP feedback hierarchy) is an optimization of the RTCP feedback model and its aim is to shift the maximum number of users limit further together with Quality of Service (QoS) measurement. The RTCP bandwidth is constant and takes just 5% of session bandwidth. Therefore the reporting interval about QoS depends, among others, on a number of session members and for very large sessions it can become very high (minutes or even hours). However the acceptable interval is about 10 seconds of reporting. Bigger values would cause time-shifted and very inaccurate reported status about the current session status and any optimization made by sender could even have a negative effect to network or QoS conditions.

The Hierarchical Aggregation is used with Source-Specific Multicast where only a single source is allowed, i.e. IPTV. The other type of multicast could be Any-Source Multicast but it is not so suitable for large-scale applications with huge number of users.

As of June 2007, only the most modern IPTV systems use Hierarchical aggregation.

Feedback Target is a new type of member that has been firstly introduced by the Internet Draft draft-ietf-avt-rtcpssm-13. The Hierarchical Aggregation method has extended its functionality. The function of this member is to receive Receiver Reports (RR) (see RTCP) and retransmit summarized RR packets, so-called Receiver Summary Information (RSI) to a sender (in case of single level hierarchy).

### Secure Real-Time Transport Protocol (SRTP)

The Secure Real-time Transport Protocol (or SRTP) defines a profile of RTP (Real-time Transport Protocol), intended to provide encryption, message authentication and integrity, and replay protection to the RTP data in both unicast and multicast applications. It was developed by a small team of IP protocol and cryptographic experts from Cisco and Ericsson including David Oran, David McGrew, Mark Baugher, Mats Naslund, Elisabetta Carrara, Karl Norman, and Rolf Blom. It was first published by the IETF in March 2004 as RFC 3711.

Since RTP is closely related to RTCP (Real Time Control Protocol) which can be used to control the RTP session, SRTP also has a sister protocol, called Secure RTCP (or SRTCP); SRTCP provides the same security-related features to RTCP, as the ones provided by SRTP to RTP.

Utilization of SRTP or SRTCP is optional to the utilization of RTP or RTCP; but even if SRTP/SRTCP are used, all provided features (such as encryption and authentication) are optional and can be separately enabled or disabled. The only exception is the message authentication feature which is indispensably required when using SRTCP.

For encryption and decryption of the data flow (and hence for providing confidentiality of the data flow), SRTP (together with SRTCP) utilizes AES as the default cipher. There are two cipher modes defined which allow the original block cipher AES to be used as a stream cipher:

A typical counter mode, which allows random access to any blocks, which is essential for RTP traffic running over unreliable network with possible loss of packets. In the general case, almost any function can be used in the role of “counter”, assuming that this function does not repeat for a long number of iterations. But the standard for encryption of RTP data is just a usual integer incremental counter. AES running in this mode is the default encryption algorithm, with a default encryption key length of 128 bits and a default session salt key length of 112 bits.

A variation of output feedback mode, enhanced to be seekable and with an altered initialization function. The default values of the encryption key and salt key are the same as for AES in Counter Mode. (AES running in this mode has been chosen to be used in UMTS 3G mobile networks.)

Besides the AES cipher, SRTP allows the ability to disable encryption outright, using the so-called “NULL cipher”, which can be assumed as the second supported cipher (or the third supported cipher mode in sum). In fact, the NULL cipher does not perform any encryption (i.e. the encryption algorithm functions as though the key stream contains only zeroes, and copies the input stream to the output stream without any changes). It is mandatory for this cipher mode to be implemented in any SRTP-compatible system. As such, it can be used when the confidentiality guarantees ensured by SRTP are not required, while other SRTP features (such as authentication and message integrity) may be used.

Though technically SRTP can easily accommodate new encryption algorithms, the SRTP standard states that new encryption algorithms besides those described cannot simply be added in some implementation of SRTP protocol. The only legal way to add a new encryption algorithm, while still claiming the compatibility with SRTP standard, is to publish a new companion standard track RFC which must clearly define the new algorithm.

The above-listed encryption algorithms do not secure message integrity themselves, allowing the attacker to either forge the data or at least to replay previously transmitted data. Hence the SRTP standard also provides the means to secure the integrity of data and safety from replay.

To authenticate the message and protect its integrity, the HMAC-SHA1 algorithm (defined in RFC 2104) is used, which produces a 160-bit result, which is then truncated to 80 or 32 bits to become the authentication tag appended to the packet. The HMAC is calculated over the packet payload and material from the packet header, including the packet sequence number. To protect against replay attacks, the receiver maintains the indices of previously received messages, compares them with the index of each new received message and admits the new message only if it has not been played (i.e. sent) before. Such an approach heavily relies on the integrity protection being enabled (to make it impossible to spoof message indices).

A key derivation function is used to derive the different keys used in a crypto context (SRTP and SRTCP encryption keys and salts, SRTP and SRTCP authentication keys) from one single master key in a cryptographically secure way. Thus, the key management protocol needs to exchange only one master key, all the necessary session keys are generated by applying the key derivation function.

Periodical application of the key derivation function will result in security benefits. It prevents an attacker from collecting large amounts of ciphertext encrypted with one single session key. Certain attacks are easier to carry out when a large amount of ciphertext is available. Furthermore, multiple applications of the key derivation function provides backwards and forward security in the sense that a compromised session key does not compromise other session keys derived from the same master key. This means that even if an attacker managed to recover a certain session key, he is not able to decrypt messages secured with previous and later session keys derived from the same master key. A leaked master key reveals all the session keys derived from it.

SRTP relies on an external key management protocol to set up the initial master key. Two protocols specifically designed to be used with SRTP are ZRTP and MIKEY.

There are also other methods to negotiate the SRTP keys. There are several vendors which offer products that use the SDES key exchange method. Some RFCs include: RFC 3711, Proposed Standard, The Secure Real-time Transport Protocol (SRTP); RFC 4771, Proposed Standard, Integrity Transform Carrying Roll-Over Counter for the Secure Real-time Transport Protocol (SRTP); RFC 3551, Standard 65, RTP Profile for Audio and Video Conferences with Minimal Control; RFC 3550, Standard 64, RTP: A Transport Protocol for Real-Time Applications; and RFC 2104, Informational, HMAC: Keyed-Hashing for Message Authentication.

### Session Description Protocol (SDP)

The Session Description Protocol (SDP) is a format for describing streaming media initialization parameters. The IETF published the original specification as an IETF Proposed Standard in April 1998, and subsequently published a revised specification as an IETF Proposed Standard as RFC 4566 in July 2006.

SDP is intended for describing multimedia communication sessions for the purposes of session announcement, session invitation, and parameter negotiation. SDP does not deliver media itself but is used between end points for negotiation of media type, format, and all associated properties. The set of properties and parameters are often called a session profile. SDP is designed to be extensible to support new media types and formats.

SDP started off as a component of the Session Announcement Protocol (SAP), but found other uses in conjunction with Real-time Transport Protocol (RTP), Real-time Streaming Protocol (RTSP), Session Initiation Protocol (SIP) and even as a standalone format for describing multicast sessions.

A session is described by a series of fields, one per line. The form of each field is as follows.

Where <character> is a single case-significant character and <value> is structured text whose format depends upon attribute type. Values are typically a UTF-8 encoding. Whitespace is not allowed immediately to either side of the =.

Within an SDP message there are three main sections, detailing the session, timing, and media descriptions. Each message may contain multiple timing and media descriptions. Names are only unique within the associated syntactic construct, i.e. within the session, time, or media.

Optional values are specified with=* and each field must appear in the order shown below.

Session Description

v=(protocol version number, currently only 0)

o=(originator and session identifier: username, id, version number, network address)

s=(session name: mandatory with at least one UTF-8-encoded character)

i=* (session title or short information)

u=* (URI of description)

e=* (zero or more email address with optional name of contacts)

p=* (zero or more phone number with optional name of contacts)

c=* (connection information—not required if included in all media)

b=* (zero or more bandwidth information lines)

One or more Time descriptions (“t=” and “r=” lines; see below)

z=* (time zone adjustments)

k=* (encryption key)

a=* (zero or more session attribute lines)

Zero or more Media descriptions (each one starting by an “m=” line; see below)

Time description (mandatory)

t=(time the session is active)

r=* (zero or more repeat times)

Media description (if present)

m=(media name and transport address)

i=* (media title or information field)

c=* (connection information—optional if included at session level)

b=* (zero or more bandwidth information lines)

k=* (encryption key)

a=* (zero or more media attribute lines—overriding the Session attribute lines)

Here is an example session description (from RFC 4566). This session description is being proposed to a receiving client (with username “jdoe”) who was requesting a session from his host located at IPv4 address 10.47.16.5 in order to play a session named “SDP Seminar” (announced separately by the media server) that the SDP server describes as being titled more completely “A Seminar on the session description protocol” (with an available PDF documentation that the client could download separately if needed to get more information). It also contains the description of two non interactive (receive only) medias (audio and video) that are part of this proposed session. The media contents are both available (without any apparent secure access control in this example) on the same media server host (indicated in the Session-level parameters, whose contact name is “Jane Doe” and reachable by her indicated email address), emitting and transporting its two media streams with the RTP protocol over UDP in the basic RTP Audio Video Profile (RTP/AVP), from an IPv4 multicast address 224.2.17.12 (with an IP Multicast Time To Live of up to 127 hops), and using UDP port 49170 for the media data of the audio stream encoded with the RTP/AVP audio format 0 (whose mapping is registered on the IANA registry of standard RTP formats) with its associated UDP port 49171 for its control channel (implicitly added for RTP), and UDP port 51372 for the media data of the video stream (encoded with the server-defined RTP/AVP video format 99, which the SDP server defines and maps as being a “video/h263-1998” media codec) with its associated UDP port 51373 for its control channel (implicitly added for RTP).

v=0

o=jdoe 2890844526 2890842807 IN IP4 10.47.16.5

s=SDP Seminar

i=A Seminar on the session description protocol

u=http://www.example.com/seminars/sdp.pdf

e=j.doe@example.com (Jane Doe)

c=IN IP4 224.2.17.12/127

t=2873397496 2873404696

a=recvonly

m=audio 49170 RTP/AVP 0

m=video 51372 RTP/AVP 99

a=rtpmap:99 h263-1998/90000

The SDP description just contains the description to user “jdoe” of the medias proposed by the described RTP/AVP media server(s) for his session. However it does not specify how the user (or his user agent) reached the SDP server in order to get that description, it also does not indicate if (and how) “jdoe” knew the session name “SDP Seminar” and where it could locate the SDP server proposing this description (this requires a separate protocol for SDP announcement of available sessions). Also this SDP description does not say if (and how) these medias will be played by jdoe's user agent. At this point, the client for these medias has still not reached the RTP/AVP media server.

Also the SDP specifications do not indicate by which transport protocol this SDP description can be delivered to the client. Typically it would be sent by a SAP server in an announcement message, but it could as well be delivered by a web server, or sent as is in an email attachment. In fact, this SDP is not really a protocol but a message format by itself, with its own content type. As this content may be valid for a limited time, the SDP description contains a range of dates of validity during which it should be available, using here a single pair of start and stop times (see the next section about time formats).

SDP uses attributes to extend the core protocol. Attributes can appear within the Session or Media sections and are scoped accordingly as session-level or media-level. New attributes are added to the standard occasionally through registration with IANA.

Attributes take two forms: A property form: a=flag conveys a simple boolean property of the media or session, and A value form: a=attribute: value provides a named parameter.

Two of these attributes are specially defined: a=charset: encoding, and a=sdplang:code.

The first one is used in the Session or Media sections to specify another character encoding (as registered in the IANA registry) than the default one highly recommended (UTF-8) where it is used in standard protocol keys whose values are containing a text intended to be displayed to a user. The second one is used to specify in which language it is written (alternate texts in multiple languages may be carried in the protocol, and selected automatically by the user agent according to user preferences. In both cases, each textual field in the protocol which are not interpreted symbolically by the protocol itself, will be interpreted as opaque strings, but rendered to the user or application with the values indicated in the last occurrence of the charset and sdplang in the current Media section, or otherwise their last value in the Session section).

The first 3 mandatory parameters (v=, s= and o=), even though they seem to contain displayable text, are not intended to be displayed to users and translated. The fields present in their values are considered in the protocol as opaque strings, they are used as identifiers, just like paths in an URL or filenames in a file system: the SDP standard indicates that they must all non empty and should be UTF-8 encoded.

A few other attributes (described as part the standard SDP specifications in the same RFC) are also shown in the example above, either as a session-level attribute (such as the attribute in property form a=recvonly) which also applies to the described medias unless they override their value, or as a media-level attribute (such as the attribute in value form a=rtpmap:99 h263-1998/90000 for the video media in the example).

Absolute times are represented in Network Time Protocol (NTP) format (the number of seconds since 1900). If the stop time is 0 then the session is “unbounded.” If the start time is also zero then the session is considered “permanent.” Unbounded and permanent sessions are discouraged but not prohibited. Intervals can be represented with Network Time Protocol times or in typed time: a value and time units (days (‘d’), hours (h′), minutes (‘m’) and seconds (‘s’)) sequence.

Thus an hour meeting from 10 am UTC on 1 Aug. 2010, with a single repeat time a week later at the same time can be represented as:

t=1280656800 1281265200

r=604800 3600 0

Or using typed time:

t=1280656800 1281265200

r=7d 1 h 0

When repeat times are specified, the start time of each repetition may need to be adjusted so that it will occur at the same local time in a specific time zone throughout the period between the start time and the stop time (which are still specified in NTP format in an absolute UTC time zone.

Instead of specifying this time zone and having to support a database of time zones for knowing when and where daylight adjustments will be needed, the repeat times are assumed to be all defined within the same time zone, and SDP supports the indication of NTP absolute times when a daylight offset (expressed in seconds or using a type time) will need to be applied to the repeated start time or end time falling at or after each daylight adjustment. All these offsets are relative to the start time, they are not cumulative. NTP supports this with the z=field which indicates a series of pairs, whose first item is the NTP absolute time when a daylight adjustment will occur, and the second item indicates the offset to apply relative to the absolute times computed with the r=field.

For example, if a daylight adjustment will subtract 1 hour on 31 Oct. 2010 at 03 am UTC (i.e. 60 days minus 7 hours after the start time on Sunday 1 Aug. 2010 at 10 am UTC), and this will be the only daylight adjustment to apply in the scheduled period which would occur between 1 Aug. 2010 up to the 28 Nov. 2010 at 10 am UTC (the stop time of the repeated 1 h session which is repeated each week at the same local time, which occurs 88 days later), this can be specified as:

t=1280656800 1290938400

r=7 d 1 h 0

z=1288494000-1 h

If the weekly 1-hour session was repeated every Sunday for full one year, i.e. from Sunday 1 Aug. 2010 03 am UTC to Sunday 26 Jun. 2011 04 am UTC (stop time of the last repeat, i.e. 360 days plus 1 hour later, or 31107600 seconds later), so that it would include the transition back to Summer time on Sunday 27 Mar. 2011 at 02 am (1 hour is added again to local time, so that the second daylight transition would occur 209 days after the first start time):

t=1280656800 1290938400

r=7 d 1 h 0

z=1288494000-1 h 1269655200 0

As SDP announcements for repeated sessions should not be made to cover very long periods exceeding a few years, the number of daylight adjustments to include in the z=parameter should remain small.

Sessions may be repeated irregularly over a week but scheduled the same way for all weeks in the period, by adding more tuples in the r parameter. For example to schedule the same event also on Saturday (at the same time of the day) you would use:

t=1280656800 1290938400

r=7 d 1 h 0 6 d

z=1288494000-1 h 1269655200 0

The SDP protocol does not support repeating sessions monthly and yearly schedules with such simple repeat times, because they are irregularly spaced in time; instead, additional t/r tuples may be supplied for each month or year.

Inter-Asterisk eXchange (IAX)

Inter-Asterisk eXchange (IAX) is a communications protocol native to the Asterisk private branch exchange (PBX) software, and is supported by a few other soft switches, PBX systems, and softphones. It is used for transporting VoIP telephony sessions between servers and to terminal devices.

The original IAX protocol is deprecated and has been superseded by a second version, commonly called IAX2. The IAX2 protocol was published as an informational (non-standards-track) RFC 5456 by discretion of the RFC Editor in February 2010.

IAX is a VoIP protocol that can be used for any type of streaming media including video, but is mainly designed for IP voice calls.

IAX uses a single User Datagram Protocol (UDP) data stream between endpoints for both the session signaling and the media payloads. Thus it uses only a single UDP port number, typically 4569. This feature provides benefits for traversing network address translators on network boundaries, as it simplifies firewall configuration. Other VoIP protocols typically use independent streams for signaling and media, such as the Session Initiation Protocol (SIP), H.323, and the Media Gateway Control Protocol (MGCP), which carry media with the Real-time Transport Protocol (RTP).

IAX is a binary-encoded protocol. New extension features must have a new numeric code allocated. Historically, this was modeled after the internal data passing of Asterisk modules.

IAX supports trunking, multiplexing channels over a single link. When trunking, data from multiple sessions are merged into a single stream of packets between two endpoints, reducing the IP overhead without creating additional latency. This is advantageous in VoIP transmissions, in which IP headers use a large percentage of bandwidth.

IAX2 supports native encryption of both control and media streams using AES-128. RFCs with IAX2 support include: RFC 5456 IAX: Inter-Asterisk eXchange Version 2, and RFC 6315 IANA Registration for Enumservice ‘iax’.

### Jingle XMPP VoIP Extensions

Jingle is an extension to the Extensible Messaging and Presence Protocol (XMPP) which adds peer-to-peer (P2P) session control (signaling) for multimedia interactions such as in Voice over IP (VoIP) or videoconferencing communications. It was designed by Google and the XMPP Standards Foundation. The multimedia streams are delivered using the Real-time Transport Protocol (RTP). If needed, NAT traversal is assisted using Interactive Connectivity Establishment (ICE).

As of December 2009, the proposed Jingle specification had not yet been approved by the XMPP Standards Foundation, but is now a Draft Standard, meaning: “Implementations are encouraged and the protocol is appropriate for deployment in production systems, but some changes to the protocol are possible before it becomes a Final Standard.”

The libjingle library, used by Google Talk to implement Jingle, has been released to the public under a BSD license. It implements both the current standard protocol and the older, pre-standard version.

Extensible Messaging and Presence Protocol (XMPP) is a communications protocol for message-oriented middleware based on XML (Extensible Markup Language). It enables the near-real-time exchange of structured yet extensible data between any two or more network entities. Originally named Jabber, the protocol was developed by the Jabber open-source community in 1999 for near real-time instant messaging (IM), presence information, and contact list maintenance. Designed to be extensible, the protocol has also been used for publish-subscribe systems, signaling for VoIP, video, file transfer, gaming, Internet of Things (IoT) applications such as the smart grid, and social networking services.

Unlike most instant messaging protocols, XMPP is defined in an open standard and uses an open systems approach of development and application, by which anyone may implement an XMPP service and interoperate with other organizations' implementations. Because XMPP is an open protocol, implementations can be developed using any software license; although many server, client, and library implementations are distributed as free and open-source software, numerous freeware and commercial software implementations also exist.

The Internet Engineering Task Force (IETF) formed an XMPP working group in 2002 to formalize the core protocols as an IETF instant messaging and presence technology. The XMPP Working group produced four specifications (RFC 3920, RFC 3921, RFC 3922, RFC 3923), which were approved as Proposed Standards in 2004. In 2011, RFC 3920 and RFC 3921 were superseded by RFC 6120 and RFC 6121 respectively, with RFC 6122 specifying the XMPP address format. In addition to these core protocols standardized at the IETF, the XMPP Standards Foundation (formerly the Jabber Software Foundation) is active in developing open XMPP extensions.

XMPP-based software is deployed widely across the Internet, and by 2003, was used by over ten million people worldwide, according to the XMPP Standards Foundation.

The XMPP network uses a client-server architecture; clients do not talk directly to one another. The model is decentralized—anyone can run a server. By design, there is no central authoritative server as there is with services such as AOL Instant Messenger or Windows Live Messenger. Some confusion often arises on this point as there is a public XMPP server being run at jabber.org, to which a large number of users subscribe. However, anyone may run their own XMPP server on their own domain.

Every user on the network has a unique XMPP address, called JID (for historical reasons, XMPP addresses are often called Jabber IDs). The JID is structured like an email address with a username and a domain name (or IP address) for the server where that user resides, separated by an at sign (@), such as username@example.com.

Since a user may wish to log in from multiple locations, they may specify a resource. A resource identifies a particular client belonging to the user (for example home, work, or mobile). This may be included in the JID by appending a slash followed by the name of the resource. For example, the full JID of a user's mobile account could be username@example.com/mobile.

Each resource may have specified a numerical value called priority. Messages simply sent to username@example.com will go to the client with highest priority, but those sent to username@example.com/mobile will go only to the mobile client. The highest priority is the one with largest numerical value.

JIDs without a username part are also valid, and may be used for system messages and control of special features on the server. A resource remains optional for these JIDs as well.

The means to route messages based on a logical endpoint identifier—the JID, instead of by an explicit IP Address present opportunities to use XMPP as an Overlay network implementation on top of different underlay networks.

XMPP provides a general framework for messaging across a network. Not surprisingly, this has a multitude of applications beyond traditional Instant Messaging (IM) and the distribution of Presence data. While several service discovery protocols exist today (such as zeroconf, or the Service Location Protocol), XMPP provides a solid base for the discovery of services (see XEP-0030 DISCO) residing locally or across a network, and the availability of these services (via Presence).

Building on its capability to support discovery across local network domains. XMPP is well-suited for cloud computing where virtual machines, networks, and firewalls would otherwise present obstacles to alternative service discovery and presence-based solutions. Cloud computing and storage systems rely on various levels and forms of communication, including not only messaging between systems to relay state but also the migration or distribution of larger objects, such as storage or virtual machines. Along with authentication and in-transit data protection, XMPP can be applied at a variety of levels and may prove ideal as an extensible middleware or Message Oriented Middleware (MOM) protocol. Widely known for its ability to exchange XML-based content (natively), it is becoming an open platform for orchestrating the exchange of other forms of content including proprietary binary streams, Full Motion Video (FMV) content, and the transport of file-based content (see the Jingle series of extensions for numerous examples). Here the majority of the applications have nothing to do with human communications (i.e., IM) but instead provides an open means to support machine-to-machine or peer-to peer communications across a diverse set of networks.

The original and “native” transport protocol for XMPP is Transmission Control Protocol (TCP), using open-ended XML streams over long-lived TCP connections.

As an alternative to the TCP transport, the XMPP community has also developed an HTTP transport for web clients as well as users behind restricted firewalls. In the original specification, XMPP could use HTTP in two ways: polling and binding. The polling method, now deprecated, essentially implies messages stored on a server-side database are being fetched (and posted) regularly by an XMPP client by way of HTTP ‘GET’ and ‘POST’ requests. The binding method, implemented using Bidirectional-streams Over Synchronous HTTP (BOSH), allows servers to push messages to clients as soon as they are sent. This push model of notification is more efficient than polling, where many of the polls return no new data.

Because the client uses HTTP, most firewalls allow clients to fetch and post messages without any hindrances. Thus, in scenarios where the TCP port used by XMPP is blocked, a server can listen on the normal HTTP port and the traffic should pass without problems. Various websites let people sign into XMPP via a browser. Furthermore, there are open public servers that listen on standard http (port 80) and haps (port 443) ports, and hence allow connections from behind most firewalls. However, the IANA-registered port for BOSH is actually 5280, not 80.

A perhaps more efficient transport for real-time messaging is WebSocket, a web technology providing for bi-directional, full-duplex communications channels over a single TCP connection. XMPP over WebSocket binding is defined in the IETF proposed standard RFC 7395.

XMPP is implemented by a large number of clients, servers, and code libraries. These implementations are provided under a variety of software licenses.

Several large public IM services natively use XMPP, including Google Talk and LiveJournal's “LT Talk”, Nimbuzz, and Ovi (Nokia). Various hosting services, such as DreamHost, enable hosting customers to choose XMPP services alongside more traditional web and email services. Specialized XMPP hosting services also exist in form of cloud so that domain owners need not directly run their own XMPP servers, including Cisco WebEx Connect, Chrome.pl, Flosoft.biz, i-pobox.net, and hosted.im.

XMPP is also used in deployments of non-IM services, including smart grid systems such as demand response applications, message-oriented middleware, and as a replacement for SMS to provide text messaging on many smartphone clients.

The XMPP Standards Foundation or XSF (formerly the Jabber Software Foundation) is active in developing open XMPP extensions. However, extensions can also be defined by any individual, software project, or organization. For example, Google has defined a number of non-XSF extensions, which are used in Google Talk and Google+ (e.g., for signaling related to Google Hangouts). Another example is the federation protocol in Apache Wave, which is based on XMPP.

XMPP has often been regarded as a competitor to SIMPLE, based on the Session Initiation Protocol (SIP) protocol, as the standard protocol for instant messaging and presence notification.

The XMPP extension for multi-user chat can be seen as a competitor to Internet Relay Chat (IRC), although IRC is far simpler, has far fewer features, and is far more widely used.

The XMPP extensions for publish-subscribe provide many of the same features as the Advanced Message Queuing Protocol (AMQP).

One of the original design goals of the early Jabber open-source community was enabling users to connect to multiple instant messaging systems (especially non-XMPP systems) through a single client application. This was done through entities called transports or gateways to other instant messaging protocols, but also to protocols such as SMS or email. Unlike multi-protocol clients, XMPP provides this access at the server level by communicating via special gateway services running alongside an XMPP server. Any user can “register” with one of these gateways by providing the information needed to log on to that network, and can then communicate with users of that network as though they were XMPP users. Thus, such gateways function as client proxies (the gateway authenticates on the user's behalf on the non-XMPP service). As a result, any client that fully supports XMPP can access any network with a gateway without extra code in the client, and without the need for the client to have direct access to the Internet. However, the client proxy model may violate terms of service on the protocol used (although such terms of service are not legally enforceable in several countries) and also requires the user to send their IM username and password to the third-party site that operates the transport (which may raise privacy and security concerns).

Another type of gateway is a server-to-server gateway, which enables a non-XMPP server deployment to connect to native XMPP servers using the built in interdomain federation features of XMPP. Such server-to-server gateways are offered by several enterprise IM software products, including: IBM Lotus Sametime, and Microsoft Lync Server (formerly named Microsoft Office Communications Server—OCS).

The IETF XMPP working group has produced a number of RFC protocol documents: RFC 3920 (superseded by RFC 6120), RFC 3921 (superseded by RFC 6121), RFC 3922, RFC 3923, RFC 4622, RFC 4854, RFC 4979, and RFC 6122.

The most important and most widely implemented of these specifications are: RFC 6120, Extensible Messaging and Presence Protocol (XMPP): Core, which describes client-server messaging using two open-ended XML streams. XML streams consist of <presence/>, <message/> and <iqt> (info/query). A connection is authenticated with Simple Authentication and Security Layer (SASL) and encrypted with Transport Layer Security (TLS); RFC 6121, Extensible Messaging and Presence Protocol (XMPP): Instant Messaging and Presence describes instant messaging (IM), the most common application of XMPP; and RFC 6122, Extensible Messaging and Presence Protocol (XMPP): Address Format describes the rules for XMPP addresses, also called JabberIDs or JIDs. Currently JIDs use Stringprep (as defined in RFC 3454) for handling of Unicode characters outside the ASCII range, but this will be changed in the future to use the technology produced by the IETF's PRECIS Working Group.

### Skype Protocol

The Skype protocol is a proprietary Internet telephony network based on peer-to-peer architecture, used by Skype. The protocol's specifications have not been made publicly available by Skype and official applications using the protocol are closed-source.

The Skype network is not interoperable with most other Voice over IP (VoIP) networks without proper licensing from Skype. Numerous attempts to study and/or reverse engineer the protocol have been undertaken to reveal the protocol, investigate security or to allow unofficial clients.

On Jun. 20, 2014, Microsoft announced the deprecation of the old Skype protocol. Within several months from this date, in order to continue using Skype services, Skype users had to update to Skype applications released in 2014, and users were not able to log in to older Skype versions (clients). There's no word on whether SmartTV and hardware phones with built-in Skype functionality will continue to work without interruptions. The new Skype protocol—Microsoft Notification Protocol 24—promised better offline messaging and better messages synchronization across Skype devices. The deprecation became effective in the second week of August, 2014.

Skype was the first peer-to-peer IP telephony network. The network contains three types of entities: super nodes, ordinary nodes, and the login server. Each client maintains a host cache with the IP address and port numbers of reachable super nodes. The Skype user directory is decentralized and distributed among the super nodes in the network.

Previously any client with good bandwidth, no restrictions due to firewall or NAT, and adequate processing power could become a super node. This placed an extra burden on those who connected to the Internet without NAT, as Skype used their computers and Internet connections as third parties for UDP hole punching (to directly connect two clients both behind NAT) or to completely relay other users' calls. In 2012, Microsoft altered the design of the network, and brought all super nodes under their control as hosted servers in data centers. Microsoft at the time defended the move, saying they “believe this approach has immediate performance, scalability and availability benefits for the hundreds of millions of users that make up the Skype community.” At the time there was some concern regarding the privacy implications of the change, which appear to have been proven true with the revelation of the PRISM surveillance program in June 2013.

Skype does not support the use of the IPv6 protocol, which would greatly reduce the complexity associated with the aforementioned IPv4 communication structure.

Super nodes relay communications on behalf of two other clients, both of which are behind firewalls or “one-to-many” Network address translation. Without relaying by the Super nodes, two clients with firewall or NAT difficulties would be unable to make or receive calls from one another. Skype tries to get the two ends to negotiate the connection details directly, but sometimes the sum of problems at both ends can prevent direct conversation being established.

The problems with firewalls and NAT can be: The external port numbers or IP address are not derivable, because NAT rewrites them; The firewall and NAT in use prevents the session being received; UDP is not usable due to NAT issues, such as timeout; firewalls block many ports; and/or TCP through many-to-one NAT is always “outward only” by default—Adding port-forwarding settings to the NAT router can allow reception of TCP sessions.

Super nodes are grouped into slots (9-10 super nodes), and slots are grouped into blocks (8 slots).

Signaling is encrypted using RC4; however, the method only obfuscates the traffic as the key can be recovered from the packet. Voice data is encrypted with AES.

The Skype client's application programming interface (API) opens the network to software developers. The Skype API allows other programs to use the Skype network to get “white pages” information and manage calls.

The Skype code is closed source, and the protocol is not standardized. Parts of the client use Internet Direct (Indy), an open source socket communication library.

On Jul. 8, 2012, a researcher from Benin, Ouanilo Medegan, released articles and proof of concept code, results of his reverse engineering the Skype client.

Many networking and security companies claim to detect and control Skype's protocol for enterprise and carrier applications. While the specific detection methods used by these companies are often proprietary, Pearson's chi-squared test and stochastic characterization with Naive Bayes classifiers are two approaches that were published in 2007.

Abbreviations that are used: SN, Skype network; SC, Skype client; and HC, host cache.

The main functions of a Skype client are: login, user search, start and end calls, media transfer, presence messages, and video conference.

A Skype client authenticates the user with the login server, advertises its presence to other peers, determines the type of NAT and firewall it is behind and discovers nodes that have public IP addresses.

To connect to the Skype network, the host cache must contain a valid entry. A TCP connection must be established (i.e. to a super node) otherwise the login will fail. Here he means host cache i.e. the information that a skype client stores about the list of super nodes(sc)

1. start
2. send UDP packet(s) to HC
3. if no response within 5 seconds then
4. attempt TCP connection with HC
5. if not connected then
6. attempt TCP connection with HC on port 80 (HTTP)
7. if not connected then
8. attempt TCP connection with HC on port 443 (HTTPS)
9. if not connected then
10. attempts++
11. if attempts==5 then
12. fail
13. else
14. wait 6 seconds
15. goto step 2

### 16. Success

After a Skype client is connected it must authenticate the username and password with the Skype login server. There are many different Skype login servers using different ports. An obfuscated list of servers is hardcoded in the Skype executable.

Skype servers are: dir1.sd.skype.net:9010, dir2.sd.skype.net:9010, dir3.sd.skype.net:9010, dir4.sd.skype.net:9010, dir5.sd.skype.net:9010, dir6.sd.skype.net:9010, dir7.sd.skype.net:9010, dir8.sd.skype.net:9010, http1.sd.skype.net:80, http2.sd.skype.net:80, http3.sd.skype.net:80, http4.sd.skype.net:80, http5.sd.skype.net:80, http6.sd.skype.net:80, http7.sd.skype.net:80, and http8.sd.skype.net:80.

Skype-SW connects randomly to 1-8.

On each login session, Skype generates a session key from 192 random bits. The session key is encrypted with the hard-coded login server's 1536-bit public RSA key to form an encrypted session key. Skype also generates a 1024-bit private/public RSA key pair. An MDS hash of a concatenation of the user name, constant string (“\nSkyper\n”) and password is used as a shared secret with the login server. The plain session key is hashed into a 256-bit AES key that is used to encrypt the session's public RSA key and the shared secret. The encrypted session key and the AES encrypted value are sent to the login server.

On the login server side, the plain session key is obtained by decrypting the encrypted session key using the login server's private RSA key. The plain session key is then used to decrypt the session's public RSA key and the shared secret. If the shared secret matches, the login server will sign the user's public RSA key with its private key. The signed data is dispatched to the super nodes.

Upon searching for a buddy, a super node will return the buddy's public key signed by Skype. The SC will authenticate the buddy and agree on a session key by using the mentioned RSA key.

UDP packets: IP, UDP, Skype SoF, and Skype Crypted Data01.

The Start of Frame (SoF) consists of: frame ID number (2 bytes), payload type (1 byte), obfuscated payload, Ack/NAck packet, payload forwarding packet, payload resending packet, and other.

The RC4 encryption algorithm is used to obfuscate the payload of datagrams. The CRC32 of public source and destination IP, Skype's packet ID are taken. Skype obfuscation layer's initialization vector (IV).

The XOR of these two 32-bit values is transformed to an 80-byte RC4 key using an unknown key engine.

A notable misuse of RC4 in Skype can be found on TCP streams (UDP is unaffected). The first 14 bytes (10 of which are known to the user, since they consist of a hash of the username and password) are XOR-ed with the RC4 stream. Then, the cipher is reinitialized to encrypt the rest of the TCP stream.

TCP packets: TCP and Skype Init TCP packet.

The Skype Init TCP packet contains: the seed (4 bytes), and init_str string 00 01 00 00 01 00 00 00 01/03.

Almost all traffic is ciphered. Each command has its parameters appended in an object list. The object list can be compressed.

| 1. | /Object List ... -\| | |
|---|---|---|
| | Enc | −> Cmd −> Encod |
| a. | \hat{ } | \ Compressed List ... -\| |

| | | |
|---|---|---|
| Frag | \| | \| |

| | |
|---|---|
| a. | \|------------------<---------------\| |
| | Ack |
| | NAck |
| | Forward −> Forwarded..Message |

An object can be a number, string, an IP:port, or even another object list. Each object has an ID. This ID identifies which command parameter the object is.

Object:

Number

IP:Port

List of numbers

String

RSA key

Object List

List Size (n)

Object 1

.

Object n

Packets can be compressed. The algorithm is a variation of arithmetic compression that uses reals instead of bits.

### TeamSpeak

TeamSpeak is proprietary voice-over-Internet Protocol (VoIP) software that allows computer users to speak on a chat channel with fellow computer users, much like a telephone conference call. A TeamSpeak user will often wear a headset with a microphone. Users use the TeamSpeak client software to connect to a TeamSpeak server of their choice, from there they can join chat channels.

The target audience for TeamSpeak is gamers, who can use the software to communicate with other players on the same team of a multiplayer game. Communicating by voice gives a competitive advantage by allowing players to keep their hands on the controls.

The TeamSpeak server currently runs on Microsoft Windows, Mac OS X, Linux and FreeBSD and uses a web based or telnet interface to control server administration and settings. The server runs as a dedicated server separate from the client. TeamSpeak clients are available for Windows, MacOS, Linux, iOS, and Android. TeamSpeak will begin to support IPv6 in an upcoming beta version, scheduled to be released in 2015.

The TeamSpeak 3 server can be used at no cost for up to 32 slots (simultaneous users). For non-commercial use, non-profit licenses are available that allow to use the server with up to 512 slots (users) at a time. With the use of 512 slots server admins can choose to split up the slots into multiple virtual server instances (up to 2).

TeamSpeak 2 supports virtual server instancing. This allows up to 75 server instances to be contained in one process on the server. Additional server processes can be run to increase this further.

Port 9987 is the default UDP port for TeamSpeak 3.

The current version of TeamSpeak has been in development since 2004. It is a complete rewrite with many new features, but has had infrequent updates on the development blog, and was first estimated to be released in mid-2006. The first public release of the TeamSpeak 3 SDK was on Jun. 5, 2008, with the integrated solution in the MMO game Vendetta Online. Open beta for TeamSpeak 3 released on Dec. 9, 2009. Open beta was closed on Aug. 10, 2011 and replaced with TeamSpeak 3.0.0 Final, which is the first stable release of TeamSpeak 3.

TeamSpeak 3 introduced the use of unique ids, housed in the program as identities that are randomly generated at the time of a client's initial setup. An identity contains a nickname (which can be changed at anytime), the Unique ID and an identity name (which is not visible to other users on the server). The unique id is used by the server to grant permissions to the user. Unique IDs replaced the need for a user to register with the server to keep their user group, be it a channel group or a server group.

When TeamSpeak 3 was first introduced to the general public in Open Beta the server administrators were met with a major change in how they granted administrative powers to their users, in the way of a permissions system based on boolean and integer. The new permissions system allows server administrators to have more control over how there user use the server.

The permissions system has two types of integer-based permissions. The permissions use two types of permissions based on integers. Power and Needed Power. The Power is the power level in numbers that the group/user has for that permission. The Needed Power is the needed power level in numbers needed by the group/user to use that specific permission. If the Power level is lower than the Needed Power level then the permission is not able to be used. If the Power level is equal to or higher than the Needed Power level then the group/user will be able to use it.

TeamSpeak 3 also has a 5-tier hierarchy within its permissions system. Server Group, Client Permissions, Channel Permissions, Channel Groups and Channel Client Permissions. The five are used to override another type, also known as inheriting. This allows for highly complex permissions for users, giving users more powers and uses in TeamSpeak without giving away complete control to the users of the server.

With the release of later versions the TeamSpeak developers created easier ways to set up permissions in the way of a “Standard Permissions Display” by default in the client. This placed the original permissions system display behind the “Standard” calling it “Advanced Permissions Display”. This allowed beginners more ease of use when setting up a TeamSpeak 3 server. Some still prefer the advanced system because it allows more control over which permissions get changed, whereas the Standard changes much permission at the same time.

### Virtual Private Network

In order to improve confidentiality over the multimedia teleconference 124, the VOIP connection can be operated through a virtual Private Network. A VPN is a method for the extension of a private network across a public network, such as the Internet. It enables users to send and receive data across shared or public networks as if their computing devices were directly connected to the private network, and thus are benefiting from the functionality, security and management policies of the private network. A VPN is created by establishing a virtual point-to-point connection through the use of dedicated connections, virtual tunneling protocols, or traffic encryption.

A VPN spanning the Internet is similar to a wide area network (WAN). From a user perspective, the extended network resources are accessed in the same way as resources available within the private network. Traditional VPNs are characterized by a point-to-point topology, and they do not tend to support or connect broadcast domains. Therefore, communication, software, and networking, which are based on OSI layer 2 and broadcast packets, such as NetBIOS used in Windows networking, may not be fully supported or work exactly as they would on a local area network (LAN). VPN variants, such as Virtual Private LAN Service (VPLS), and layer 2 tunneling protocols, are designed to overcome this limitation.

VPNs allow employees to securely access the corporate intranet while traveling outside the office. Similarly. VPNs securely connect geographically separated offices of an organization, creating one cohesive network. VPN technology is also used by individual Internet users to secure their wireless transactions, to circumvent geo restrictions and censorship, and to connect to proxy servers for the purpose of protecting personal identity and location.

Early data networks allowed VPN-style remote connectivity through dial-up modems or through leased line connections utilizing Frame Relay and Asynchronous Transfer Mode (ATM) virtual circuits, provisioned through a network owned and operated by telecommunication carriers. These networks are not considered true VPNs because they passively secure the data being transmitted by the creation of logical data streams. They have been replaced by VPNs based on IP and IP/Multiprotocol Label Switching (MPLS) Networks, due to significant cost-reductions and increased bandwidth provided by new technologies such as Digital Subscriber Line (DSL) and fiber-optic networks.

VPNs can be either remote-access (connecting a computer to a network) or site-to-site (connecting two networks). In a corporate setting, remote-access VPNs allow employees to access their company's intranet from home or while traveling outside the office, and site-to-site VPNs allow employees in geographically disparate offices to share one cohesive virtual network. A VPN can also be used to interconnect two similar networks over a dissimilar middle network; for example, two IPv6 networks over an IPv4 network.

VPN systems may be classified by: 1) The protocols used to tunnel the traffic 2) The tunnel's termination point location, e.g., on the customer edge or network-provider edge 3) Whether they offer site-to-site or network-to-network connectivity 4) The levels of security provided 5) The OSI layer they present to the connecting network, such as Layer 2 circuits or Layer 3 network connectivity 6) The osi model has seven layers.

VPNs cannot make online connections completely anonymous, but they can usually increase privacy and security. To prevent disclosure of private information, VPNs typically allow only authenticated remote access and make use of encryption techniques.

VPNs provide security by the use of tunneling protocols and often through procedures such as encryption. The VPN security model provides: information security: 1) Confidentiality such that even if the network traffic is sniffed at the packet level (see network sniffer and Deep packet inspection), an attacker would only see encrypted data 2) Sender authentication to prevent unauthorized users from accessing the VPN 3) Message integrity to detect any instances of tampering with transmitted messages

Secure VPN protocols includes the following: 1) Internet Protocol Security (IPsec) as initially developed by the Internet Engineering Task Force (IETF) for IPv6, which was required in all standards-compliant implementations of IPv6 before RFC 6434 made it only a recommendation. This standards-based security protocol is also widely used with IPv4 and the Layer 2 Tunneling Protocol. Its design meets most security goals: authentication, integrity, and confidentiality. IPsec uses encryption, encapsulating an IP packet inside an IPsec packet. De-encapsulation happens at the end of the tunnel, where the original IP packet is decrypted and forwarded to its intended destination. 2) Transport Layer Security (SSL/TLS) can tunnel an entire network's traffic (as it does in the OpenVPN project and SoftEther VPN project) or secure an individual connection. A number of vendors provide remote-access VPN capabilities through SSL. An SSL VPN can connect from locations where IPsec runs into trouble with Network Address Translation and firewall rules. 3) Datagram Transport Layer Security (DTLS)—used in Cisco AnyConnect VPN and in OpenConnect VPN to solve the issues SSL/TLS has with tunneling over UDP. 4) Microsoft Point-to-Point Encryption (MPPE) works with the Point-to-Point Tunneling Protocol and in several compatible implementations on other platforms. 5) Microsoft Secure Socket Tunneling Protocol (SSTP) tunnels Point-to-Point Protocol (PPP) or Layer 2 Tunneling Protocol traffic through an SSL 3.0 channel. (SSTP was introduced in Windows Server 2008 and in Windows Vista Service Pack 1.) 6) Multi Path Virtual Private Network (MPVPN). Ragula Systems Development Company owns the registered trademark “MPVPN”. 7) Secure Shell (SSH) VPN—OpenSSH offers VPN tunneling (distinct from port forwarding) to secure remote connections to a network or to inter-network links. OpenSSH server provides a limited number of concurrent tunnels. The VPN feature itself does not support personal authentication.

Tunnel endpoints must be authenticated before secure VPN tunnels can be established. User-created remote-access VPNs may use passwords, biometrics, two-factor authentication or other cryptographic methods. Network-to-network tunnels often use passwords or digital certificates. They permanently store the key to allow the tunnel to establish automatically, without intervention from the user.

Tunneling protocols can operate in a point-to-point network topology that would theoretically not be considered a VPN, because a VPN by definition is expected to support arbitrary and changing sets of network nodes. But since most router implementations support a software-defined tunnel interface, customer-provisioned VPNs often are simply defined tunnels running conventional routing protocols.

Depending on whether a provider-provisioned VPN (PPVPN) operates in layer 2 or layer 3, the building blocks described below may be L2 only, L3 only, or combine them both. Multiprotocol label switching (MPLS) functionality blurs the L2-L3 identity.

RFC 4026 generalized the following terms to cover L2 and L3 VPNs, but they were introduced in RFC 2547. More information on the devices below can also be found in Lewis, Cisco Press.

Customer (C) devices are a device that is within a customer's network and not directly connected to the service provider's network. C devices are not aware of the VPN.

Customer Edge device (CE) is device at the edge of the customer's network which provides access to the PPVPN. Sometimes it's just a demarcation point between provider and customer responsibility. Other providers allow customers to configure it.

Provider edge device (PE) is a device, or set of devices, at the edge of the provider network which connects to customer networks through CE devices and presents the provider's view of the customer site. PEs is aware of the VPNs that connect through them, and maintain VPN state.

Provider device (P) is a device operates inside the provider's core network and does not directly interface to any customer endpoint. It might, for example, provide routing for many provider-operated tunnels that belong to different customers' PPVPNs. While the P device is a key part of implementing PPVPNs, it is not itself VPN-aware and does not maintain VPN state. Its principal role is allowing the service provider to scale its PPVPN offerings, for example, by acting as an aggregation point for multiple PEs. P-to-P connections, in such a role, often are high-capacity optical links between major locations of providers.

A Layer 2 technique that allow for the coexistence of multiple LAN broadcast domains, interconnected via trunks using the IEEE 802.1Q trunking protocol. Other trunking protocols have been used but have become obsolete, including Inter-Switch Link (ISL), IEEE 802.10 (originally a security protocol but a subset was introduced for trunking), and ATM LAN Emulation (LANE).

Developed by IEEE, Virtual private LAN services (VLANs) allow multiple tagged LANs to share common trunking. VLANs frequently comprise only customer-owned facilities. Whereas VPLS as described in the above section (OSI Layer 1 services) supports emulation of both point-to-point and point-to-multipoint topologies, the method discussed here extends Layer 2 technologies such as 802.1d and 802.1q LAN trunking to run over transports such as Metro Ethernet.

As used in this context, a VPLS is a Layer 2 PPVPN, rather than a private line, emulating the full functionality of a traditional local area network (LAN). From a user standpoint, a VPLS makes it possible to interconnect several LAN segments over a packet-switched, or optical, provider core; a core transparent to the user, making the remote LAN segments behave as one single LAN.

PEs understands the topology of each VPN, which are interconnected with MPLS tunnels, either directly or via P routers. In MPLS terminology, the P routers are Label Switch Routers without awareness of VPNs.

Virtual router (PPVPN) as opposed to BGP/MPLS techniques, requires no modification to existing routing protocols such as BGP. By the provisioning of logically independent routing domains, the customer operating a VPN is completely responsible for the address space. In the various MPLS tunnels, the different PPVPNs are disambiguated by their label, but do not need routing distinguishers.

Some virtual networks may not use encryption to protect the privacy of data. While VPNs often provide security, an unencrypted overlay network does not neatly fit within the secure or trusted categorization. For example, a tunnel set up between two hosts that used Generic Routing Encapsulation (GRE) would in fact be a virtual private network, but neither secure nor trusted.

Native plaintext tunneling protocols include Layer 2 Tunneling Protocol (L2TP) when it is set up without IPsec and Point-to-Point Tunneling Protocol (PPTP) or Microsoft Point-to-Point Encryption (MPPE).

Trusted VPNs do not use cryptographic tunneling, and instead rely on the security of a single provider's network to protect the traffic. Multi-Protocol Label Switching (MPLS) often overlays VPNs, often with quality-of-service control over a trusted delivery network. Layer 2 Tunneling Protocol (L2TP) which is a standards-based replacement, and a compromise taking the good features from each, for two proprietary VPN protocols: Cisco's Layer 2 Forwarding (L2F) (obsolete as of 2009) and Microsoft's Point-to-Point Tunneling Protocol (PPTP).

From the security standpoint, VPNs either trust the underlying delivery network, or must enforce security with mechanisms in the VPN itself. Unless the trusted delivery network runs among physically secure sites only, both trusted and secure models need an authentication mechanism for users to gain access to the VPN.

Mobile VPNs are used in a setting where an endpoint of the VPN is not fixed to a single IP address, but instead roams across various networks such as data networks from cellular carriers or between multiple Wi-Fi access points. Mobile VPNs have been widely used in public safety, where they give law enforcement officers access to mission-critical applications, such as computer-assisted dispatch and criminal databases, while they travel between different subnets of a mobile network. They are also used in field service management and by healthcare organizations, among other industries.

Increasingly, mobile VPNs are being adopted by mobile professionals who need reliable connections. They are used for roaming seamlessly across networks and in and out of wireless coverage areas without losing application sessions or dropping the secure VPN session. A conventional VPN cannot survive such events because the network tunnel is disrupted, causing applications to disconnect, time out, or fail, or even cause the computing device itself to crash.

Instead of logically tying the endpoint of the network tunnel to the physical IP address, each tunnel is bound to a permanently associated IP address at the device. The mobile VPN software handles the necessary network authentication and maintains the network sessions in a manner transparent to the application and the user. The Host Identity Protocol (HIP), under study by the Internet Engineering Task Force, is designed to support mobility of hosts by separating the role of IP addresses for host identification from their locator functionality in an IP network. With HIP a mobile host maintains its logical connections established via the host identity identifier while associating with different IP addresses when roaming between access networks.

### 3. APPARATUS OF MULTIMEDIA STREAMING BETWEEN HETEROGENEOUS COMPUTER SYSTEMS

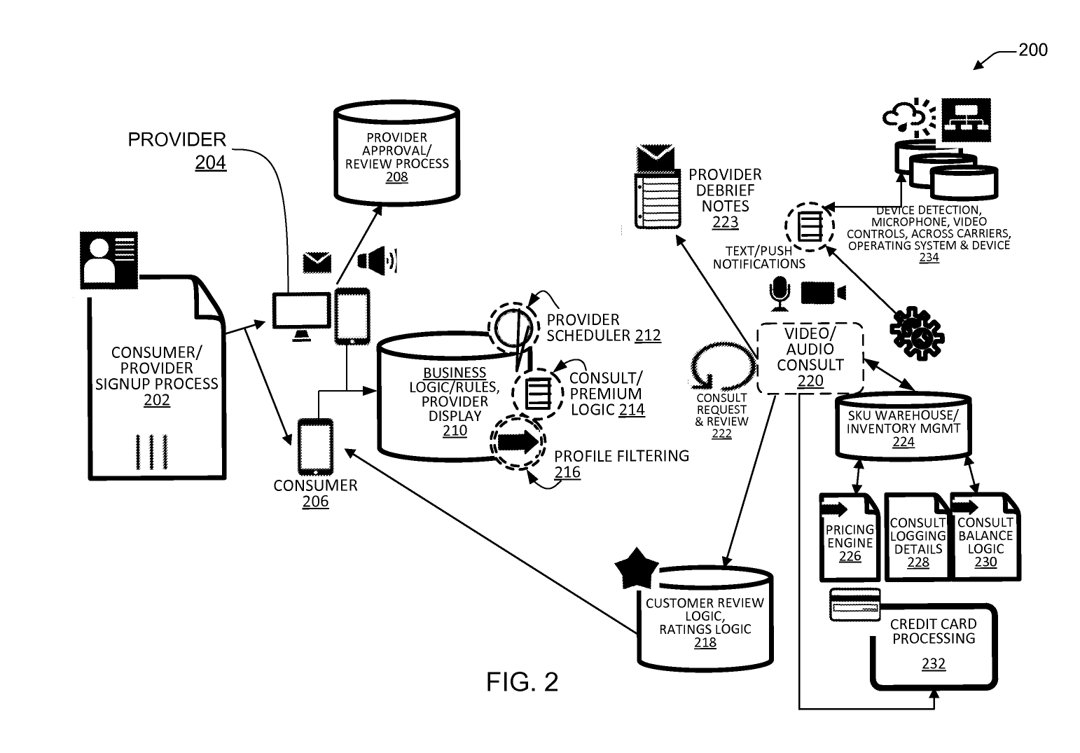

FIG. 2 is a block diagram of an apparatus 200 of multimedia streaming between heterogeneous computer systems, according to an implementation.

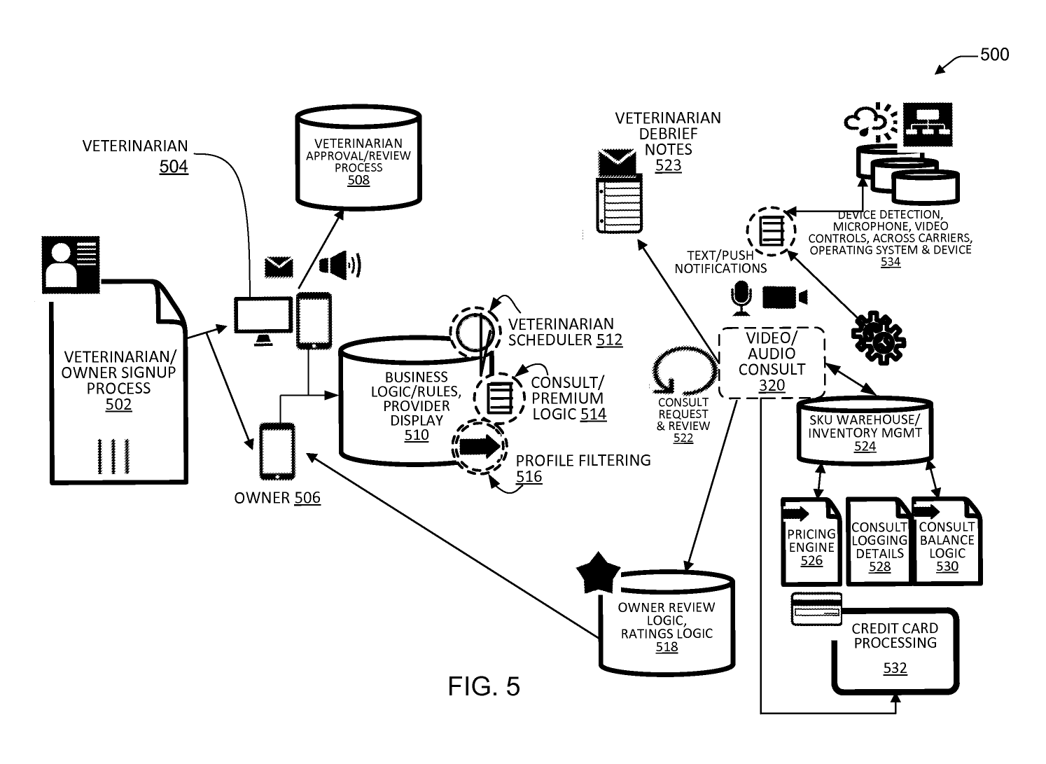

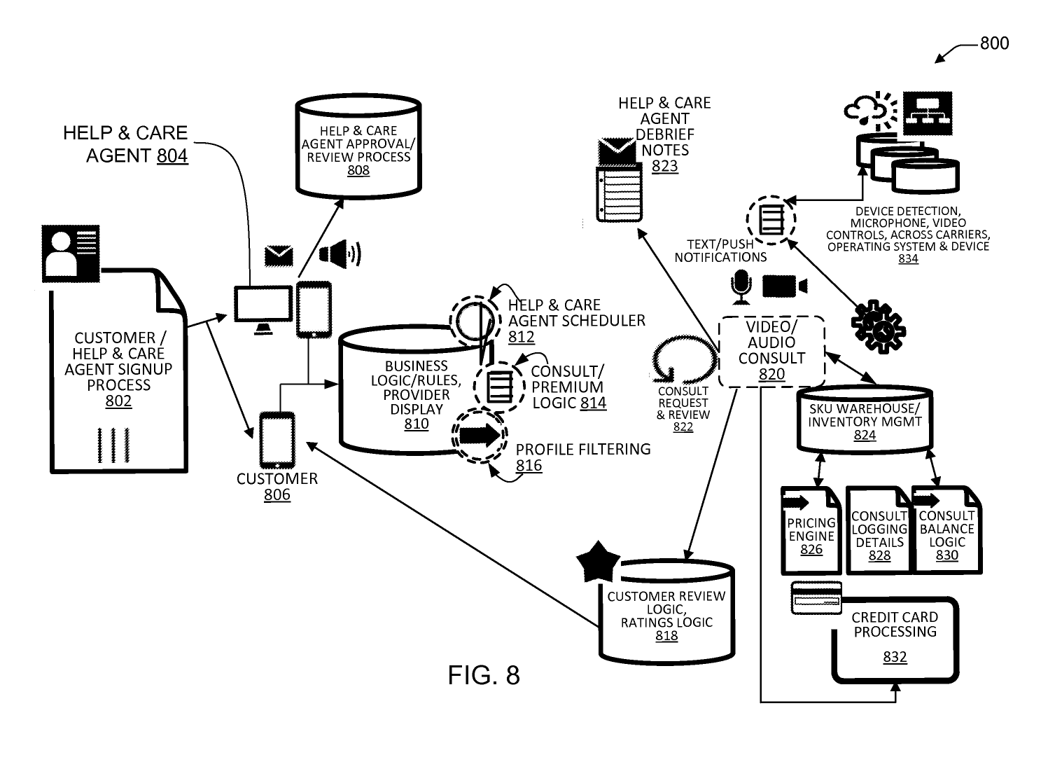

The apparatus 200 of multimedia streaming between heterogeneous computer systems includes a subscription process 202 (also known as a sign-up process) for a provider that is associated with a provider multimedia computing system 204 and a consumer that is associated with a consumer multimedia computing system 206. The subscription process 202 includes creating and populating a record that includes fields that describe or represent of the consumer a first name, a last name, a state, a zip code, an email address, a phone number, a password for the apparatus 200, and a checkbox indicating consent by the consumer to the terms and conditions of the apparatus 200. A login from a social media website will also populate the record. The subscription process 202 is also performed for the client in FIGS. 3-4 and 6-7, the owner in FIG. 5 and the customer in FIG. 8-10.

Quite commonly, the provider multimedia computing system 204 and the consumer multimedia computing system 206 are heterogeneous computing systems with significant differences in all capabilities, including differences in operating systems and performance of the hardware that can have significant effects on the multimedia interaction with other computing systems.

The provider that is associated with the provider multimedia computing system 204 is subject to a provider approval/review process 208 that can include review of any applicable licensing of the provider. For example, the provider approval/review process 208 can include rejecting a provider as a subscriber to the apparatus 200 of multimedia streaming between heterogeneous computer systems because the provider does not hold a license that is deemed in the provider approval/review process 208 as required to establish sufficient competence to participate as a subscriber to the apparatus 200. The approval/review process 208 also includes status of rejected and suspended status of each approved provider.

The apparatus 200 of multimedia streaming between heterogeneous computer systems also includes a controller 210 of business-logic-and-rules-and-provider-display. The controller 210 of business-logic-and-rules-and-provider-display is intermittently coupled to the provider multimedia computing system 204 and the controller 210 of business-logic-and-rules-and-provider-display is intermittently coupled to the consumer multimedia computing system 206. The controller 210 of business-logic-and-rules-and-provider-display includes a scheduler of providers 212 that is populated with data from the provider multimedia computing system 204 and that is accessed by the consumer multimedia computing system 206. The controller 210 of business-logic-and-rules-and-provider-display includes a controller of consultation and premium logic 214 and a profile filter 216. The provider multimedia computing system 204 can access the provider-display (also known as the ‘provider dashboard’) of the controller 210 of business-logic-and-rules-and-provider-display through a web browser via HTTP in order to update the profile of the provider, [except the professional license number(s)] and to add funds to the provider account.

The apparatus 200 of multimedia streaming between heterogeneous computer systems also includes a controller of consumer-review-logic-and-ratings-logic 218 that is operably coupled to the consumer multimedia computing system 206. The controller of consumer-review-logic-and-ratings-logic 218 instantiates a multimedia (audio and/or video) teleconference 220 between the provider multimedia computing system and the consumer multimedia computing system 206 upon receipt of a teleconference consultation request 222. At the termination of the multimedia teleconference 220, the controllers of consumer-review-logic-and-ratings-logic 218 controls the review logic and ratings logic and debrief notes 223 are transmitted to the provider multimedia computing system 204.

The multimedia teleconference 220 is performed in reference to data provided by a stock keeping unit (SKU) warehouse and inventory management controller 224. SKU is a number or string of alpha and numeric characters that uniquely identifies a product or service. The SKU warehouse and inventory management controller 224 operates in reference to a pricing engine 226, a teleconference log 228 and multimedia teleconference balance logic 230. A credit card processing module 232 provides data to the teleconference log 228 and multimedia teleconference balance logic 230.

At the termination of the multimedia teleconference 220, the controllers of consumer-review-logic-and-ratings-logic 218 controls the review logic and ratings logic and debrief notes 223 are transmitted to the provider multimedia computing system 204. One example of the review logic and ratings logic for FIGS. 2, 3, 4, 5, 6, 7, 8, 9 and 10 is shown below in Table A:

TABLE A

| Question | Option | Notes | |
|---|---|---|---|
| Overall | Possible 5 stars | Ability to click on # of stars | |
| Experience | | | |
| How likely | sliding scale 1-10 (below 10 “extremely | ability to move scale to number, | |
| would you | likely”, 1 “not at all” | have 1, 5, 10 under scale | |
| recommend | | | |
| this lawyer | | | |
| to | | | |
| consultation | | | |
| with a friend | | | |
| or family | | | |
| member? | | | |
| Quick | open text box maximum 200 characters | display first 75 characters under | |
| Review | | review in profile page with # of | |
| Notes | | stars given | |
| Scoring | | | |
| Logic | | | |
| # of stars | two point each (70% weight) | 1-5 stars are 2 points each, i.e.. | |
| | | Half star is one point | |
| How likely | one point each (30% weight) | 1-5 score (scale range) | |
| to | | | |
| recommend? | | | |
| Review total | each review has a possible of 20 points | each star is 3 points, so total #/5 | |
| | | show how many overall stars | |
| Take total of | display # of stars based on totals/average | | |
| all reviews | | | |
| Example | | | |
| Review 1: 4 | 8 star points, 9 points total 17 | (8/10) * 0.7 + (9/10) * 0.3 | 8.3 Total* |
| stars, 9 how | | | |
| likely | | | |
| Review 2: 3 | 6 star points, 7 points, total 13 | (6/10) * 0.7 + (7/10) * 0.3 | 6.3 Total |
| stars, 7 | | | |
| likely | | | |
| So mean | 8.3 + 6.3/2 = 7.3 | 7.3/2 (number of total reviews | 3.65 stars |
| stars for total | | | |
| review | | | |

*This would show 4.15 stars

In regards to the significant differences in operating systems and performance of the hardware in the heterogeneous computing systems of the provider multimedia computing system 204 and the consumer multimedia computing system 206, capabilities detection 234 of the provider multimedia computing system 204 and the consumer multimedia computing system 206 is performed, such as detection of the model, microphone, video controls, camera, processor speed, bus speed, amount of cache memory, amount of non-cache memory, telecom carrier and operating system are performed. The possible parameters of the multimedia teleconference 220 are determined based in the detected capabilities. For example, if no camera is detected at least one of the provider multimedia computing system 204 and the consumer multimedia computing system 206, then the multimedia teleconference 220 can be established but is limited to an audio teleconference 220. If a camera is detected, but the image resolution that is detected on one of the provider multimedia computing system 204 and the consumer multimedia computing system 206 is low resolution, then the multimedia teleconference 220 can be established but is limited to a low-res video teleconference 220. If no microphone is detected on either the provider multimedia computing system 204 or the consumer multimedia computing system 206, then the multimedia teleconference 220 is not allowed until a microphone is detected on the provider multimedia computing system 204 and the consumer multimedia computing system 206. Significant error logic, connect logic, time out logic and wait messaging notifications have been established. When the multimedia teleconference 220 can be established, the communication between the provider multimedia computing system 204 and the consumer multimedia computing system 206 is highly interactive and information is exchanged in real-time between the provider multimedia computing system 204 and the consumer multimedia computing system 206, in comparison to slower email-based systems of communication between the provider multimedia computing system 204 and the consumer multimedia computing system 206.

FIG. 3 is a block diagram of an overview of apparatus 300 of multimedia streaming between heterogeneous computer systems, according to an attorney/client implementation.

The apparatus 300 of multimedia streaming between heterogeneous computer systems includes a subscription process 302 (also known as a sign-up process) for a lawyer that is associated with a lawyer multimedia computing system 304 and a client that is associated with a client multimedia computing system 306. Quite commonly, the lawyer multimedia computing system 304 and the client multimedia computing system 306 are heterogeneous computing systems with significant differences in all capabilities, including differences in operating systems and performance of the hardware that can have significant effects on the multimedia interaction with other computing systems.

The lawyer that is associated with the lawyer multimedia computing system 304 is subject to a lawyer approval/review process 308 that can include review of any applicable licensing of the lawyer. For example, the lawyer approval/review process 308 can include rejecting a lawyer as a subscriber to the apparatus 300 of multimedia streaming between heterogeneous computer systems because the lawyer does not hold a license that is deemed in the lawyer approval/review process 308 as required to establish sufficient competence to participate as a subscriber to the apparatus 300. The approval/review process 308 also includes status of rejected and suspended status of approved lawyer.

The apparatus 300 of multimedia streaming between heterogeneous computer systems also includes a controller 310 of business-logic-and-rules-and-lawyer-display. The controller 310 of business-logic-and-rules-and-lawyer-display is intermittently coupled to the lawyer multimedia computing system 304 and the controller 310 of business-logic-and-rules-and-lawyer-display is intermittently coupled to the client multimedia computing system 306. The controller 310 of business-logic-and-rules-and-lawyer-display includes a scheduler of lawyers 312 that is populated with data from the lawyer multimedia computing system 304 and that is accessed by the client multimedia computing system 306. The controller 310 of business-logic-and-rules-and-lawyer-display includes a controller of consultation and premium logic 314 and a profile filter 316. The lawyer multimedia computing system 304 can access the lawyer-display (also known as the ‘lawyer dashboard’) of the controller 310 of business-logic-and-rules-and-lawyer-display through a web browser via HTTP in order to update the profile of the lawyer, [except the professional license number(s)] and to add funds to the lawyer account.

The apparatus 300 of multimedia streaming between heterogeneous computer systems also includes a controller of client-review-logic-and-ratings-logic 318 that is operably coupled to the client multimedia computing system 306. The controller of client-review-logic-and-ratings-logic 318 instantiates a multimedia (audio and/or video) teleconference 320 between the lawyer multimedia computing system and the client multimedia computing system 306 upon receipt of a teleconference consultation request 322. At the termination of the multimedia teleconference 320, the controllers of client-review-logic-and-ratings-logic 318 controls the review logic and ratings logic and debrief notes 323 are transmitted to the lawyer multimedia computing system 304. The multimedia teleconference 320 is performed in reference to data provided by a SKU warehouse and inventory management controller 324. The SKU warehouse and inventory management controller 324 operates in reference to a pricing engine 326, a teleconference log 328 and multimedia teleconference balance logic 330. A credit card processing module 332 provides data to the teleconference log 328 and multimedia teleconference balance logic 330.

In regards to the significant differences in operating systems and performance of the hardware in the heterogeneous computing systems of the lawyer multimedia computing system 304 and the client multimedia computing system 306, capabilities detection 334 of the lawyer multimedia computing system 304 and the client multimedia computing system 306 is performed, such as detection of the model, microphone, video controls, camera, processor speed, bus speed, amount of cache memory, amount of non-cache memory, telecom carrier and operating system are performed. The possible parameters of the multimedia teleconference 320 are determined based in the detected capabilities. For example, if no camera is detected at least one of the lawyer multimedia computing system 304 and the client multimedia computing system 306, then the multimedia teleconference 320 can be established but is limited to an audio teleconference 320. If a camera is detected, but the image resolution that is detected on one of the lawyer multimedia computing system 304 and the client multimedia computing system 306 is low resolution, then the multimedia teleconference 320 can be established but is limited to a low-res video teleconference 320. If no microphone is detected on either the lawyer multimedia computing system 304 or the client multimedia computing system 306, then the multimedia teleconference 320 is not allowed until a microphone is detected on the lawyer multimedia computing system 304 and the client multimedia computing system 306. When the multimedia teleconference 320 can be established, the communication between the lawyer multimedia computing system 304 and the client multimedia computing system 306 is highly interactive and information is exchanged in real-time between the lawyer multimedia computing system 304 and the client multimedia computing system 306, in comparison to slower email-based systems of communication between the lawyer multimedia computing system 304 and the client multimedia computing system 306.

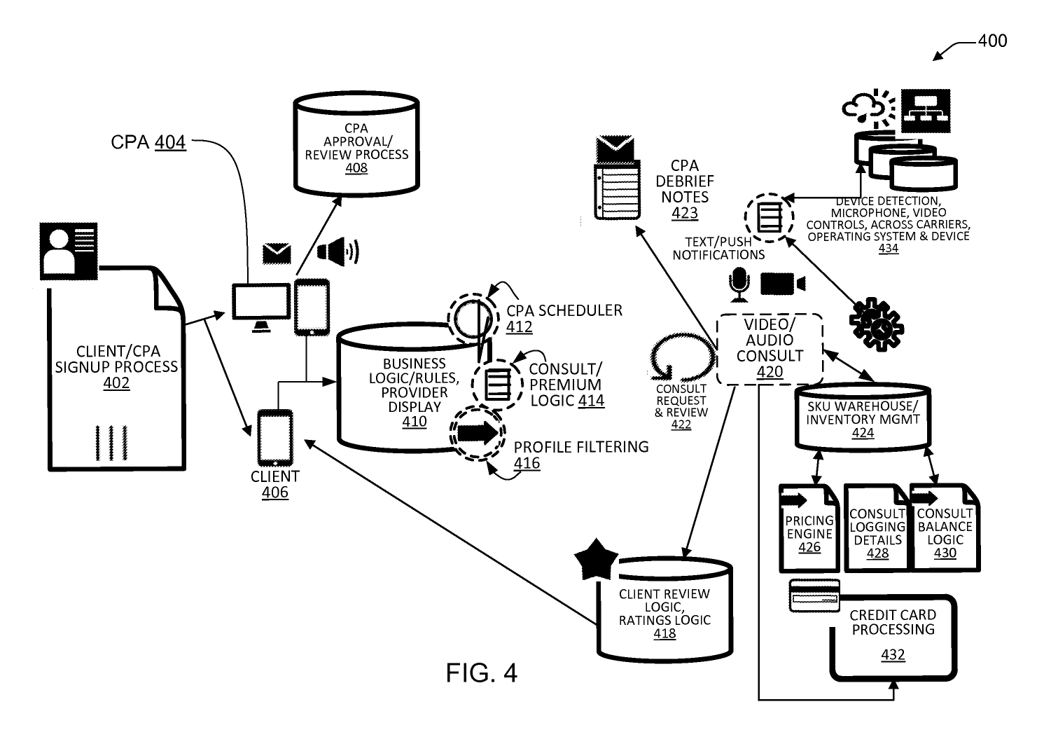

FIG. 4 is a block diagram of an overview of apparatus 400 of multimedia streaming between heterogeneous computer systems, according to a certified public accountant (CPA)/client implementation.

The apparatus 400 of multimedia streaming between heterogeneous computer systems includes a subscription process 402 (also known as a sign-up process) for a Certified Public Accountant (CPA) that is associated with a CPA multimedia computing system 404 and a client that is associated with a client multimedia computing system 406. Quite commonly, the CPA multimedia computing system 404 and the client multimedia computing system 406 are heterogeneous computing systems with significant differences in all capabilities, including differences in operating systems and performance of the hardware that can have significant effects on the multimedia interaction with other computing systems.

The CPA that is associated with the CPA multimedia computing system 404 is subject to a CPA approval/review process 408 that can include review of any applicable licensing of the CPA. For example, the CPA approval/review process 408 can include rejecting a CPA as a subscriber to the apparatus 400 of multimedia streaming between heterogeneous computer systems because the CPA does not hold a license that is deemed in the CPA approval/review process 408 as required to establish sufficient competence to participate as a subscriber to the apparatus 400. The approval/review process 408 also includes status of rejected and suspended status of each approved CPA.

The apparatus 400 of multimedia streaming between heterogeneous computer systems also includes a controller 410 of business-logic-and-rules-and-CPA-display. The controller 410 of business-logic-and-rules-and-CPA-display is intermittently coupled to the CPA multimedia computing system 404 and the controller 410 of business-logic-and-rules-and-CPA-display is intermittently coupled to the client multimedia computing system 406. The controller 410 of business-logic-and-rules-and-CPA-display includes a scheduler of CPAs 412 that is populated with data from the CPA multimedia computing system 404 and that is accessed by the client multimedia computing system 406. The controller 410 of business-logic-and-rules-and-CPA-display includes a controller of consultation and premium logic 414 and a profile filter 416. The CPA multimedia computing system 404 can access the CPA-display (also known as the ‘CPA dashboard’) of the controller 410 of business-logic-and-rules-and-CPA-display through a web browser via HTTP in order to update the profile of the CPA, [except the professional license number(s)] and to add funds to the CPA account.

The apparatus 400 of multimedia streaming between heterogeneous computer systems also includes a controller of client-review-logic-and-ratings-logic 418 that is operably coupled to the client multimedia computing system 406. The controller of client-review-logic-and-ratings-logic 418 instantiates a multimedia (audio and/or video) teleconference 420 between the CPA multimedia computing system and the client multimedia computing system 406 upon receipt of a teleconference consultation request 422. At the termination of the multimedia teleconference 420, the controllers of client-review-logic-and-ratings-logic 418 controls the review logic and ratings logic and debrief notes 423 are transmitted to the CPA multimedia computing system 404. The multimedia teleconference 420 is performed in reference to data provided by a SKU warehouse and inventory management controller 424. The SKU warehouse and inventory management controller 424 operates in reference to a pricing engine 426, a teleconference log 428 and multimedia teleconference balance logic 430. A credit card processing module 432 provides data to the teleconference log 428 and multimedia teleconference balance logic 430.

In regards to the significant differences in operating systems and performance of the hardware in the heterogeneous computing systems of the CPA multimedia computing system 404 and the client multimedia computing system 406, capabilities detection 434 of the CPA multimedia computing system 404 and the client multimedia computing system 406 is performed, such as detection of the model, microphone, video controls, camera, processor speed, bus speed, amount of cache memory, amount of non-cache memory, telecom carrier and operating system are performed. The possible parameters of the multimedia teleconference 420 are determined based in the detected capabilities. For example, if no camera is detected at least one of the CPA multimedia computing system 404 and the client multimedia computing system 406, then the multimedia teleconference 420 can be established but is limited to an audio teleconference 420. If a camera is detected, but the image resolution that is detected on one of the CPA multimedia computing system 404 and the client multimedia computing system 406 is low resolution, then the multimedia teleconference 420 can be established but is limited to a low-res video teleconference 420. If no microphone is detected on either the CPA multimedia computing system 404 or the client multimedia computing system 406, then the multimedia teleconference 420 is not allowed until a microphone is detected on the CPA multimedia computing system 404 and the client multimedia computing system 406. When the multimedia teleconference 420 can be established, the communication between the CPA multimedia computing system 404 and the client multimedia computing system 406 is highly interactive and information is exchanged in real-time between the CPA multimedia computing system 404 and the client multimedia computing system 406, in comparison to slower email-based systems of communication between the CPA multimedia computing system 404 and the client multimedia computing system 406.

FIG. 5 is a block diagram of an overview of apparatus 500 of multimedia streaming between heterogeneous computer systems, according to a veterinarian/owner implementation.

The apparatus 500 of multimedia streaming between heterogeneous computer systems includes a subscription process 502 (also known as a sign-up process) for a Veterinarian that is associated with a Veterinarian multimedia computing system 504 and an owner that is associated with an owner multimedia computing system 506. Quite commonly, the Veterinarian multimedia computing system 504 and the owner multimedia computing system 506 are heterogeneous computing systems with significant differences in all capabilities, including differences in operating systems and performance of the hardware that can have significant effects on the multimedia interaction with other computing systems.

The Veterinarian that is associated with the Veterinarian multimedia computing system 504 is subject to a Veterinarian approval/review process 508 that can include review of any applicable licensing of the Veterinarian. For example, the Veterinarian approval/review process 508 can include rejecting a Veterinarian as a subscriber to the apparatus 500 of multimedia streaming between heterogeneous computer systems because the Veterinarian does not hold a license that is deemed in the Veterinarian approval/review process 508 as required to establish sufficient competence to participate as a subscriber to the apparatus 500. The approval/review process 508 also includes status of rejected and suspended status of each approved Veterinarian.

The apparatus 500 of multimedia streaming between heterogeneous computer systems also includes a controller 510 of business-logic-and-rules-and-Veterinarian-display. The controller 510 of business-logic-and-rules-and-Veterinarian-display is intermittently coupled to the Veterinarian multimedia computing system 504 and the controller 510 of business-logic-and-rules-and-Veterinarian-display is intermittently coupled to the owner multimedia computing system 506. The controller 510 of business-logic-and-rules-and-Veterinarian-display includes a scheduler of Veterinarians 512 that is populated with data from the Veterinarian multimedia computing system 504 and that is accessed by the owner multimedia computing system 506. The controller 510 of business-logic-and-rules-and-Veterinarian-display includes a controller of consultation and premium logic 514 and a profile filter 516. The Veterinarian multimedia computing system 504 can access the Veterinarian-display (also known as the ‘Veterinarian dashboard’) of the controller 510 of business-logic-and-rules-and-Veterinarian-display through a web browser via HTTP in order to update the profile of the Veterinarian, [except the professional license number(s)] and to add funds to the Veterinarian account.

The apparatus 500 of multimedia streaming between heterogeneous computer systems also includes a controller of owner-review-logic-and-ratings-logic 518 that is operably coupled to the owner multimedia computing system 506. The controller of owner-review-logic-and-ratings-logic 518 instantiates a multimedia (audio and/or video) teleconference 520 between the Veterinarian multimedia computing system and the owner multimedia computing system 506 upon receipt of a teleconference consultation request 522. At the termination of the multimedia teleconference 520, the controllers of owner-review-logic-and-ratings-logic 518 controls the review logic and ratings logic and debrief notes 523 are transmitted to the Veterinarian multimedia computing system 504. The multimedia teleconference 520 is performed in reference to data provided by a SKU warehouse and inventory management controller 524. The SKU warehouse and inventory management controller 524 operates in reference to a pricing engine 526, a teleconference log 528 and multimedia teleconference balance logic 530. A credit card processing module 532 provides data to the teleconference log 528 and multimedia teleconference balance logic 530.

In regards to the significant differences in operating systems and performance of the hardware in the heterogeneous computing systems of the Veterinarian multimedia computing system 504 and the owner multimedia computing system 506, capabilities detection 534 of the Veterinarian multimedia computing system 504 and the owner multimedia computing system 506 is performed, such as detection of the model, microphone, video controls, camera, processor speed, bus speed, amount of cache memory, amount of non-cache memory, telecom carrier and operating system are performed. The possible parameters of the multimedia teleconference 520 are determined based in the detected capabilities. For example, if no camera is detected at least one of the Veterinarian multimedia computing system 504 and the owner multimedia computing system 506, then the multimedia teleconference 520 can be established but is limited to an audio teleconference 520. If a camera is detected, but the image resolution that is detected on one of the Veterinarian multimedia computing system 504 and the owner multimedia computing system 506 is low resolution, then the multimedia teleconference 520 can be established but is limited to a low-res video teleconference 520. If no microphone is detected on either the Veterinarian multimedia computing system 504 or the owner multimedia computing system 506, then the multimedia teleconference 520 is not allowed until a microphone is detected on the Veterinarian multimedia computing system 504 and the owner multimedia computing system 506. When the multimedia teleconference 520 can be established, the communication between the Veterinarian multimedia computing system 504 and the owner multimedia computing system 506 is highly interactive and information is exchanged in real-time between the Veterinarian multimedia computing system 504 and the owner multimedia computing system 506, in comparison to slower email-based systems of communication between the Veterinarian multimedia computing system 504 and the owner multimedia computing system 506.

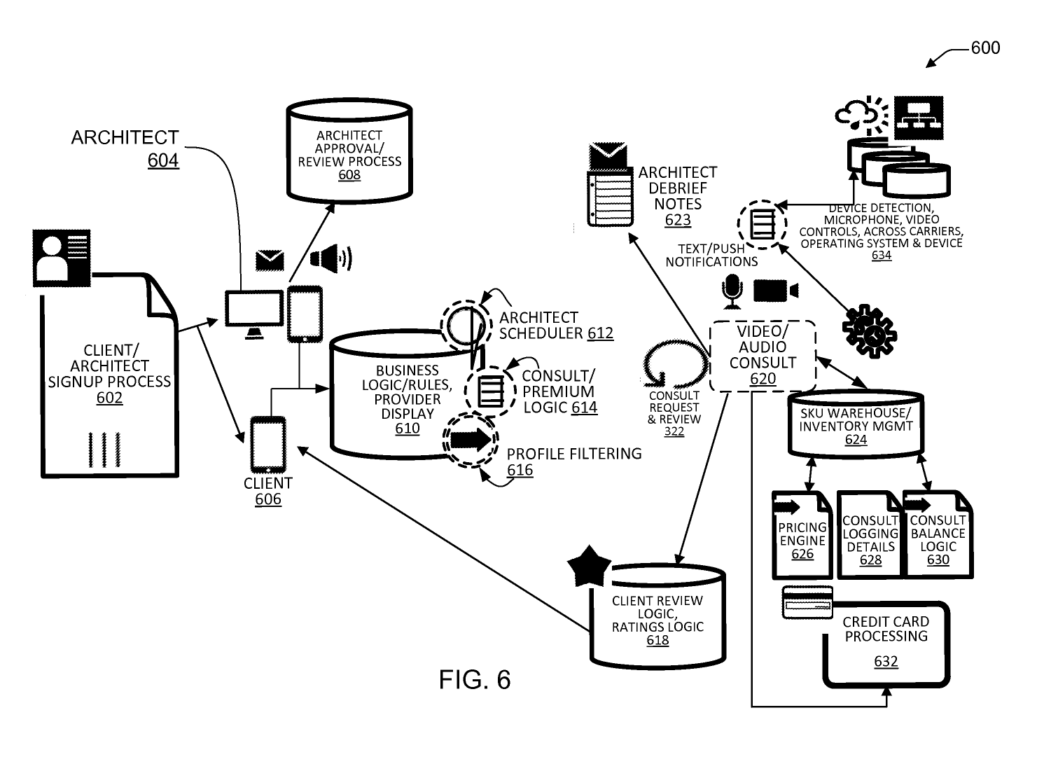

FIG. 6 is a block diagram of an overview of apparatus 600 of multimedia streaming between heterogeneous computer systems, according to an architect/client implementation.

The apparatus 600 of multimedia streaming between heterogeneous computer systems includes a subscription process 602 (also known as a sign-up process) for a Architect that is associated with a Architect multimedia computing system 604 and a client that is associated with a client multimedia computing system 606. Quite commonly, the Architect multimedia computing system 604 and the client multimedia computing system 606 are heterogeneous computing systems with significant differences in all capabilities, including differences in operating systems and performance of the hardware that can have significant effects on the multimedia interaction with other computing systems.

The Architect that is associated with the Architect multimedia computing system 604 is subject to an Architect approval/review process 608 that can include review of any applicable licensing of the Architect. For example, the Architect approval/review process 608 can include rejecting a Architect as a subscriber to the apparatus 600 of multimedia streaming between heterogeneous computer systems because the Architect does not hold a license that is deemed in the Architect approval/review process 608 as required to establish sufficient competence to participate as a subscriber to the apparatus 600. The approval/review process 608 also includes status of rejected and suspended status of each approved Architect.

The apparatus 600 of multimedia streaming between heterogeneous computer systems also includes a controller 610 of business-logic-and-rules-and-Architect-display. The controller 610 of business-logic-and-rules-and-Architect-display is intermittently coupled to the Architect multimedia computing system 604 and the controller 610 of business-logic-and-rules-and-Architect-display is intermittently coupled to the client multimedia computing system 606. The controller 610 of business-logic-and-rules-and-Architect-display includes a scheduler of Architects 612 that is populated with data from the Architect multimedia computing system 604 and that is accessed by the client multimedia computing system 606. The controller 610 of business-logic-and-rules-and-Architect-display includes a controller of consultation and premium logic 614 and a profile filter 616. The Architect multimedia computing system 604 can access the Architect-display (also known as the ‘Architect dashboard’) of the controller 610 of business-logic-and-rules-and-Architect-display through a web browser via HTTP in order to update the profile of the Architect, [except the professional license number(s)] and to add funds to the Architect account.

The apparatus 600 of multimedia streaming between heterogeneous computer systems also includes a controller of client-review-logic-and-ratings-logic 618 that is operably coupled to the client multimedia computing system 606. The controller of client-review-logic-and-ratings-logic 618 instantiates a multimedia (audio and/or video) teleconference 620 between the Architect multimedia computing system and the client multimedia computing system 606 upon receipt of a teleconference consultation request 622. At the termination of the multimedia teleconference 620, the controllers of client-review-logic-and-ratings-logic 618 controls the review logic and ratings logic and debrief notes 623 are transmitted to the Architect multimedia computing system 604. The multimedia teleconference 620 is performed in reference to data provided by a SKU warehouse and inventory management controller 624. The SKU warehouse and inventory management controller 624 operates in reference to a pricing engine 626, a teleconference log 628 and multimedia teleconference balance logic 630. A credit card processing module 632 provides data to the teleconference log 628 and multimedia teleconference balance logic 630.

In regards to the significant differences in operating systems and performance of the hardware in the heterogeneous computing systems of the Architect multimedia computing system 604 and the client multimedia computing system 606, capabilities detection 634 of the Architect multimedia computing system 604 and the client multimedia computing system 606 is performed, such as detection of the model, microphone, video controls, camera, processor speed, bus speed, amount of cache memory, amount of non-cache memory, telecom carrier and operating system are performed. The possible parameters of the multimedia teleconference 620 are determined based in the detected capabilities. For example, if no camera is detected at least one of the Architect multimedia computing system 604 and the client multimedia computing system 606, then the multimedia teleconference 620 can be established but is limited to an audio teleconference 620. If a camera is detected, but the image resolution that is detected on one of the Architect multimedia computing system 604 and the client multimedia computing system 606 is low resolution, then the multimedia teleconference 620 can be established but is limited to a low-res video teleconference 620. If no microphone is detected on either the Architect multimedia computing system 604 or the client multimedia computing system 606, then the multimedia teleconference 620 is not allowed until a microphone is detected on the Architect multimedia computing system 604 and the client multimedia computing system 606. When the multimedia teleconference 620 can be established, the communication between the Architect multimedia computing system 604 and the client multimedia computing system 606 is highly interactive and information is exchanged in real-time between the Architect multimedia computing system 604 and the client multimedia computing system 606, in comparison to slower email-based systems of communication between the Architect multimedia computing system 604 and the client multimedia computing system 606.

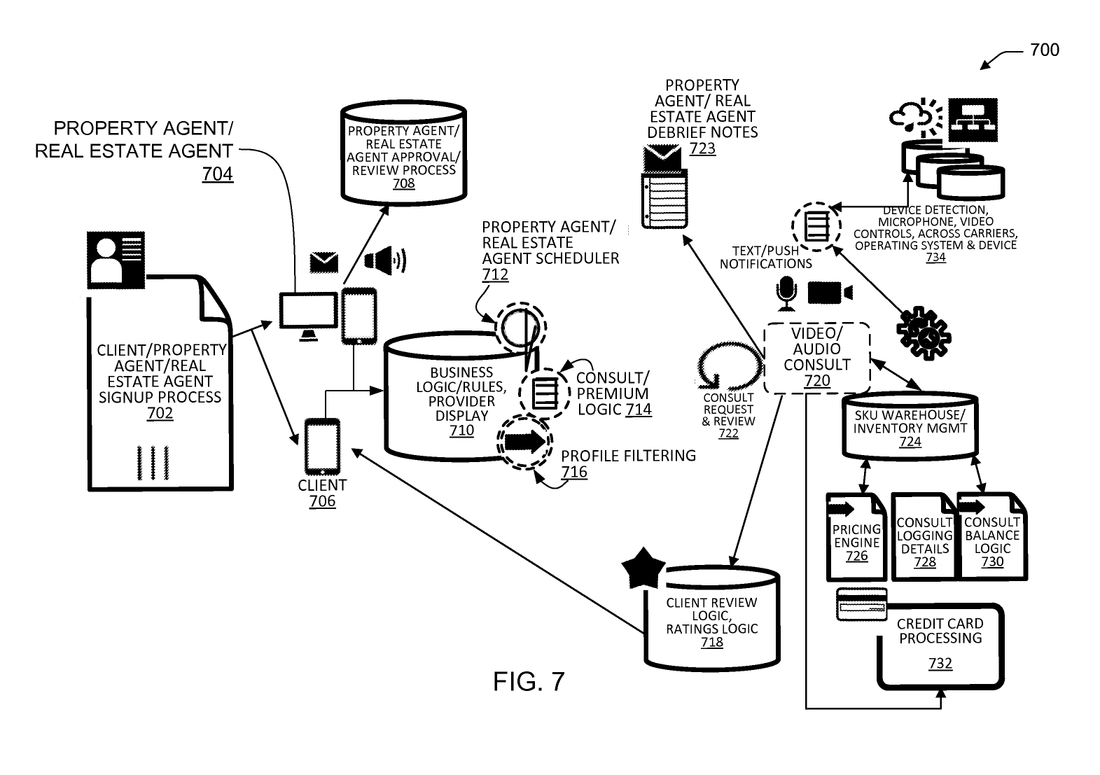

FIG. 7 is a block diagram of an overview of apparatus 700 of multimedia streaming between heterogeneous computer systems, according to a property agent/real estate agent and client implementation.

The apparatus 700 of multimedia streaming between heterogeneous computer systems includes a subscription process 702 (also known as a sign-up process) for a Property Agent/Real Estate Agent that is associated with a Property Agent/Real Estate Agent multimedia computing system 704 and a client that is associated with a client multimedia computing system 706. Quite commonly, the Property Agent/Real Estate Agent multimedia computing system 704 and the client multimedia computing system 706 are heterogeneous computing systems with significant differences in all capabilities, including differences in operating systems and performance of the hardware that can have significant effects on the multimedia interaction with other computing systems.

The Property Agent/Real Estate Agent that is associated with the Property Agent/Real Estate Agent multimedia computing system 704 is subject to a Property Agent/Real Estate Agent approval/review process 708 that can include review of any applicable licensing of the Property Agent/Real Estate Agent. For example, the Property Agent/Real Estate Agent approval/review process 708 can include rejecting a Property Agent/Real Estate Agent as a subscriber to the apparatus 700 of multimedia streaming between heterogeneous computer systems because the Property Agent/Real Estate Agent does not hold a license that is deemed in the Property Agent/Real Estate Agent approval/review process 708 as required to establish sufficient competence to participate as a subscriber to the apparatus 700. The approval/review process 708 also includes status of rejected and suspended status of each approved Property Agent/Real Estate Agent.

The apparatus 700 of multimedia streaming between heterogeneous computer systems also includes a controller 710 of business-logic-and-rules-and-Property-Agent/Real-Estate-Agent-display. The controller 710 of business-logic-and-rules-and-Property-Agent/Real-Estate-Agent-display is intermittently coupled to the Property Agent/Real Estate Agent multimedia computing system 704 and the controller 710 of business-logic-and-rules-and-Property-Agent/Real-Estate-Agent-display is intermittently coupled to the client multimedia computing system 706. The controller 710 of business-logic-and-rules-and-Property-Agent/Real-Estate-Agent-display includes a scheduler of Property Agent/Real Estate Agents 712 that is populated with data from the Property Agent/Real Estate Agent multimedia computing system 704 and that is accessed by the client multimedia computing system 706. The controller 710 of business logic and rules and of Property Agent/Real Estate Agent displays includes a controller of consultation and premium logic 714 and a profile filter 716. The Property-Agent/Real-Estate-Agent multimedia computing system 704 can access the Property-Agent/Real-Estate-Agent-display (also known as the ‘Property-Agent/Real-Estate-Agent dashboard’) of the controller 710 of business-logic-and-rules-and-Property-Agent/Real-Estate-Agent-display through a web browser via HTTP in order to update the profile of the Property-Agent/Real-Estate-Agent, [except the professional license number(s)] and to add funds to the Property-Agent/Real-Estate-Agent account.

The apparatus 700 of multimedia streaming between heterogeneous computer systems also includes a controller of client-review-logic-and-ratings-logic 718 that is operably coupled to the client multimedia computing system 706. The controller of client-review-logic-and-ratings-logic 718 instantiates a multimedia (audio and/or video) teleconference 720 between the Property Agent/Real Estate Agent multimedia computing system and the client multimedia computing system 706 upon receipt of a teleconference consultation request 722. At the termination of the multimedia teleconference 720, the controllers of client-review-logic-and-ratings-logic 718 controls the review logic and ratings logic and debrief notes 723 are transmitted to the Property Agent/Real Estate Agent multimedia computing system 704. The multimedia teleconference 720 is performed in reference to data provided by a SKU warehouse and inventory management controller 724. The SKU warehouse and inventory management controller 724 operates in reference to a pricing engine 726, a teleconference log 728 and multimedia teleconference balance logic 730. A credit card processing module 732 provides data to the teleconference log 728 and multimedia teleconference balance logic 730.

In regards to the significant differences in operating systems and performance of the hardware in the heterogeneous computing systems of the Property Agent/Real Estate Agent multimedia computing system 704 and the client multimedia computing system 706, capabilities detection 734 of the Property Agent/Real Estate Agent multimedia computing system 704 and the client multimedia computing system 706 is performed, such as detection of the model, microphone, video controls, camera, processor speed, bus speed, amount of cache memory, amount of non-cache memory, telecom carrier and operating system are performed. The possible parameters of the multimedia teleconference 720 are determined based in the detected capabilities. For example, if no camera is detected at least one of the Property Agent/Real Estate Agent multimedia computing system 704 and the client multimedia computing system 706, then the multimedia teleconference 720 can be established but is limited to an audio teleconference 720. If a camera is detected, but the image resolution that is detected on one of the Property Agent/Real Estate Agent multimedia computing system 704 and the client multimedia computing system 706 is low resolution, then the multimedia teleconference 720 can be established but is limited to a low-res video teleconference 720. If no microphone is detected on either the Property Agent/Real Estate Agent multimedia computing system 704 or the client multimedia computing system 706, then the multimedia teleconference 720 is not allowed until a microphone is detected on the Property Agent/Real Estate Agent multimedia computing system 704 and the client multimedia computing system 706. When the multimedia teleconference 720 can be established, the communication between the Property Agent/Real Estate Agent multimedia computing system 704 and the client multimedia computing system 706 is highly interactive and information is exchanged in real-time between the Property Agent/Real Estate Agent multimedia computing system 704 and the client multimedia computing system 706, in comparison to slower email-based systems of communication between the Property Agent/Real Estate Agent multimedia computing system 704 and the client multimedia computing system 706.

FIG. 8 is a block diagram of an overview of apparatus 800 of multimedia streaming between heterogeneous computer systems, according to a Help and Care Agent/customer implementation. Help is the ability to provide companies help hotlines high touch connections to people in need in order to make an immediate impact or difference. i.e. suicide hotlines, pregnancy/abortion, teens, gays/transgender. Care is the ability to provide companies customer service and/or call center agents the ability to provide virtual concierge type services via video and audio consultation. i.e. cable providers, banks etc.

The apparatus 800 of multimedia streaming between heterogeneous computer systems includes a subscription process 802 (also known as a sign-up process) for a Help and Care Agent that is associated with a Help and Care Agent multimedia computing system 804 and a customer that is associated with a customer multimedia computing system 806. Quite commonly, the Help and Care Agent multimedia computing system 804 and the customer multimedia computing system 806 are heterogeneous computing systems with significant differences in all capabilities, including differences in operating systems and performance of the hardware that can have significant effects on the multimedia interaction with other computing systems.

The Help and Care Agent that is associated with the Help and Care Agent multimedia computing system 804 is subject to a Help and Care Agent approval/review process 808 that can include review of any applicable licensing of the Help and Care Agent. For example, the Help and Care Agent approval/review process 808 can include rejecting a Help and Care Agent as a subscriber to the apparatus 800 of multimedia streaming between heterogeneous computer systems because the Help and Care Agent does not hold a license that is deemed in the Help and Care Agent approval/review process 808 as required to establish sufficient competence to participate as a subscriber to the apparatus 800. The approval/review process 808 also includes status of rejected and suspended status of each approved Help and Care Agent.

The apparatus 800 of multimedia streaming between heterogeneous computer systems also includes a controller 810 of business-logic-and-rules-and-Help-and-Care-display. The controller 810 of business-logic-and-rules-and-Help-and-Care-display is intermittently coupled to the Help and Care Agent multimedia computing system 804 and the controller 810 of business-logic-and-rules-and-Help-and-Care-display is intermittently coupled to the customer multimedia computing system 806. The controller 810 of business-logic-and-rules-and-Help-and-Care-display includes a scheduler of Help and Care Agents 812 that is populated with data from the Help and Care Agent multimedia computing system 804 and that is accessed by the customer multimedia computing system 806. The controller 810 of business-logic-and-rules-and-Help-and-Care-display includes a controller of consultation and premium logic 814 and a profile filter 816. The Help-and-Care multimedia computing system 804 can access the Help-and-Care-display (also known as the ‘Help-and-Care dashboard’) of the controller 810 of business-logic-and-rules-and-Help-and-Care-display through a web browser via HTTP in order to update the profile of the Help-and-Care, [except the professional license number(s)] and to add funds to the Help-and-Care account.

The apparatus 800 of multimedia streaming between heterogeneous computer systems also includes a controller of customer-review-logic-and-ratings-logic 818 that is operably coupled to the customer multimedia computing system 806. The controller of customer-review-logic-and-ratings-logic 818 instantiates a multimedia (audio and/or video) teleconference 820 between the Help and Care Agent multimedia computing system and the customer multimedia computing system 806 upon receipt of a teleconference consultation request 822. At the termination of the multimedia teleconference 820, the controllers of customer-review-logic-and-ratings-logic 818 controls the review logic and ratings logic and debrief notes 823 are transmitted to the Help and Care Agent multimedia computing system 804. The multimedia teleconference 820 is performed in reference to data provided by a SKU warehouse and inventory management controller 824. The SKU warehouse and inventory management controller 824 operates in reference to a pricing engine 826, a teleconference log 828 and multimedia teleconference balance logic 830. A credit card processing module 832 provides data to the teleconference log 828 and multimedia teleconference balance logic 830.

In regards to the significant differences in operating systems and performance of the hardware in the heterogeneous computing systems of the Help and Care Agent multimedia computing system 804 and the customer multimedia computing system 806, capabilities detection 834 of the Help and Care Agent multimedia computing system 804 and the customer multimedia computing system 806 is performed, such as detection of the model, microphone, video controls, camera, processor speed, bus speed, amount of cache memory, amount of non-cache memory, telecom carrier and operating system are performed. The possible parameters of the multimedia teleconference 820 are determined based in the detected capabilities. For example, if no camera is detected at least one of the Help and Care Agent multimedia computing system 804 and the customer multimedia computing system 806, then the multimedia teleconference 820 can be established but is limited to an audio teleconference 820. If a camera is detected, but the image resolution that is detected on one of the Help and Care Agent multimedia computing system 804 and the customer multimedia computing system 806 is low resolution, then the multimedia teleconference 820 can be established but is limited to a low-res video teleconference 820. If no microphone is detected on either the Help and Care Agent multimedia computing system 804 or the customer multimedia computing system 806, then the multimedia teleconference 820 is not allowed until a microphone is detected on the Help and Care Agent multimedia computing system 804 and the customer multimedia computing system 806. When the multimedia teleconference 820 can be established, the communication between the Help and Care Agent multimedia computing system 804 and the customer multimedia computing system 806 is highly interactive and information is exchanged in real-time between the Help and Care Agent multimedia computing system 804 and the customer multimedia computing system 806, in comparison to slower email-based systems of communication between the Help and Care Agent multimedia computing system 804 and the customer multimedia computing system 806.

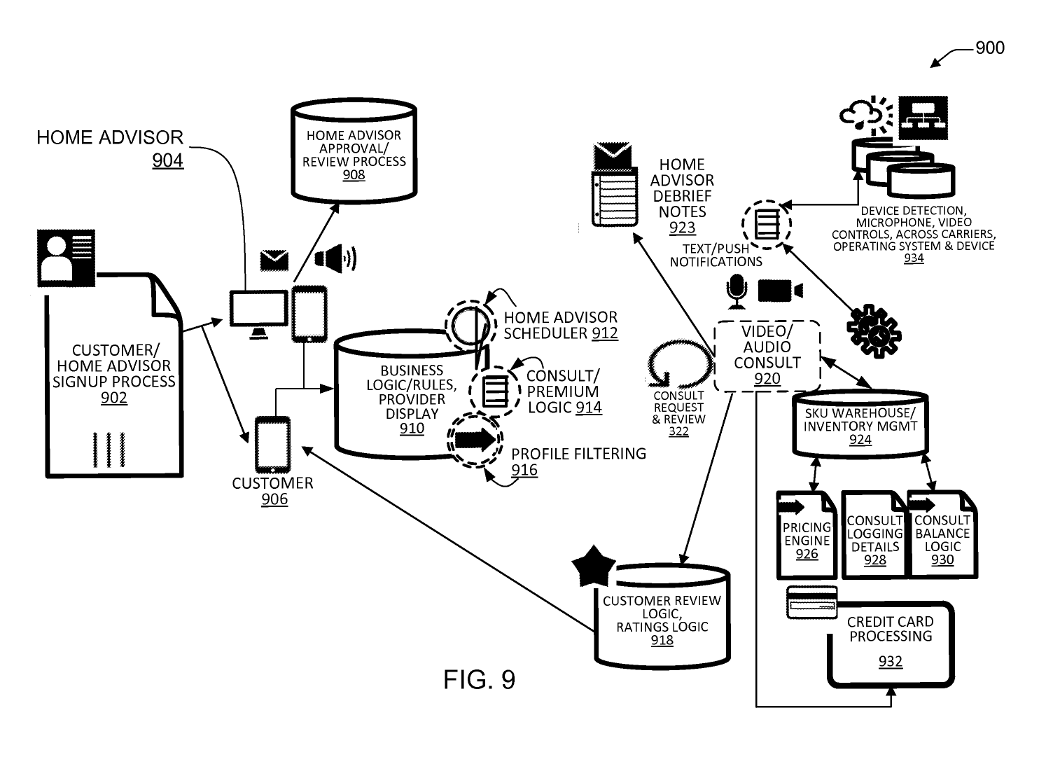

FIG. 9 is a block diagram of an overview of apparatus 900 of multimedia streaming between heterogeneous computer systems, according to a home advisor/customer implementation.

The apparatus 900 of multimedia streaming between heterogeneous computer systems includes a subscription process 902 (also known as a sign-up process) for a Home Advisor that is associated with a Home Advisor multimedia computing system 904 and a customer that is associated with a customer multimedia computing system 906. Quite commonly, the Home Advisor multimedia computing system 904 and the customer multimedia computing system 906 are heterogeneous computing systems with significant differences in all capabilities, including differences in operating systems and performance of the hardware that can have significant effects on the multimedia interaction with other computing systems.

The Home Advisor that is associated with the Home Advisor multimedia computing system 904 is subject to a Home Advisor approval/review process 908 that can include review of any applicable licensing of the Home Advisor. For example, the Home Advisor approval/review process 908 can include rejecting a Home Advisor as a subscriber to the apparatus 900 of multimedia streaming between heterogeneous computer systems because the Home Advisor does not hold a license that is deemed in the Home Advisor approval/review process 908 as required to establish sufficient competence to participate as a subscriber to the apparatus 900. The approval/review process 808 also includes status of rejected and suspended status of each approved Home Advisor.

The apparatus 900 of multimedia streaming between heterogeneous computer systems also includes a controller 910 of business-logic-and-rules-and-Home-Advisor-display. The controller 910 of business-logic-and-rules-and-Home-Advisor-display is intermittently coupled to the Home Advisor multimedia computing system 904 and the controller 910 of business-logic-and-rules-and-Home-Advisor-display is intermittently coupled to the customer multimedia computing system 906. The controller 910 of business-logic-and-rules-and-Home-Advisor-display includes a scheduler of Home Advisors 912 that is populated with data from the Home Advisor multimedia computing system 904 and that is accessed by the customer multimedia computing system 906. The controller 910 of business-logic-and-rules-and-Home-Advisor-display includes a controller of consultation and premium logic 914 and a profile filter 916. The Home-Advisor multimedia computing system 904 can access the Home-Advisor-display (also known as the ‘Home-Advisor dashboard’) of the controller 910 of business-logic-and-rules-and-Home-Advisor-display through a web browser via HTTP in order to update the profile of the Home-Advisor, [except the professional license number(s)] and to add funds to the Home-Advisor account.

The apparatus 900 of multimedia streaming between heterogeneous computer systems also includes a controller of customer-review-logic-and-ratings-logic 918 that is operably coupled to the customer multimedia computing system 906. The controller of customer-review-logic-and-ratings-logic 918 instantiates a multimedia (audio and/or video) teleconference 920 between the Home Advisor multimedia computing system and the customer multimedia computing system 906 upon receipt of a teleconference consultation request 922. At the termination of the multimedia teleconference 920, the controllers of customer-review-logic-and-ratings-logic 918 controls the review logic and ratings logic and debrief notes 923 are transmitted to the Home Advisor multimedia computing system 904. The multimedia teleconference 920 is performed in reference to data provided by a SKU warehouse and inventory management controller 924. The SKU warehouse and inventory management controller 924 operates in reference to a pricing engine 926, a teleconference log 928 and multimedia teleconference balance logic 930. A credit card processing module 932 provides data to the teleconference log 928 and multimedia teleconference balance logic 930.

In regards to the significant differences in operating systems and performance of the hardware in the heterogeneous computing systems of the Home Advisor multimedia computing system 904 and the customer multimedia computing system 906, capabilities detection 934 of the Home Advisor multimedia computing system 904 and the customer multimedia computing system 906 is performed, such as detection of the model, microphone, video controls, camera, processor speed, bus speed, amount of cache memory, amount of non-cache memory, telecom carrier and operating system are performed. The possible parameters of the multimedia teleconference 920 are determined based in the detected capabilities. For example, if no camera is detected at least one of the Home Advisor multimedia computing system 904 and the customer multimedia computing system 906, then the multimedia teleconference 920 can be established but is limited to an audio teleconference 920. If a camera is detected, but the image resolution that is detected on one of the Home Advisor multimedia computing system 904 and the customer multimedia computing system 906 is low resolution, then the multimedia teleconference 920 can be established but is limited to a low-res video teleconference 920. If no microphone is detected on either the Home Advisor multimedia computing system 904 or the customer multimedia computing system 906, then the multimedia teleconference 920 is not allowed until a microphone is detected on the Home Advisor multimedia computing system 904 and the customer multimedia computing system 906. When the multimedia teleconference 920 can be established, the communication between the Home Advisor multimedia computing system 904 and the customer multimedia computing system 906 is highly interactive and information is exchanged in real-time between the Home Advisor multimedia computing system 904 and the customer multimedia computing system 906, in comparison to slower email-based systems of communication between the Home Advisor multimedia computing system 904 and the customer multimedia computing system 906.

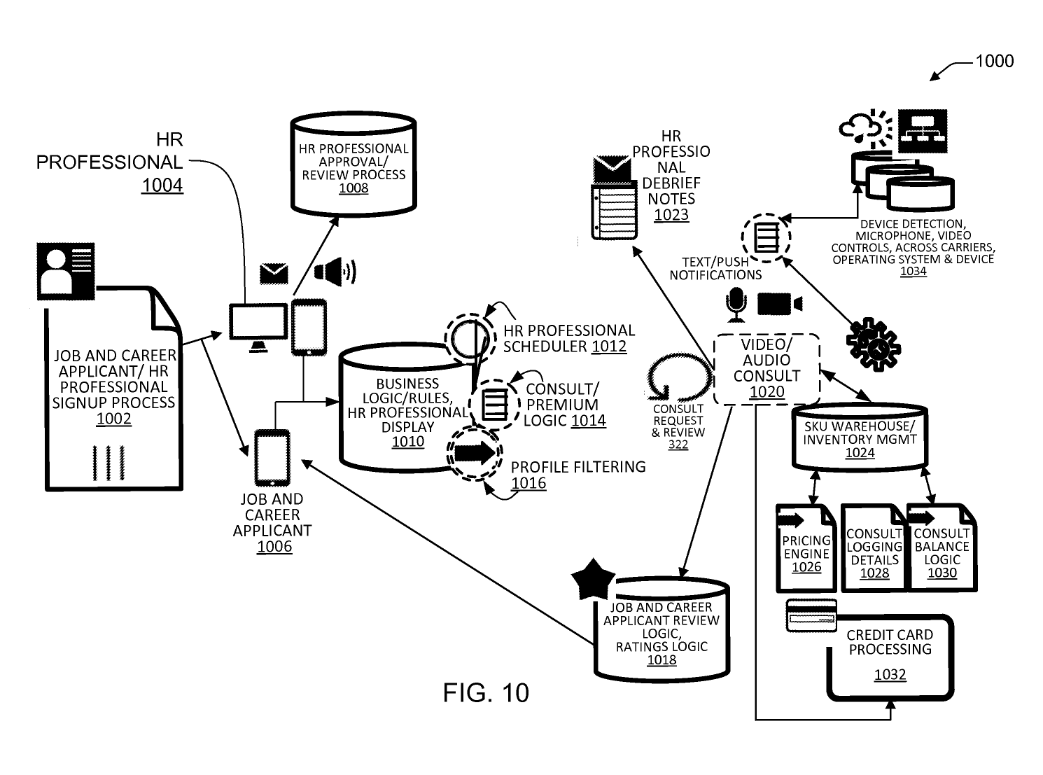

FIG. 10 is a block diagram of an overview of apparatus 1000 of multimedia streaming between heterogeneous computer systems, according to a HR Professional/Job and Career Applicant implementation.

The apparatus 1000 of multimedia streaming between heterogeneous computer systems includes a subscription process 1002 (also known as a sign-up process) for a HR Professional that is associated with a HR Professional multimedia computing system 1004 and a customer that is associated with a Job and Career Applicant multimedia computing system 1006. Quite commonly, the HR Professional multimedia computing system 1004 and the Job and Career Applicant multimedia computing system 1006 are heterogeneous computing systems with significant differences in all capabilities, including differences in operating systems and performance of the hardware that can have significant effects on the multimedia interaction with other computing systems.

The HR Professional that is associated with the HR Professional multimedia computing system 1004 is subject to a HR Professional approval/review process 1008 that can include review of any applicable licensing of the HR Professional. For example, the HR Professional approval/review process 1008 can include rejecting a HR Professional as a subscriber to the apparatus 1000 of multimedia streaming between heterogeneous computer systems because the HR Professional does not hold a license that is deemed in the HR Professional approval/review process 1008 as required to establish sufficient competence to participate as a subscriber to the apparatus 1000. The approval/review process 1008 also includes status of rejected and suspended status of each approved HR Professional.

The apparatus 1000 of multimedia streaming between heterogeneous computer systems also includes a controller 1010 of business-logic-and-rules-and-HR-Professional-display. The controller 1010 of business-logic-and-rules-and-HR-Professional-display is intermittently coupled to the HR Professional multimedia computing system 1004 and the controller 1010 of business-logic-and-rules-and-HR-Professional-display is intermittently coupled to the Job and Career Applicant multimedia computing system 1006. The controller 1010 of business-logic-and-rules-and-HR-Professional-display includes a scheduler of Job and HR Professionals 1012 that is populated with data from the HR Professional multimedia computing system 1004 and that is accessed by the Job and Career Applicant multimedia computing system 1006. The controller 1010 of business-logic-and-rules-and-HR-Professional-display includes a controller of consultation and premium logic 1014 and a profile filter 1016. The HR Professional multimedia computing system 1004 can access the HR-Profession-display (also known as the ‘HR Professional dashboard’) of the controller 1010 of business-logic-and-rules-and-HR-professional-display through a web browser via HTTP in order to update the profile of the HR Professional, [except the professional license number(s)] and to add funds to the HR Professional account.

The apparatus 1000 of multimedia streaming between heterogeneous computer systems also includes a controller of customer-review-logic-and-ratings-logic 1018 that is operably coupled to the Job and Career Applicant multimedia computing system 1006. The controller of customer-review-logic-and-ratings-logic 1018 instantiates a multimedia (audio and/or video) teleconference 1020 between the HR Professional multimedia computing system and the Job and Career Applicant multimedia computing system 1006 upon receipt of a teleconference consultation request 1022. At the termination of the multimedia teleconference 1020, the controller of customer-review-logic-and-ratings-logic 1018 controls the review logic and ratings logic and debrief notes 1023 are transmitted to the HR Professional multimedia computing system 1004. The multimedia teleconference 1020 is performed in reference to data provided by a SKU warehouse and inventory management controller 1024. The SKU warehouse and inventory management controller 1024 operates in reference to a pricing engine 1026, a teleconference log 1028 and multimedia teleconference balance logic 1030. A credit card processing module 1032 provides data to the teleconference log 1028 and multimedia teleconference balance logic 1030.

In regards to the significant differences in operating systems and performance of the hardware in the heterogeneous computing systems of the HR Professional multimedia computing system 1004 and the Job and Career Applicant multimedia computing system 1006, capabilities detection 1034 of the HR Professional multimedia computing system 1004 and the Job and Career Applicant multimedia computing system 1006 is performed, such as detection of the model, microphone, video controls, camera, processor speed, bus speed, amount of cache memory, amount of non-cache memory, telecom carrier and operating system are performed. The possible parameters of the multimedia teleconference 1020 are determined based in the detected capabilities. For example, if no camera is detected at least one of the HR Professional multimedia computing system 1004 and the Job and Career Applicant multimedia computing system 1006, then the multimedia teleconference 1020 can be established but is limited to an audio teleconference 1020. If a camera is detected, but the image resolution that is detected on one of the HR Professional multimedia computing system 1004 and the Job and Career Applicant multimedia computing system 1006 is low resolution, then the multimedia teleconference 1020 can be established but is limited to a low-res video teleconference 1020. If no microphone is detected on either the HR Professional multimedia computing system 1004 or the Job and Career Applicant multimedia computing system 1006, then the multimedia teleconference 1020 is not allowed until a microphone is detected on the HR Professional multimedia computing system 1004 and the Job and Career Applicant multimedia computing system 1006. When the multimedia teleconference 1020 can be established, the communication between the HR Professional multimedia computing system 1004 and the Job and Career Applicant multimedia computing system 1006 is highly interactive and information is exchanged in real-time between the HR Professional multimedia computing system 1004 and the Job and Career Applicant multimedia computing system 1006, in comparison to slower email-based systems of communication between the HR Professional multimedia computing system 1004 and the Job and Career Applicant multimedia computing system 1006.

### 4. METHODS OF MULTIMEDIA STREAMING BETWEEN HETEROGENEOUS COMPUTER SYSTEMS

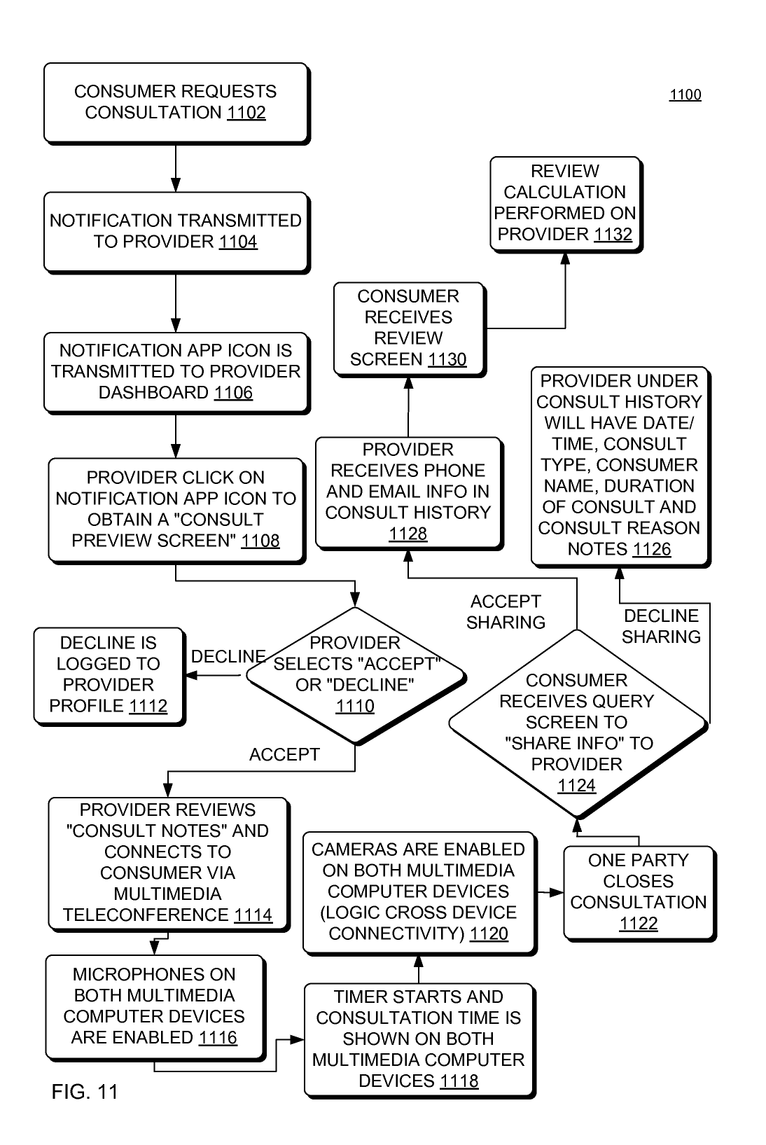

FIG. 11 is a flowchart of a method 1100 of multimedia streaming between heterogeneous computer systems, according to an implementation.

In method 1100, a consumer requests a consultation with a provider on the consumer multimedia computing system 206, at block 1102. Thereafter, at block 1104, a notification of the request for consultation is transmitted to the provider multimedia computing system 204. Thereafter, at block 1106, a notification app icon is transmitted to the dashboard of the provider multimedia computing system 204. At block 1108, the provider multimedia computing system 204 presents a selection to “accept” or “decline” the request for multimedia teleconference consultation(s) on a “consultation preview screen” and the Provider selects “accept” or “decline”.

If “decline” is selected at block 1110, the declination is logged to the profile of the Provider, at block 1112. If “accept” is selected, “consultation notes” are transmitted to the provider multimedia computing system 204 and a multimedia teleconference is initiated to the provider multimedia computing system 204 and to the consumer multimedia computing system 206, at block 1114, and microphones on both the provider multimedia computing system 204 and the consumer multimedia computing system 206 are enabled, at block 1116. At the beginning of the initiation of the multimedia teleconference, a timer is started and the lapsed consultation time is shown on both the provider multimedia computing system 204 and the consumer multimedia computing system 206, at block 1118. If minimum sufficiency to support a video teleconference is determined to exist on both the provider multimedia computing system 204 and the consumer multimedia computing system 206, then cameras are enabled on both the provider multimedia computing system 204 and the consumer multimedia computing system 206 to support a video teleconference, at block 1120. Thereafter, when an operator of either the provider multimedia computing system 204 or the consumer multimedia computing system 206 closes the multimedia teleconference, at block 1122, the provider the consumer multimedia computing system 206 receives and displays a query screen to “share info” to the Provider, at block 1124.

If the operator of the consumer multimedia computing system 206 does not select “share”, Provider under Consultation History will have date/time, multimedia teleconference consultation type, consumer name, duration of multimedia teleconference consultation and multimedia teleconference consultation reason notes, at block 1126. If the operator of the consumer multimedia computing system 206 selects “share”, the provider multimedia computing system 204 receives phone and email info in a “Consultation History” section of the Provider dashboard, at block 1128, the consumer multimedia computing system 206 receives a review screen, at block 1130, and at block 1132 a review calculation is performed on the Provider using the data received from the review screen.

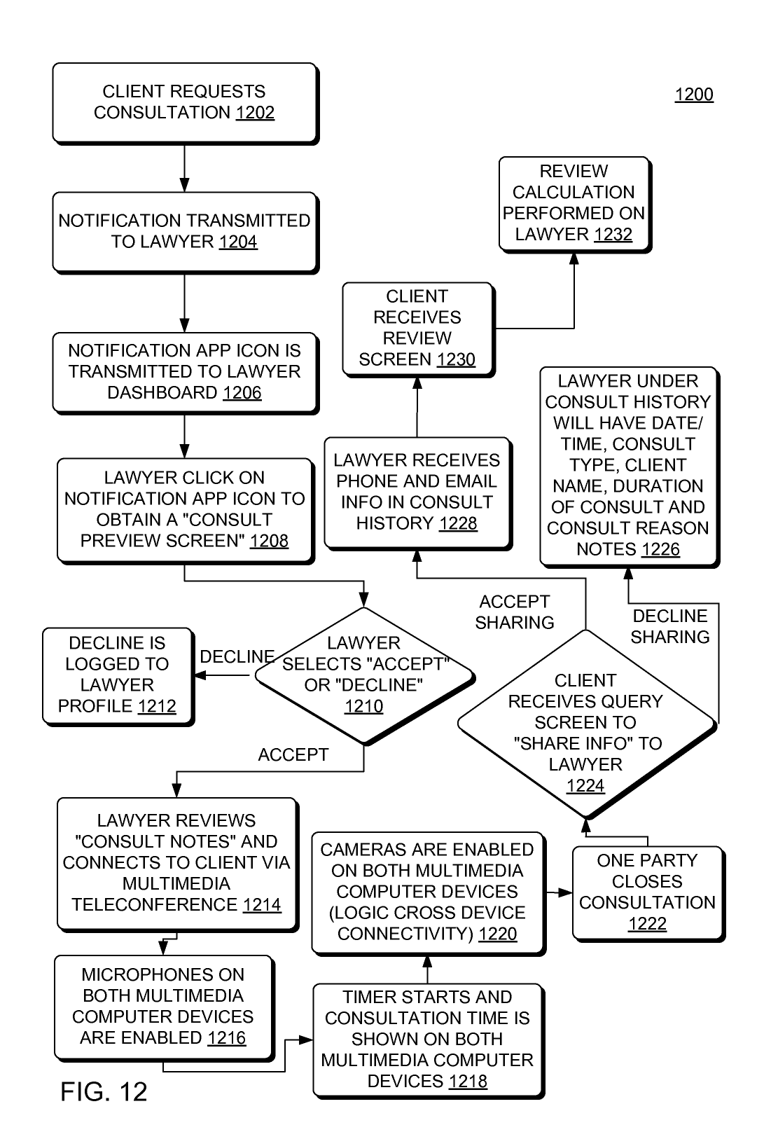

FIG. 12 is a flowchart of method 1200 of multimedia streaming between heterogeneous computer systems, according to an implementation.

In method 1200, a client requests a consultation with a lawyer on the client multimedia computing system 306, at block 1202. Thereafter, at block 1204, a notification of the request for consultation is transmitted to the lawyer multimedia computing system 304. Thereafter, at block 1206, a notification app icon is transmitted to the dashboard of the lawyer multimedia computing system 304. At block 1208, the lawyer multimedia computing system 304 presents a selection to “accept” or “decline” the request for multimedia teleconference consultation on a “consultation preview screen” and the Lawyer selects “accept” or “decline”.

If “decline” is selected at block 1210, the declination is logged to the profile of the Lawyer, at block 1212. If “accept” is selected, “consultation notes” are transmitted to the lawyer multimedia computing system 304 and a multimedia teleconference is initiated to the lawyer multimedia computing system 304 and to the client multimedia computing system 306, at block 1214, and microphones on both the lawyer multimedia computing system 304 and the client multimedia computing system 306 are enabled, at block 1216. At the beginning of the initiation of the multimedia teleconference, a timer is started and the lapsed consultation time is shown on both the lawyer multimedia computing system 304 and the client multimedia computing system 306, at block 1218. If minimum sufficiency to support a video teleconference is determined to exist on both the lawyer multimedia computing system 304 and the client multimedia computing system 306, then cameras are enabled on both the lawyer multimedia computing system 304 and the client multimedia computing system 306 to support a video teleconference, at block 1220. Thereafter, when an operator of either the lawyer multimedia computing system 304 or the client multimedia computing system 306 closes the multimedia teleconference, at block 1222, the lawyer the client multimedia computing system 306 receives and displays a query screen to “share info” to the Lawyer, at block 1224.

If the operator of the client multimedia computing system 306 does not select “share”, Lawyer under Consultation History will have date/time, multimedia teleconference consultation type, client name, duration of multimedia teleconference consultation and multimedia teleconference consultation reason notes, at block 1226. If the operator of the client multimedia computing system 306 selects “share”, the lawyer multimedia computing system 304 receives phone and email info in a “Consultation History” section of the Lawyer dashboard, at block 1228, the client multimedia computing system 306 receives a review screen, at block 1230, and at block 1232 a review calculation is performed on the Lawyer using the data received from the review screen.

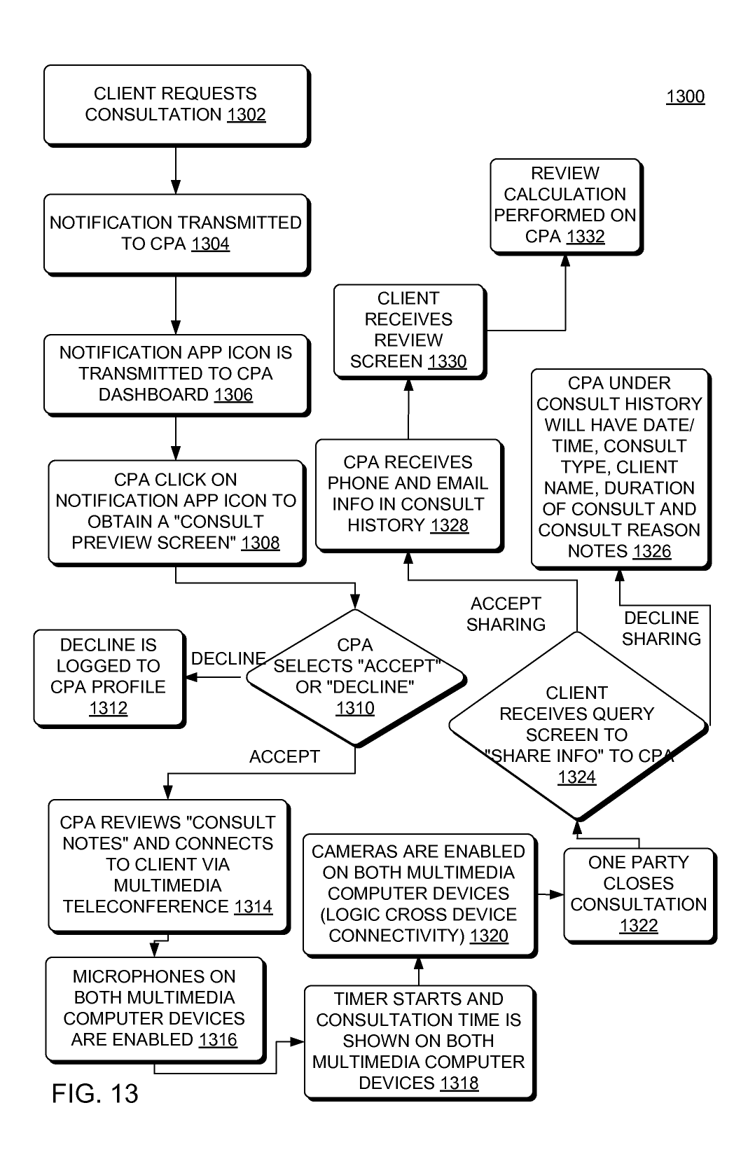

FIG. 13 is a flowchart of method 1300 of multimedia streaming between heterogeneous computer systems, according to an implementation.

In method 1300, a client requests a consultation with a CPA on the client multimedia computing system 406, at block 1302. Thereafter, at block 1304, a notification of the request for consultation is transmitted to the CPA multimedia computing system 404. Thereafter, at block 1306, a notification app icon is transmitted to the dashboard of the CPA multimedia computing system 404. At block 1308, the CPA multimedia computing system 404 presents a selection to “accept” or “decline” the request for consultation on a “consultation preview screen” and the CPA selects “accept” or “decline”.

If “decline” is selected at block 1310, the declination is logged to the profile of the CPA, at block 1312. If “accept” is selected, “consultation notes” are transmitted to the CPA multimedia computing system 404 and a multimedia teleconference is initiated to the CPA multimedia computing system 404 and to the client multimedia computing system 406, at block 1314, and microphones on both the CPA multimedia computing system 404 and the client multimedia computing system 406 are enabled, at block 1316. At the beginning of the initiation of the multimedia teleconference, a timer is started and the lapsed consultation time is shown on both the CPA multimedia computing system 404 and the client multimedia computing system 406, at block 1318. If minimum sufficiency to support a video teleconference is determined to exist on both the CPA multimedia computing system 404 and the client multimedia computing system 406, then cameras are enabled on both the CPA multimedia computing system 404 and the client multimedia computing system 406 to support a video teleconference, at block 1320. Thereafter, when an operator of either the CPA multimedia computing system 404 or the client multimedia computing system 406 closes the multimedia teleconference, at block 1322, the CPA the client multimedia computing system 406 receives and displays a query screen to “share info” to the CPA, at block 1324.

If the operator of the client multimedia computing system 406 does not select “share”, CPA under Consultation History will have date/time, multimedia teleconference consultation type, client name, duration of consultation and consultation reason notes, at block 1326. If the operator of the client multimedia computing system 406 selects “share”, the CPA multimedia computing system 404 receives phone and email info in a “Consultation History” section of the CPA dashboard, at block 1328, the client multimedia computing system 406 receives a review screen, at block 1330, and at block 1332 a review calculation is performed on the CPA using the data received from the review screen.

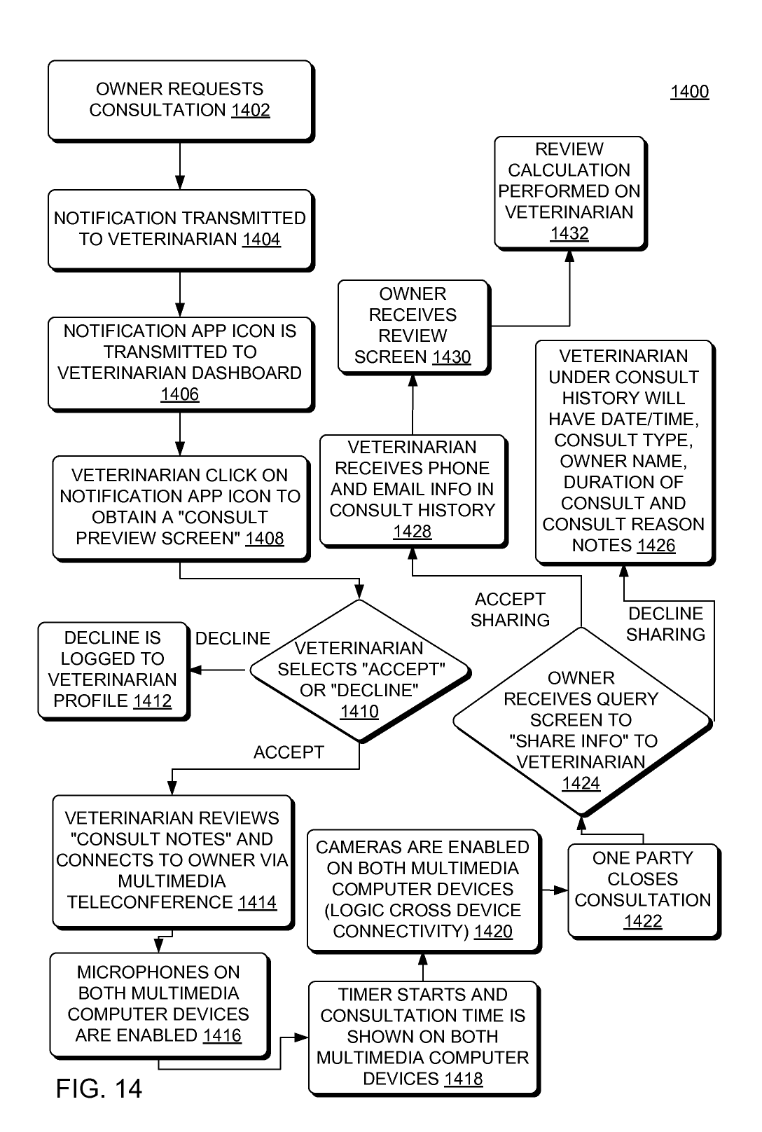

FIG. 14 is a flowchart of method 1400 of multimedia streaming between heterogeneous computer systems, according to an implementation.

In method 1400, an owner requests a consultation with a veterinarian on the owner multimedia computing system 506, at block 1402. Thereafter, at block 1404, a notification of the request for consultation is transmitted to the veterinarian multimedia computing system 504. Thereafter, at block 1406, a notification app icon is transmitted to the dashboard of the veterinarian multimedia computing system 504. At block 1408, the veterinarian multimedia computing system 504 presents a selection to “accept” or “decline” the request for consultation on a “consultation preview screen” and the veterinarian selects “accept” or “decline”.

If “decline” is selected at block 1410, the declination is logged to the profile of the veterinarian, at block 1412. If “accept” is selected, “consultation notes” are transmitted to the veterinarian multimedia computing system 504 and a multimedia teleconference is initiated to the veterinarian multimedia computing system 504 and to the owner multimedia computing system 506, at block 1414, and microphones on both the veterinarian multimedia computing system 504 and the owner multimedia computing system 506 are enabled, at block 1416. At the beginning of the initiation of the multimedia teleconference, a timer is started and the lapsed consultation time is shown on both the veterinarian multimedia computing system 504 and the owner multimedia computing system 506, at block 1418. If minimum sufficiency to support a video teleconference is determined to exist on both the veterinarian multimedia computing system 504 and the owner multimedia computing system 506, then cameras are enabled on both the veterinarian multimedia computing system 504 and the owner multimedia computing system 506 to support a video teleconference, at block 1420. Thereafter, when an operator of either the veterinarian multimedia computing system 504 or the owner multimedia computing system 506 closes the multimedia teleconference, at block 1422, the veterinarian the owner multimedia computing system 506 receives and displays a query screen to “share info” to the veterinarian, at block 1424.

If the operator of the owner multimedia computing system 506 does not select “share”, veterinarian under Consultation History will have date/time, multimedia teleconference consultation type, owner name, duration of consultation and consultation reason notes, at block 1426. If the operator of the owner multimedia computing system 506 selects “share”, the veterinarian multimedia computing system 504 receives phone and email info in a “Consultation History” section of the veterinarian dashboard, at block 1428, the owner multimedia computing system 506 receives a review screen, at block 1430, and at block 1432 a review calculation is performed on the veterinarian using the data received from the review screen.

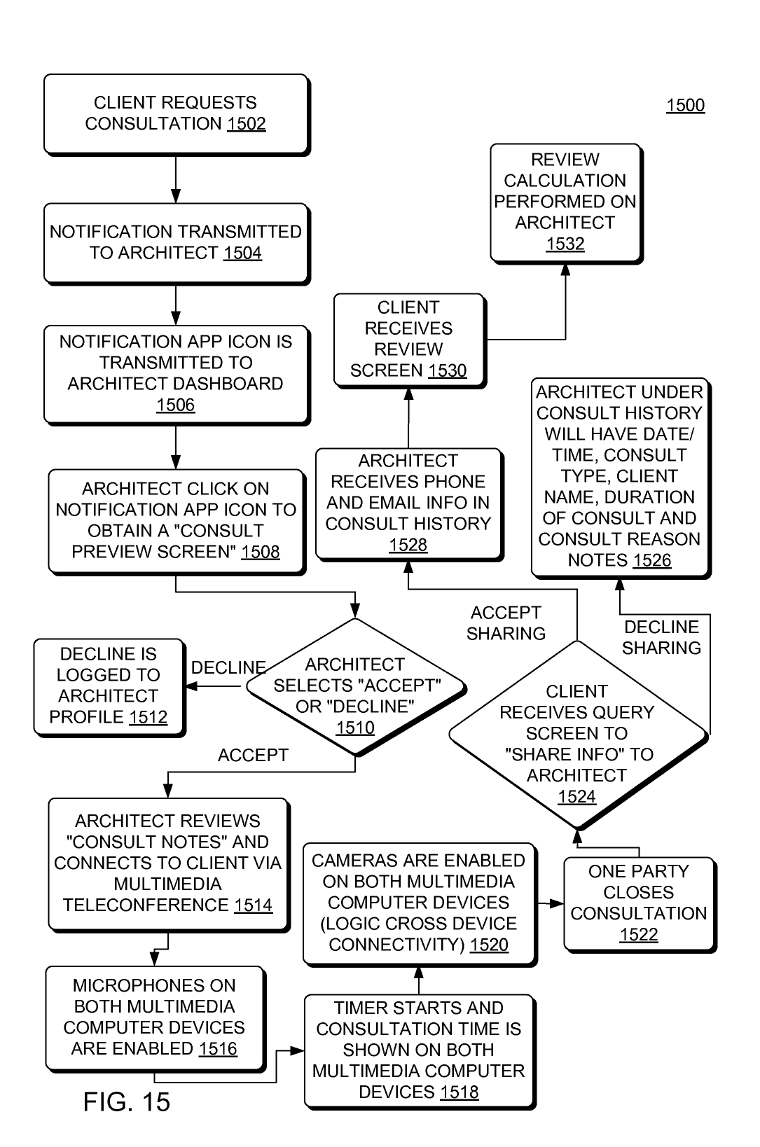

FIG. 15 is a flowchart of method 1500 of multimedia streaming between heterogeneous computer systems, according to an implementation.

In method 1500, a client requests a consultation with an architect on the client multimedia computing system 606, at block 1502. Thereafter, at block 1504, a notification of the request for consultation is transmitted to the architect multimedia computing system 604. Thereafter, at block 1506, a notification app icon is transmitted to the dashboard of the architect multimedia computing system 604. At block 1508, the architect multimedia computing system 604 presents a selection to “accept” or “decline” the request for consultation on a “consultation preview screen” and the architect selects “accept” or “decline”.

If “decline” is selected at block 1510, the declination is logged to the profile of the architect, at block 1512. If “accept” is selected, “consultation notes” are transmitted to the architect multimedia computing system 604 and a multimedia teleconference is initiated to the architect multimedia computing system 604 and to the client multimedia computing system 606, at block 1514, and microphones on both the architect multimedia computing system 604 and the client multimedia computing system 606 are enabled, at block 1516. At the beginning of the initiation of the multimedia teleconference, a timer is started and the lapsed consultation time is shown on both the architect multimedia computing system 604 and the client multimedia computing system 606, at block 1518. If minimum sufficiency to support a video teleconference is determined to exist on both the architect multimedia computing system 604 and the client multimedia computing system 606, then cameras are enabled on both the architect multimedia computing system 604 and the client multimedia computing system 606 to support a video teleconference, at block 1520. Thereafter, when an operator of either the architect multimedia computing system 604 or the client multimedia computing system 606 closes the multimedia teleconference, at block 1522, the architect the client multimedia computing system 606 receives and displays a query screen to “share info” to the architect, at block 1524.

If the operator of the client multimedia computing system 606 does not select “share”, architect under Consultation History will have date/time, multimedia teleconference consultation type, client name, duration of consultation and consultation reason notes, at block 1526. If the operator of the client multimedia computing system 606 selects “share”, the architect multimedia computing system 604 receives phone and email info in a “Consultation History” section of the architect dashboard, at block 1528, the client multimedia computing system 606 receives a review screen, at block 1530, and at block 1532 a review calculation is performed on the architect using the data received from the review screen.

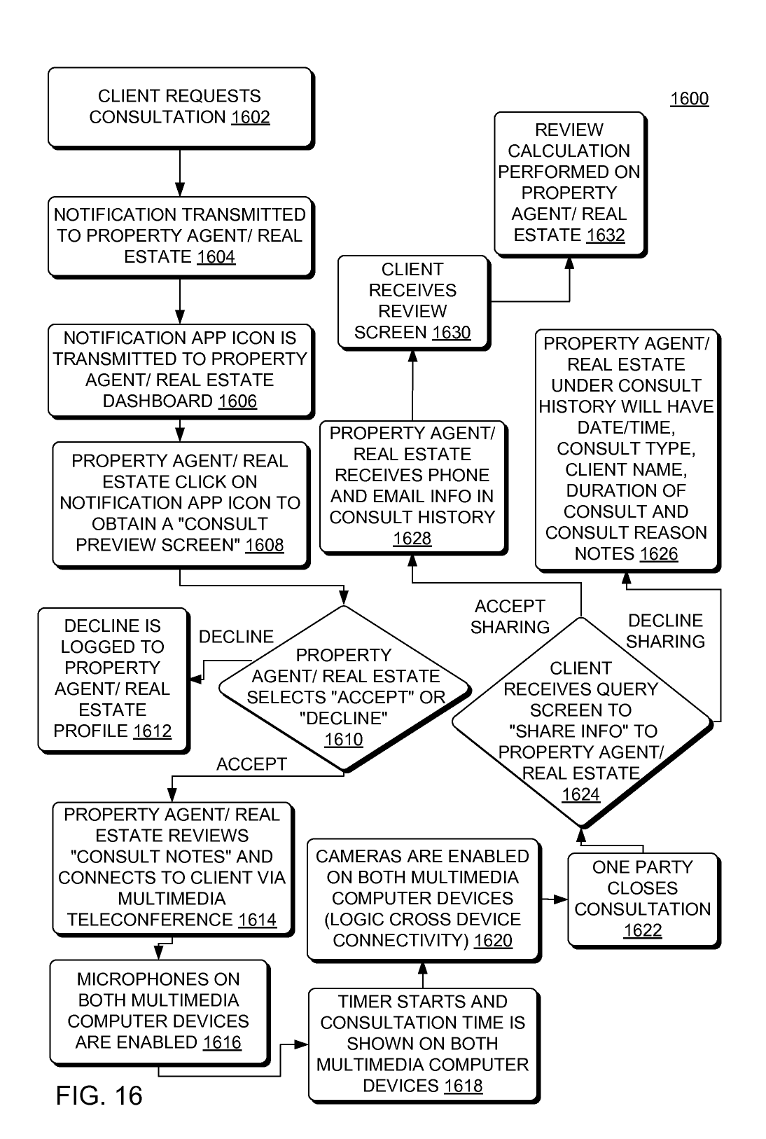

FIG. 16 is a flowchart of method 1600 of multimedia streaming between heterogeneous computer systems, according to an implementation.

In method 1600, a client requests a consultation with a property agent/real estate agent on the client multimedia computing system 706, at block 1602. Thereafter, at block 1604, a notification of the request for consultation is transmitted to the property agent/real estate agent multimedia computing system 704. Thereafter, at block 1606, a notification app icon is transmitted to the dashboard of the property agent/real estate agent multimedia computing system 704. At block 1608, the property agent/real estate agent multimedia computing system 704 presents a selection to “accept” or “decline” the request for consultation on a “consultation preview screen” and the property agent/real estate agent selects “accept” or “decline”.

If “decline” is selected at block 1610, the declination is logged to the profile of the property agent/real estate agent, at block 1612. If “accept” is selected, “consultation notes” are transmitted to the property agent/real estate agent multimedia computing system 704 and a multimedia teleconference is initiated to the property agent/real estate agent multimedia computing system 704 and to the client multimedia computing system 706, at block 1614, and microphones on both the property agent/real estate agent multimedia computing system 704 and the client multimedia computing system 706 are enabled, at block 1616. At the beginning of the initiation of the multimedia teleconference, a timer is started and the lapsed consultation time is shown on both the property agent/real estate agent multimedia computing system 704 and the client multimedia computing system 706, at block 1618. If minimum sufficiency to support a video teleconference is determined to exist on both the property agent/real estate agent multimedia computing system 704 and the client multimedia computing system 706, then cameras are enabled on both the property agent/real estate agent multimedia computing system 704 and the client multimedia computing system 706 to support a video teleconference, at block 1620. Thereafter, when an operator of either the property agent/real estate agent multimedia computing system 704 or the client multimedia computing system 706 closes the multimedia teleconference, at block 1622, the property agent/real estate agent the client multimedia computing system 706 receives and displays a query screen to “share info” to the property agent/real estate agent, at block 1624.

If the operator of the client multimedia computing system 706 does not select “share”, property agent/real estate agent under Consultation History will have date/time, multimedia teleconference consultation type, client name, duration of multimedia teleconference consultation and multimedia teleconference consultation reason notes, at block 1626. If the operator of the client multimedia computing system 706 selects “share”, the property agent/real estate agent multimedia computing system 704 receives phone and email info in a “Consultation History” section of the property agent/real estate agent dashboard, at block 1628, the client multimedia computing system 706 receives a review screen, at block 1630, and at block 1632 a review calculation is performed on the property agent/real estate agent using the data received from the review screen.

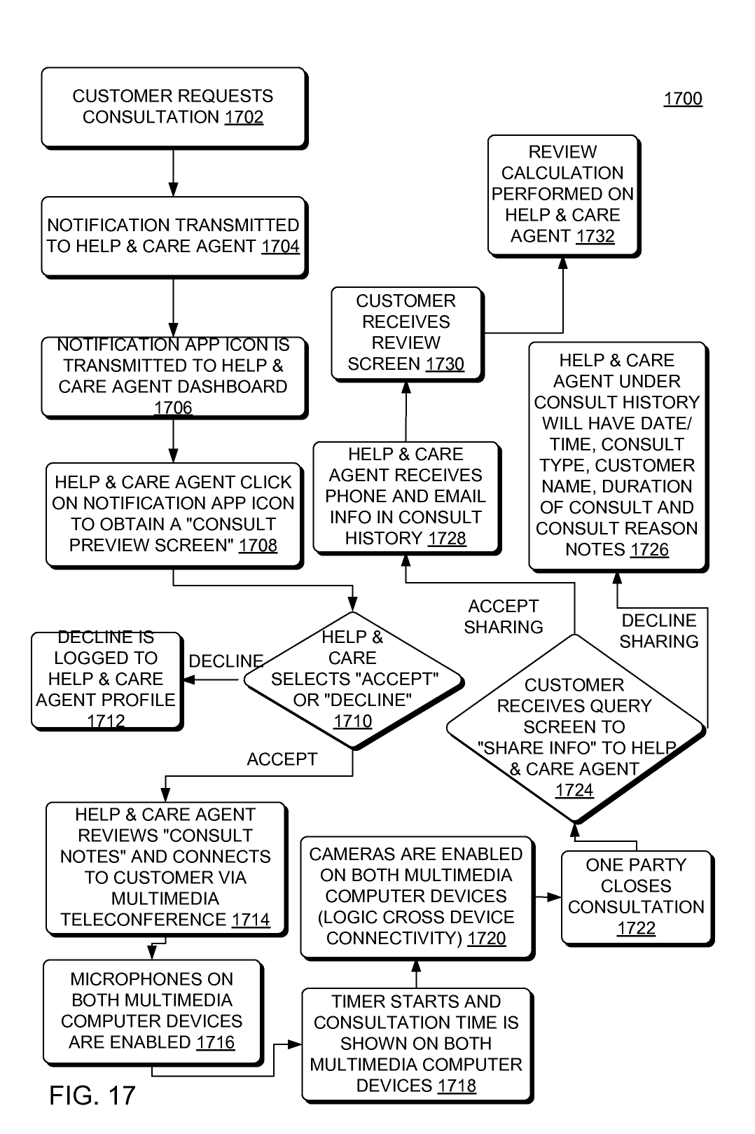

FIG. 17 is a flowchart of method 1700 of multimedia streaming between heterogeneous computer systems, according to an implementation.

In method 1700, a customer requests a consultation with a Help and Care Agent on the customer multimedia computing system 806, at block 1702. Thereafter, at block 1704, a notification of the request for consultation is transmitted to the Help and Care multimedia computing system 804. Thereafter, at block 1706, a notification app icon is transmitted to the dashboard of the Help and Care multimedia computing system 804. At block 1708, the Help and Care multimedia computing system 804 presents a selection to “accept” or “decline” the request for consultation on a “consultation preview screen” and the Help and Care Agent selects “accept” or “decline”.

If “decline” is selected at block 1710, the declination is logged to the profile of the Help and Care, at block 1712. If “accept” is selected, “consultation notes” are transmitted to the Help and Care multimedia computing system 804 and a multimedia teleconference is initiated to the Help and Care multimedia computing system 804 and to the customer multimedia computing system 806, at block 1714, and microphones on both the Help and Care multimedia computing system 804 and the customer multimedia computing system 806 are enabled, at block 1716. At the beginning of the initiation of the multimedia teleconference, a timer is started and the lapsed consultation time is shown on both the Help and Care multimedia computing system 804 and the customer multimedia computing system 806, at block 1718. If minimum sufficiency to support a video teleconference is determined to exist on both the Help and Care multimedia computing system 804 and the customer multimedia computing system 806, then cameras are enabled on both the Help and Care multimedia computing system 804 and the customer multimedia computing system 806 to support a video teleconference, at block 1720. Thereafter, when an operator of either the Help and Care multimedia computing system 804 or the customer multimedia computing system 806 closes the multimedia teleconference, at block 1722, the Help and Care multimedia computing system 806 receives and displays a query screen to “share info” to the Help and Care Agent, at block 1724.

If the operator of the customer multimedia computing system 806 does not select “share”, Help and Care under Consultation History will have date/time, multimedia teleconference consultation type, customer name, duration of multimedia teleconference consultation and multimedia teleconference consultation reason notes, at block 1726. If the operator of the customer multimedia computing system 806 selects “share”, the Help and Care multimedia computing system 804 receives phone and email info in a “Consultation History” section of the Help and Care dashboard, at block 1728, the customer multimedia computing system 806 receives a review screen, at block 1730, and at block 1732 a review calculation is performed on the Help and Care Agent using the data received from the review screen.

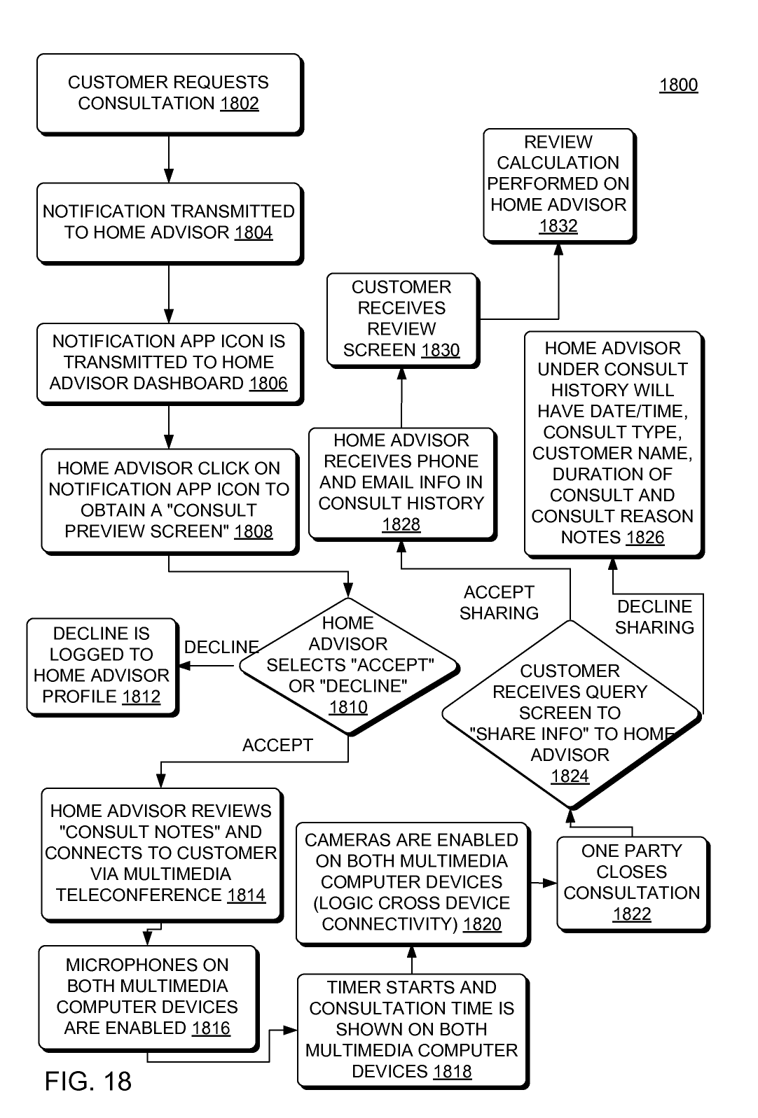

FIG. 18 is a flowchart of method 1800 of multimedia streaming between heterogeneous computer systems, according to an implementation.

In method 1800, a customer requests a consultation with a home advisor on the customer multimedia computing system 906, at block 1802. Thereafter, at block 1804, a notification of the request for consultation is transmitted to the home advisor multimedia computing system 904. Thereafter, at block 1806, a notification app icon is transmitted to the dashboard of the home advisor multimedia computing system 904. At block 1808, the home advisor multimedia computing system 904 presents a selection to “accept” or “decline” the request for consultation on a “consultation preview screen” and the home advisor selects “accept” or “decline”.

If “decline” is selected at block 1810, the declination is logged to the profile of the home advisor, at block 1812. If “accept” is selected, “consultation notes” are transmitted to the home advisor multimedia computing system 904 and a multimedia teleconference is initiated to the home advisor multimedia computing system 904 and to the customer multimedia computing system 906, at block 1814, and microphones on both the home advisor multimedia computing system 904 and the customer multimedia computing system 906 are enabled, at block 1816. At the beginning of the initiation of the multimedia teleconference, a timer is started and the lapsed consultation time is shown on both the home advisor multimedia computing system 904 and the customer multimedia computing system 906, at block 1818. If minimum sufficiency to support a video teleconference is determined to exist on both the home advisor multimedia computing system 904 and the customer multimedia computing system 906, then cameras are enabled on both the home advisor multimedia computing system 904 and the customer multimedia computing system 906 to support a video teleconference, at block 1820. Thereafter, when an operator of either the home advisor multimedia computing system 904 or the customer multimedia computing system 906 closes the multimedia teleconference, at block 1822, the home advisor the customer multimedia computing system 906 receives and displays a query screen to “share info” to the home advisor, at block 1824.

If the operator of the customer multimedia computing system 906 does not select “share”, home advisor under Consultation History will have date/time, multimedia teleconference consultation type, customer name, duration of multimedia teleconference consultation and multimedia teleconference consultation reason notes, at block 1826. If the operator of the customer multimedia computing system 906 selects “share”, the home advisor multimedia computing system 904 receives phone and email info in a “Consultation History” section of the home advisor dashboard, at block 1828, the customer multimedia computing system 906 receives a review screen, at block 1830, and at block 1832 a review calculation is performed on the home advisor using the data received from the review screen.

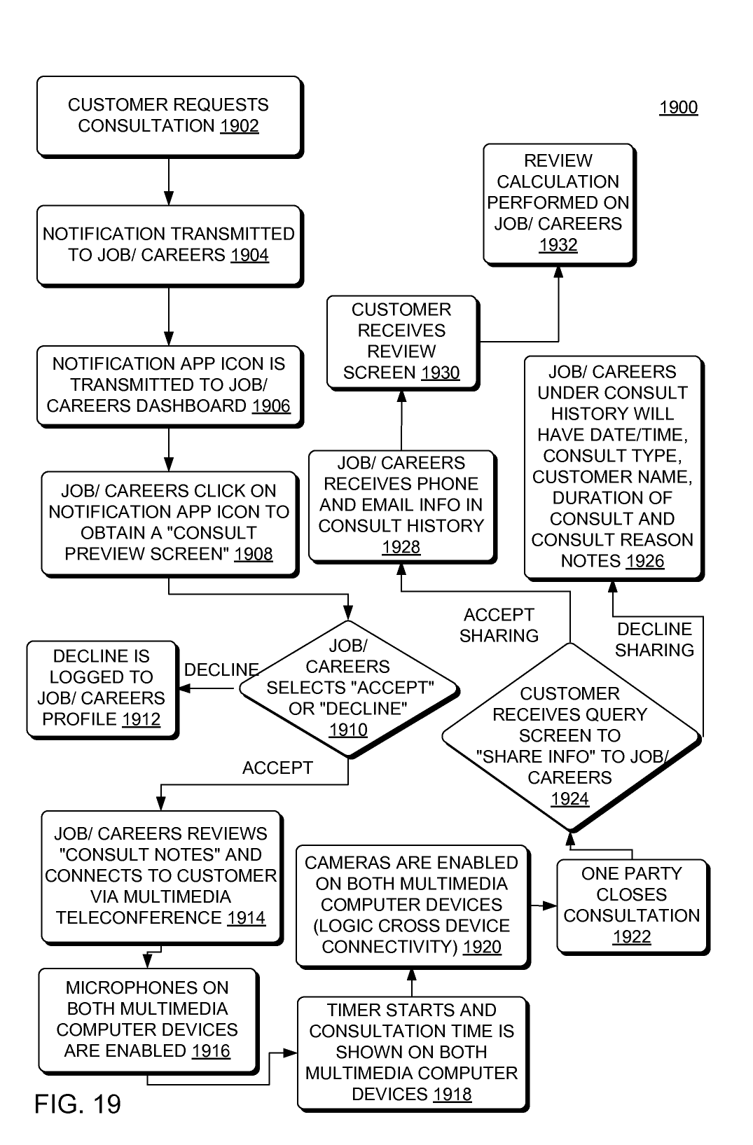

FIG. 19 is a flowchart of method 1900 of multimedia streaming between heterogeneous computer systems, according to an implementation.

In method 1900, a customer requests a consultation with a HR professional on the Job and Career Applicant multimedia computing system 1006, at block 1902. Thereafter, at block 1904, a notification of the request for consultation is transmitted to the HR professional multimedia computing system 1004. Thereafter, at block 1906, a notification app icon is transmitted to the dashboard of the HR professional multimedia computing system 1004. At block 1908, the HR professional multimedia computing system 1004 presents a selection to “accept” or “decline” the request for consultation on a “consultation preview screen” and the HR professional selects “accept” or “decline”.

If “decline” is selected at block 1910, the declination is logged to the profile of the HR professional, at block 1912. If “accept” is selected, “consultation notes” are transmitted to the HR professional multimedia computing system 1004 and a multimedia teleconference is initiated to the HR professional multimedia computing system 1004 and to the Job and Career Applicant multimedia computing system 1006, at block 1914, and microphones on both the HR professional multimedia computing system 1004 and the Job and Career Applicant multimedia computing system 1006 are enabled, at block 1916. At the beginning of the initiation of the multimedia teleconference, a timer is started and the lapsed consultation time is shown on both the HR professional multimedia computing system 1004 and the Job and Career Applicant multimedia computing system 1006, at block 1918. If minimum sufficiency to support a video teleconference is determined to exist on both the HR professional multimedia computing system 1004 and the Job and Career Applicant multimedia computing system 1006, then cameras are enabled on both the HR professional multimedia computing system 1004 and the Job and Career Applicant multimedia computing system 1006 to support a video teleconference, at block 1920. Thereafter, when an operator of either the HR professional multimedia computing system 1004 or the Job and Career Applicant multimedia computing system 1006 closes the multimedia teleconference, at block 1922, the Job and Career Applicant multimedia computing system 1006 receives and displays a query screen to “share info” to the HR professional, at block 1924.

If the operator of the Job and Career Applicant multimedia computing system 1006 does not select “share”, HR professional under Consultation History will have date/time, multimedia teleconference consultation type, customer name, duration of multimedia teleconference consultation and multimedia teleconference consultation reason notes, at block 1926. If the operator of the Job and Career Applicant multimedia computing system 1006 selects “share”, the HR professional multimedia computing system 1004 receives phone and email info in a “Consultation History” section of the HR professional dashboard, at block 1928, the Job and Career Applicant multimedia computing system 1006 receives a review screen, at block 1930, and at block 1932 a review calculation is performed on the HR professional using the data received from the review screen.

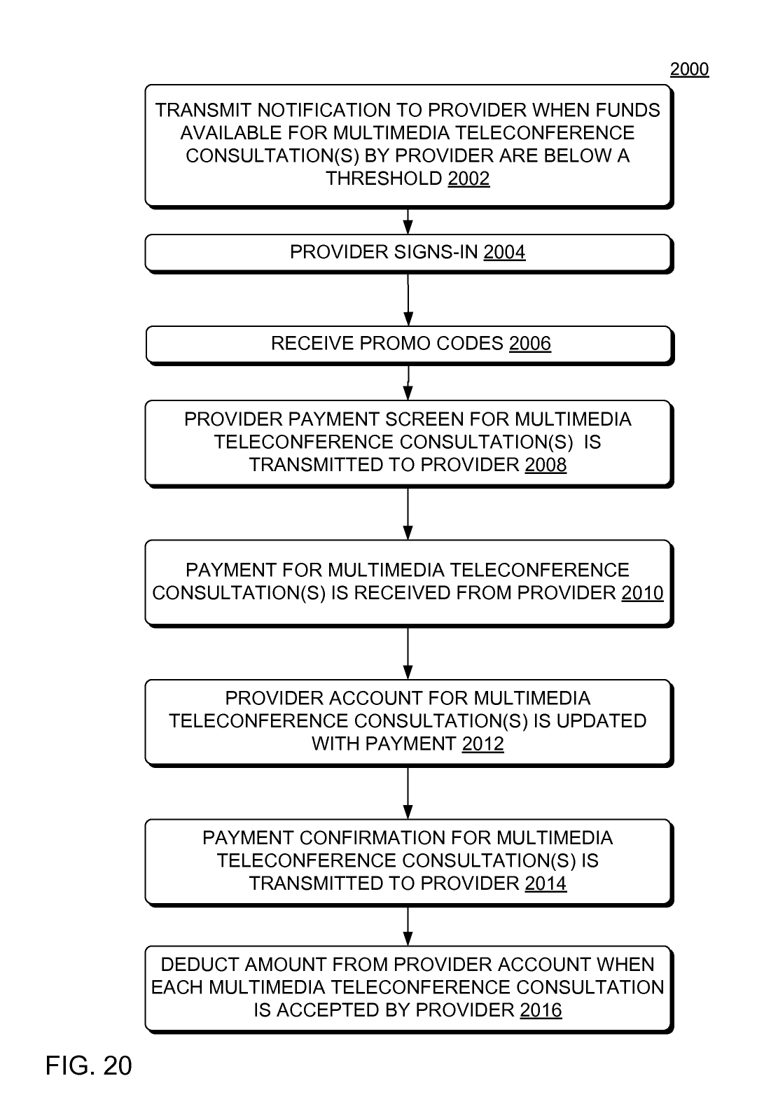

FIG. 20 is a flowchart of a method 2000 of performing SKU and inventory management of multimedia teleconference consultation(s) for a provider, according to an implementation. Method 2000 can be performed by SKU/inventory management 224 and the controller 210 of business-logic-and-rules-and-provider-display in FIG. 2.

Method 2000 includes transmitting a notification to a provider when funds available for multimedia teleconference consultation(s) by provider are below a threshold, at block 2002. The notification indicates that funds available for multimedia teleconference consultation(s) by the provider are low. The notification can be email, text message or other push notification.

Method 2000 also includes the provider accessing the controller 210 of business-logic-and-rules-and-provider-display by signing-in to the controller 210 of business-logic-and-rules-and-provider-display, at block 2004.

Because credit card processors do not allow for discount codes, at block 2006, the SKU/inventory management 224 can receive and include promotion codes in the payment screen in a variety of forms, such as an absolute amount of discount in the currency or in the form a % discount. The promotion code can be added to a checkout screen and the net amount charged to the credit card account of the provider through the credit card processor. The promotion code can be a one time user for each provider, or a coupon that only applies to product type (e.g. Lead or Premium or total cart), or limited to total uses.

Method 2000 also includes transmitting a provider payment screen for multimedia teleconference consultation(s) to the provider by the controller 210 of business-logic-and-rules-and-provider-display, at block 2008. The controller 210 of business-logic-and-rules-and-provider-display transmits the provider payment screen. The payment screen can provide options on the multimedia teleconference consultation(s) such as location (city, state) of the consumer, specialty area (sub categories), cost per multimedia teleconference consultation, quantity of multimedia teleconference consultation(s), ability to adjust multimedia teleconference consultation(s) based on demand/need. The price can be listed by location/category and quantity. The payment screen can include the current amount of multimedia teleconference consultation(s) in the account of the provider.

Method 2000 also includes receiving payment for multimedia teleconference consultation(s) from the provider at the controller 210 of business-logic-and-rules-and-provider-display, at block 2010.

Method 2000 also includes updating the provider account for multimedia teleconference consultation(s) with the payment, at block 2012.

Method 2000 also includes transmitting a confirmation of the payment for the multimedia teleconference consultation(s) to the provider, at block 2014.

Method 2000 also includes deducting an amount for each multimedia teleconference consultation from the provider account when each multimedia teleconference consultation is accepted by the provider, at block 2016, such as in block 1110 in FIG. 11.

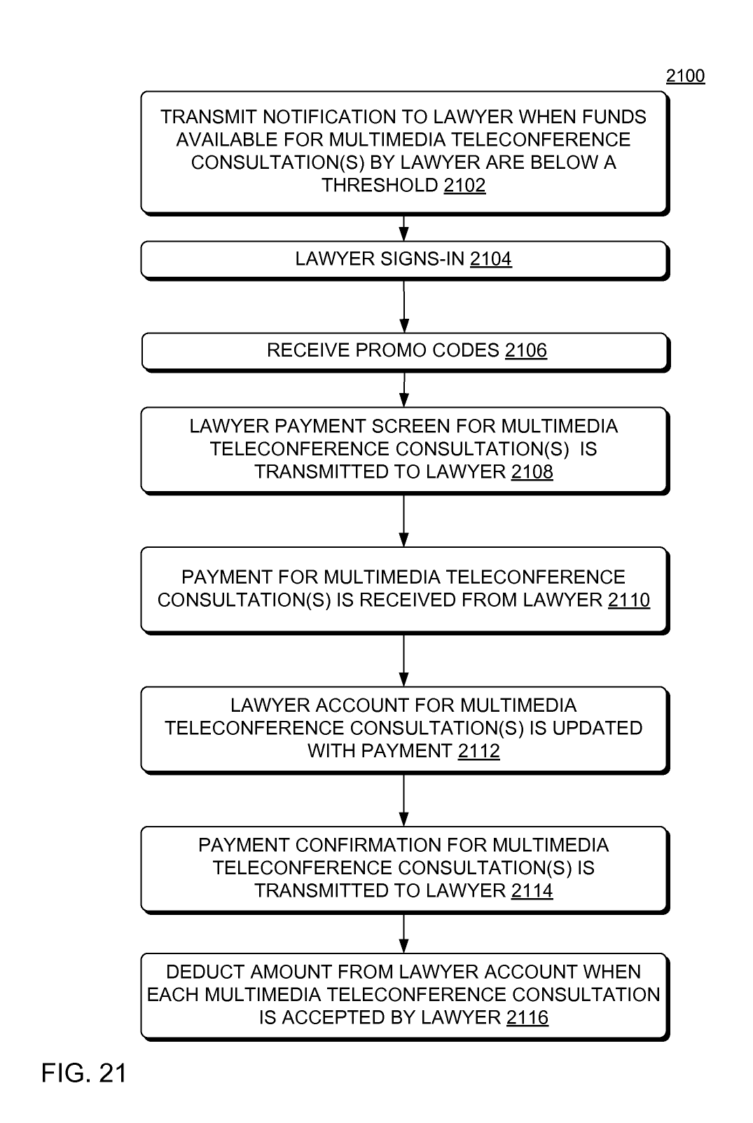

FIG. 21 is a flowchart of a method 2100 of performing SKU and inventory management of multimedia teleconference consultation(s) for a lawyer, according to an implementation. Method 2100 can be performed by SKU/inventory management 324 and the controller 310 of business-logic-and-rules-and-lawyer-display in FIG. 3.

Method 2100 includes transmitting a notification to a lawyer when funds available for multimedia teleconference consultation(s) by lawyer are below a threshold, at block 2102. The notification indicates that funds available for multimedia teleconference consultation(s) by the lawyer are low. The notification can be email, text message or other push notification.

Method 2100 also includes the lawyer accessing the controller 310 of business-logic-and-rules-and-lawyer-display by signing-in to the controller 310 of business-logic-and-rules-and-lawyer-display, at block 2104.

Because credit card processors do not allow for discount codes, at block 2106, the SKU/inventory management 324 can receive and include promotion codes in the payment screen, as described in greater detail in conjunction with block 2006 in FIG. 20.

Method 2100 also includes transmitting a lawyer payment screen for multimedia teleconference consultation(s) to the lawyer by the controller 310 of business-logic-and-rules-and-lawyer-display, at block 2108. The controller 310 of business-logic-and-rules-and-lawyer-display transmits the lawyer payment screen. The payment screen can provide options on the multimedia teleconference consultation(s) such as location (city, state) of the client, specialty area (sub categories), cost per multimedia teleconference consultation, quantity of multimedia teleconference consultation(s), ability to adjust multimedia teleconference consultation(s) based on demand/need. The price can be listed by location/category and quantity. The payment screen can include the current amount of multimedia teleconference consultation(s) in the account of the lawyer.

Method 2100 also includes receiving payment for multimedia teleconference consultation(s) from the lawyer at the controller 310 of business-logic-and-rules-and-lawyer-display, at block 2110.

Method 2100 also includes updating the lawyer account for multimedia teleconference consultation(s) with the payment, at block 2112.

Method 2100 also includes transmitting a confirmation of the payment for the multimedia teleconference consultation(s) to the lawyer, at block 2114.

Method 2100 also includes deducting an amount for each multimedia teleconference consultation from the lawyer account when each multimedia teleconference consultation is accepted by the lawyer, at block 2116, such as in block 1210 in FIG. 12.

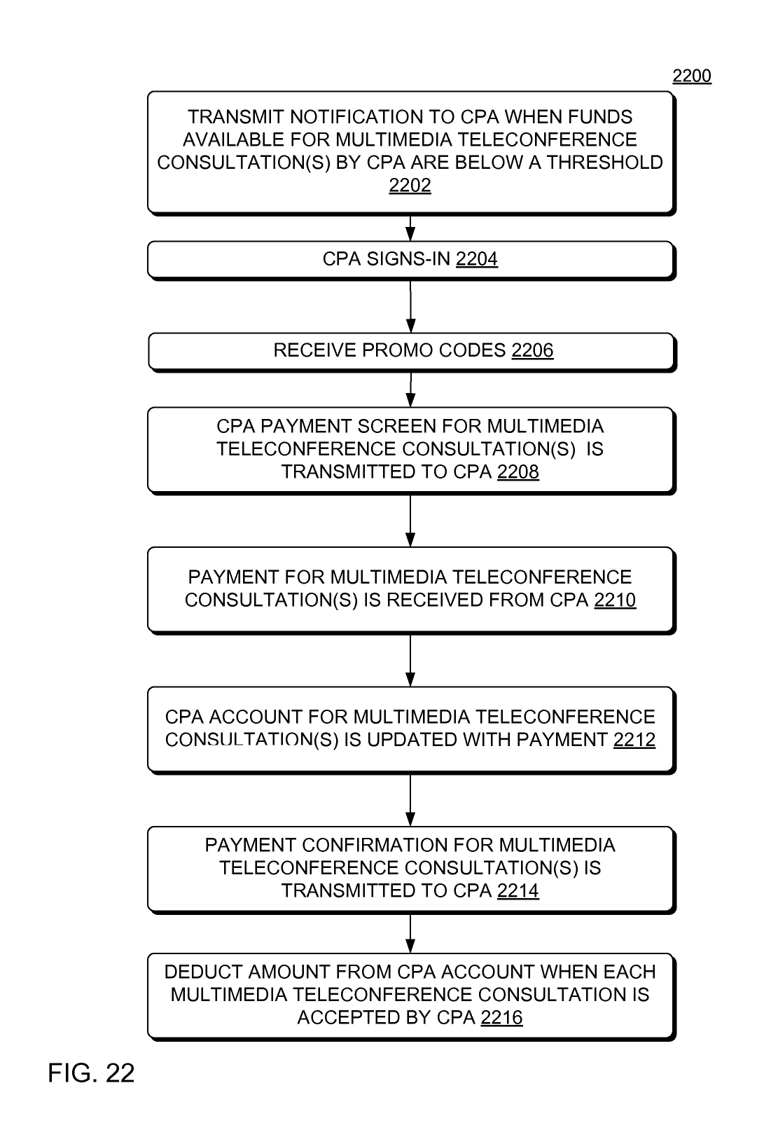

FIG. 22 is a flowchart of a method 2200 of performing SKU and inventory management of multimedia teleconference consultation(s) for a CPA, according to an implementation. Method 2200 can be performed by SKU/inventory management 424 and the controller 410 of business-logic-and-rules-and-CPA-display in FIG. 4.

Method 2200 includes transmitting a notification to a CPA when funds available for multimedia teleconference consultation(s) by CPA are below a threshold, at block 2202. The notification indicates that funds available for multimedia teleconference consultation(s) by the CPA are low. The notification can be email, text message or other push notification.

Method 2200 also includes the CPA accessing the controller 410 of business-logic-and-rules-and-CPA-display by signing-in to the controller 410 of business-logic-and-rules-and-CPA-display, at block 2204.

Because credit card processors do not allow for discount codes, at block 2206, the SKU/inventory management 224 can receive and include promotion codes in the payment screen, as described in greater detail in conjunction with block 2006 in FIG. 20.

Method 2200 also includes transmitting a CPA payment screen for multimedia teleconference consultation(s) to the CPA by the controller 410 of business-logic-and-rules-and-CPA-display, at block 2208. The controller 410 of business-logic-and-rules-and-CPA-display transmits the CPA payment screen. The payment screen can provide options on the multimedia teleconference consultation(s) such as location (city, state) of the client, specialty area (sub categories), cost per multimedia teleconference consultation, quantity of multimedia teleconference consultation(s), ability to adjust multimedia teleconference consultation(s) based on demand/need. The price can be listed by location/category and quantity. The payment screen can include the current amount of multimedia teleconference consultation(s) in the account of the CPA.

Method 2200 also includes receiving payment for multimedia teleconference consultation(s) from the CPA at the controller 410 of business-logic-and-rules-and-CPA-display, at block 2210.

Method 2200 also includes updating the CPA account for multimedia teleconference consultation(s) with the payment, at block 2212. Method 2200 also includes transmitting a confirmation of the payment for the multimedia teleconference consultation(s) to the CPA, at block 2214. Method 2200 also includes deducting an amount for each multimedia teleconference consultation from the CPA account when each multimedia teleconference consultation is accepted by the CPA, at block 2216, such as in block 1310 in FIG. 13.

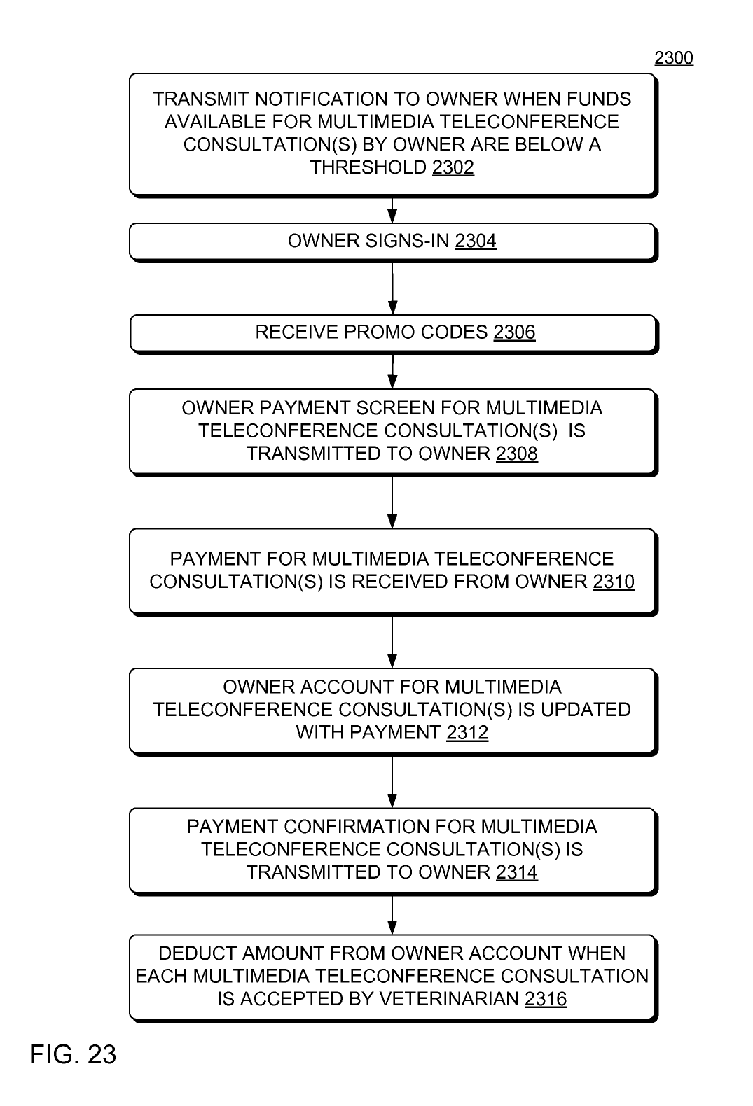

FIG. 23 is a flowchart of a method 2300 of performing SKU and inventory management of multimedia teleconference consultation(s) for an owner of an animal, according to an implementation. Method 2300 can be performed by SKU/inventory management 524 and the controller 510 of business-logic-and-rules-and-Owner-display in FIG. 5.

Method 2300 includes transmitting a notification to a Veterinarian when an owner has paid for a multimedia teleconference consultation(s) for an owner. The owner is charged up-front the multimedia teleconference consultation(s) by taking a service fee then providing the remaining funds to the Veterinarian for the multimedia teleconference consultation(s), which is a different process than the other methods 2000-2200 and 2400-2800. The notification can be email, text message or other push notification.

Method 2300 also includes the owner accessing the controller 510 of business-logic-and-rules-and-owner-display by signing-in to the controller 510 of business-logic-and-rules-and-owner-display, at block 2304.

Because credit card processors do not allow for discount codes, at block 2306, the SKU/inventory management 524 can receive and include promotion codes in the payment screen, as described in greater detail in conjunction with block 2006 in FIG. 20. Discount codes in the application of promotion codes is implemented by the owner by using a code.

Method 2300 also includes transmitting an owner payment screen for multimedia teleconference consultation(s) to the owner by the controller 510 of business-logic-and-rules-and-owner-display, at block 2308. The controller 510 of business-logic-and-rules-and-owner-display transmits the owner payment screen. The payment screen can provide options on the multimedia teleconference consultation(s) such as location (city, state) of the owner, specialty area (sub categories), cost per multimedia teleconference consultation, quantity of multimedia teleconference consultation(s), ability to adjust multimedia teleconference consultation(s) based on demand/need. The price can be listed by location/category and quantity. The payment screen can include the current amount of multimedia teleconference consultation(s) in the account of the owner.

Method 2300 also includes receiving payment for multimedia teleconference consultation(s) from the owner at the controller 510 of business-logic-and-rules-and-owner-display, at block 2310.

Method 2300 also includes updating the owner account for multimedia teleconference consultation(s) with the payment, at block 2312. Method 2300 also includes transmitting a confirmation of the payment for the multimedia teleconference consultation(s) to the owner, at block 2314.

Method 2300 also includes deducting an amount for each multimedia teleconference consultation from the owner account when each multimedia teleconference consultation is accepted by the Veterinarian, at block 2316, such as in block 1410 in FIG. 14, and also paying the Veterinarian the portion of the consultation fee minus the service fee.

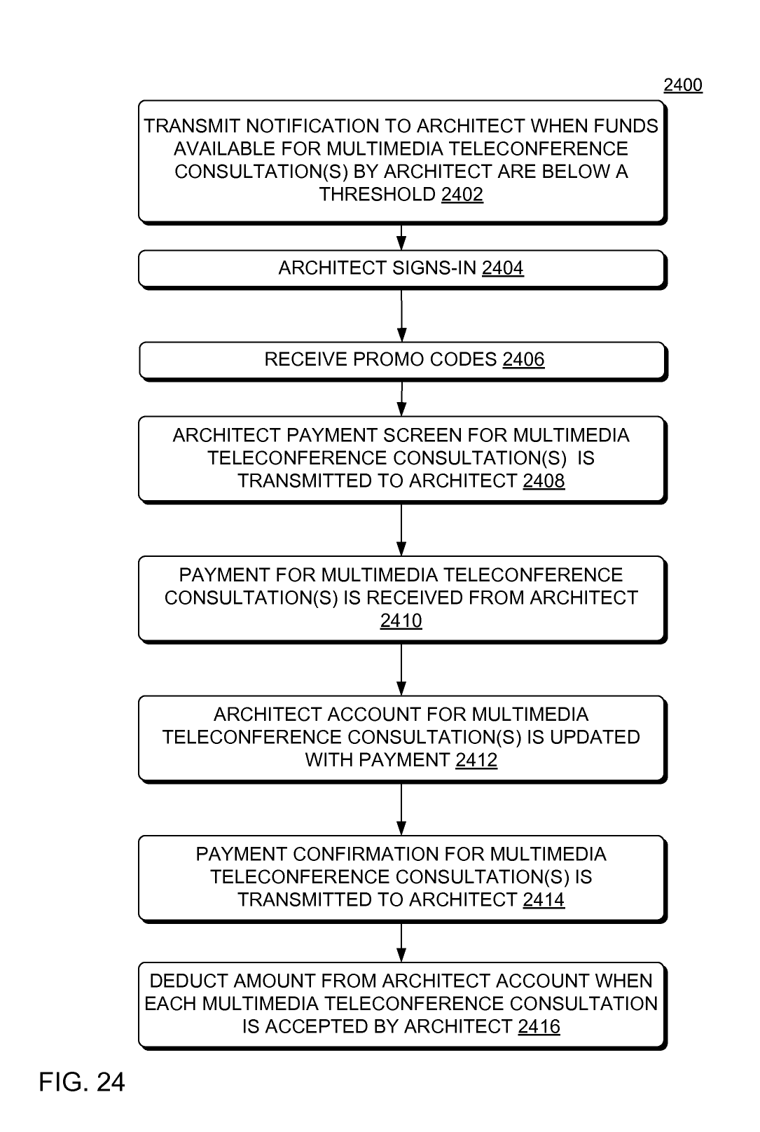

FIG. 24 is a flowchart of a method 2400 of performing SKU and inventory management of multimedia teleconference consultation(s) for an Architect, according to an implementation. Method 2400 can be performed by SKU/inventory management 624 and the controller 610 of business-logic-and-rules-and-Architect-display in FIG. 6.

Method 2400 includes transmitting a notification to a Architect when funds available for multimedia teleconference consultation(s) by Architect are below a threshold, at block 2402. The notification indicates that funds available for multimedia teleconference consultation(s) by the Architect are low. The notification can be email, text message or other push notification.

Method 2400 also includes the Architect accessing the controller 610 of business-logic-and-rules-and-Architect-display by signing-in to the controller 610 of business-logic-and-rules-and-Architect-display, at block 2404.

Because credit card processors do not allow for discount codes, at block 2406, the SKU/inventory management 624 can receive and include promotion codes in the payment screen, as described in greater detail in conjunction with block 2006 in FIG. 20.

Method 2400 also includes transmitting a Architect payment screen for multimedia teleconference consultation(s) to the Veterinarian by the controller 610 of business-logic-and-rules-and-Architect-display, at block 2408. The controller 610 of business-logic-and-rules-and-Architect-display transmits the Architect payment screen. The payment screen can provide options on the multimedia teleconference consultation(s) such as location (city, state) of the client, specialty area (sub categories), cost per multimedia teleconference consultation, quantity of multimedia teleconference consultation(s), ability to adjust multimedia teleconference consultation(s) based on demand/need. The price can be listed by location/category and quantity. The payment screen can include the current amount of multimedia teleconference consultation(s) in the account of the Architect.

Method 2400 also includes receiving payment for multimedia teleconference consultation(s) from the Architect at the controller 610 of business-logic-and-rules-and-Architect-display, at block 2410.

Method 2400 also includes updating the Architect account for multimedia teleconference consultation(s) with the payment, at block 2412. Method 2400 also includes transmitting a confirmation of the payment for the multimedia teleconference consultation(s) to the Architect, at block 2414. Method 2400 also includes ddeducting an amount for each multimedia teleconference consultation from the Architect account when each multimedia teleconference consultation is accepted by the Architect, at block 2416, such as in block 1510 in FIG. 15.

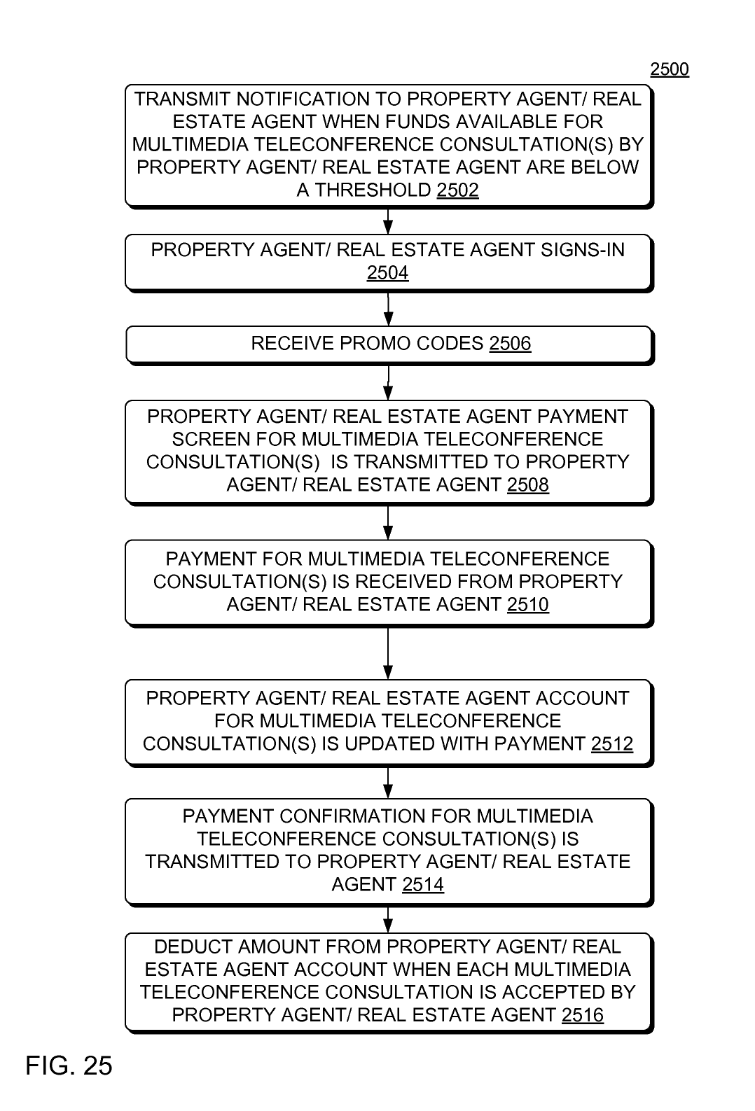

FIG. 25 is a flowchart of a method 2500 of performing SKU and inventory management of multimedia teleconference consultation(s) for a Property Agent/Real Estate Agent, according to an implementation. Method 2500 can be performed by SKU/inventory management 724 and the controller 710 of business-logic-and-rules-and-Property-Agent/Real-Estate-Agent-display in FIG. 7.

Method 2500 includes transmitting a notification to a Property Agent/Real Estate Agent when funds available for multimedia teleconference consultation(s) by Property Agent/Real Estate Agent are below a threshold, at block 2502. The notification indicates that funds available for multimedia teleconference consultation(s) by the Property Agent/Real Estate Agent are low. The notification can be email, text message or other push notification.

Method 2500 also includes the Property Agent/Real Estate Agent accessing the controller 710 of business-logic-and-rules-and-Property-Agent/Real-Estate-Agent-display by signing-in to the controller 710 of business-logic-and-rules-and-Property-Agent/Real-Estate-Agent-display, at block 2504.

Because credit card processors do not allow for discount codes, at block 2506, the SKU/inventory management 724 can receive and include promotion codes in the payment screen, as described in greater detail in conjunction with block 2006 in FIG. 20.

Method 2500 also includes transmitting a Property Agent/Real Estate Agent payment screen for multimedia teleconference consultation(s) to the Veterinarian by the controller 710 of business-logic-and-rules-and-Property-Agent/Real-Estate-Agent, at block 2508. The controller 710 of business-logic-and-rules-and-Property-Agent/Real-Estate-Agent-display transmits the Property Agent/Real Estate Agent payment screen. The payment screen can provide options on the multimedia teleconference consultation(s) such as location (city, state) of the client, specialty area (sub categories), cost per multimedia teleconference consultation, quantity of multimedia teleconference consultation(s), ability to adjust multimedia teleconference consultation(s) based on demand/need. The price can be listed by location/category and quantity. The payment screen can include the current amount of multimedia teleconference consultation(s) in the account of the Property Agent/Real Estate Agent.

Method 2500 also includes receiving payment for multimedia teleconference consultation(s) from the Property Agent/Real Estate Agent at the controller 710 of business-logic-and-rules-and-Property-Agent/Real Estate-Agent-display, at block 2510.

Method 2500 also includes updating the Property Agent/Real Estate Agent account for multimedia teleconference consultation(s) with the payment, at block 2512. Method 2500 also includes transmitting a confirmation of the payment for the multimedia teleconference consultation(s) to the Property Agent/Real Estate Agent, at block 2514. Method 2500 also includes deducting an amount for each multimedia teleconference consultation from the Property Agent/Real Estate Agent account when each multimedia teleconference consultation is accepted by the Property Agent/Real Estate Agent, at block 2516, such as in block 1610 in FIG. 16.

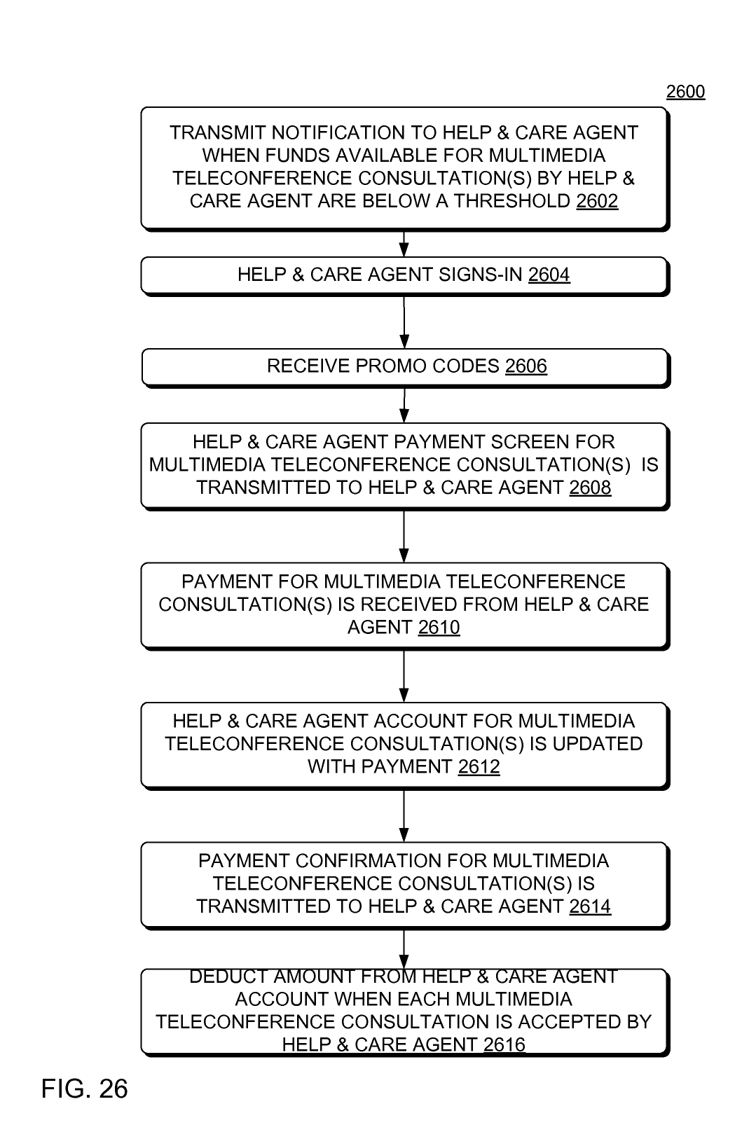

FIG. 26 is a flowchart of a method 2600 of performing SKU and inventory management of multimedia teleconference consultation(s) for a Help and Care Agent, according to an implementation. Method 2600 can be performed by SKU/inventory management 824 and the controller 810 of business-logic-and-rules-and-Help-and-Care-Agent-display in FIG. 8.

Method 2600 includes transmitting a notification to a Help and Care Agent when funds available for multimedia teleconference consultation(s) by Help and Care Agent are below a threshold, at block 2602. The notification indicates that funds available for multimedia teleconference consultation(s) by the Help and Care Agent are low. The notification can be email, text message or other push notification.

Method 2600 also includes the Help and Care Agent accessing the controller 810 of business-logic-and-rules-and-Help-and-Care-Agent-display by signing-in to the controller 810 of business-logic-and-rules-and-Help-and-Care-Agent-display, at block 2604.

Because credit card processors do not allow for discount codes, at block 2606, the SKU/inventory management 824 can receive and include promotion codes in the payment screen, as described in greater detail in conjunction with block 2006 in FIG. 20.

Method 2600 also includes transmitting a Help and Care Agent payment screen for multimedia teleconference consultation(s) to the Veterinarian by the controller 810 of business-logic-and-rules-and-Help-and-Care-Agent, at block 2608. The controller 810 of business-logic-and-rules-and-Help-and-Care-Agent-display transmits the Help and Care Agent payment screen. The payment screen can provide options on the multimedia teleconference consultation(s) such as location (city, state) of the customer, specialty area (sub categories), cost per multimedia teleconference consultation, quantity of multimedia teleconference consultation(s), ability to adjust multimedia teleconference consultation(s) based on demand/need. The price can be listed by location/category and quantity. The payment screen can include the current amount of multimedia teleconference consultation(s) in the account of the Help and Care Agent.

Method 2600 also includes receiving payment for multimedia teleconference consultation(s) from the Help and Care Agent at the controller 810 of business-logic-and-rules-and-Property-Agent/Real Estate-Agent-display, at block 2610.

Method 2600 also includes updating the Help and Care Agent account for multimedia teleconference consultation(s) with the payment, at block 2612. Method 2600 also includes transmitting a confirmation of the payment for the multimedia teleconference consultation(s) to the Help and Care Agent, at block 2614. Method 2600 also includes deducting an amount for each multimedia teleconference consultation from the Help and Care Agent account when each multimedia teleconference consultation is accepted by the Help and Care Agent, at block 2616, such as in block 1710 in FIG. 17.

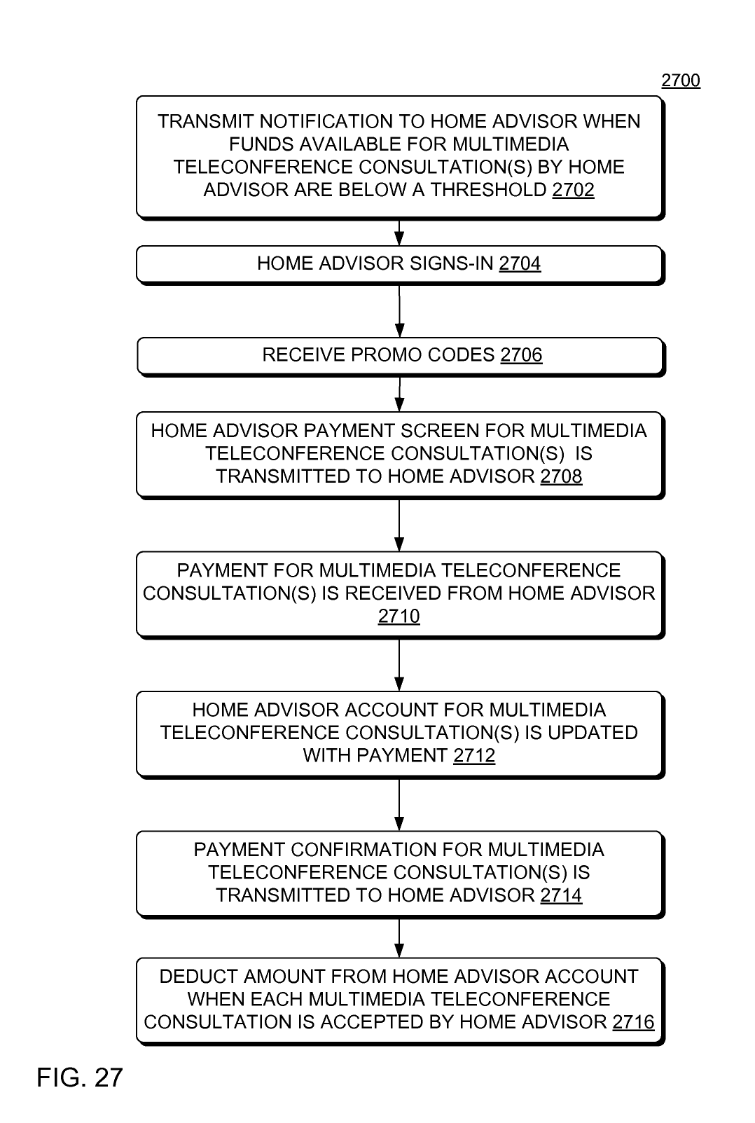

FIG. 27 is a flowchart of a method 2700 of performing SKU and inventory management of multimedia teleconference consultation(s) for a Home Advisor, according to an implementation. Method 2700 can be performed by SKU/inventory management 924 and the controller 910 of business-logic-and-rules-and-Home-Advisor-display in FIG. 9.

Method 2700 includes transmitting a notification to a Home Advisor when funds available for multimedia teleconference consultation(s) by Home Advisor are below a threshold, at block 2702. The notification indicates that funds available for multimedia teleconference consultation(s) by the Home Advisor are low. The notification can be email, text message or other push notification.

Method 2700 also includes the Home Advisor accessing the controller 910 of business-logic-and-rules-and-Home-Advisor-display by signing-in to the controller 910 of business-logic-and-rules-and-Home-Advisor-display, at block 2704.

Because credit card processors do not allow for discount codes, at block 2706, the SKU/inventory management 924 can receive and include promotion codes in the payment screen, as described in greater detail in conjunction with block 2006 in FIG. 20.

Method 2700 also includes transmitting a Home Advisor payment screen for multimedia teleconference consultation(s) to the Veterinarian by the controller 910 of business-logic-and-rules-and-Home-Advisor, at block 2708. The controller 910 of business-logic-and-rules-and-Home-Advisor-display transmits the Home Advisor payment screen. The payment screen can provide options on the multimedia teleconference consultation(s) such as location (city, state) of the customer, specialty area (sub categories), cost per multimedia teleconference consultation, quantity of multimedia teleconference consultation(s), ability to adjust multimedia teleconference consultation(s) based on demand/need. The price can be listed by location/category and quantity. The payment screen can include the current amount of multimedia teleconference consultation(s) in the account of the Home Advisor.

Method 2700 also includes receiving payment for multimedia teleconference consultation(s) from the Home Advisor at the controller 910 of business-logic-and-rules-and-Property-Agent/Real Estate-Agent-display, at block 2710.

Method 2700 also includes updating the Home Advisor account for multimedia teleconference consultation(s) with the payment, at block 2712. Method 2700 also includes transmitting a confirmation of the payment for the multimedia teleconference consultation(s) to the Home Advisor, at block 2714. Method 2700 also includes deducting an amount for each multimedia teleconference consultation from the Home Advisor account when each multimedia teleconference consultation is accepted by the Home Advisor, at block 2716, such as in block 1810 in FIG. 18.

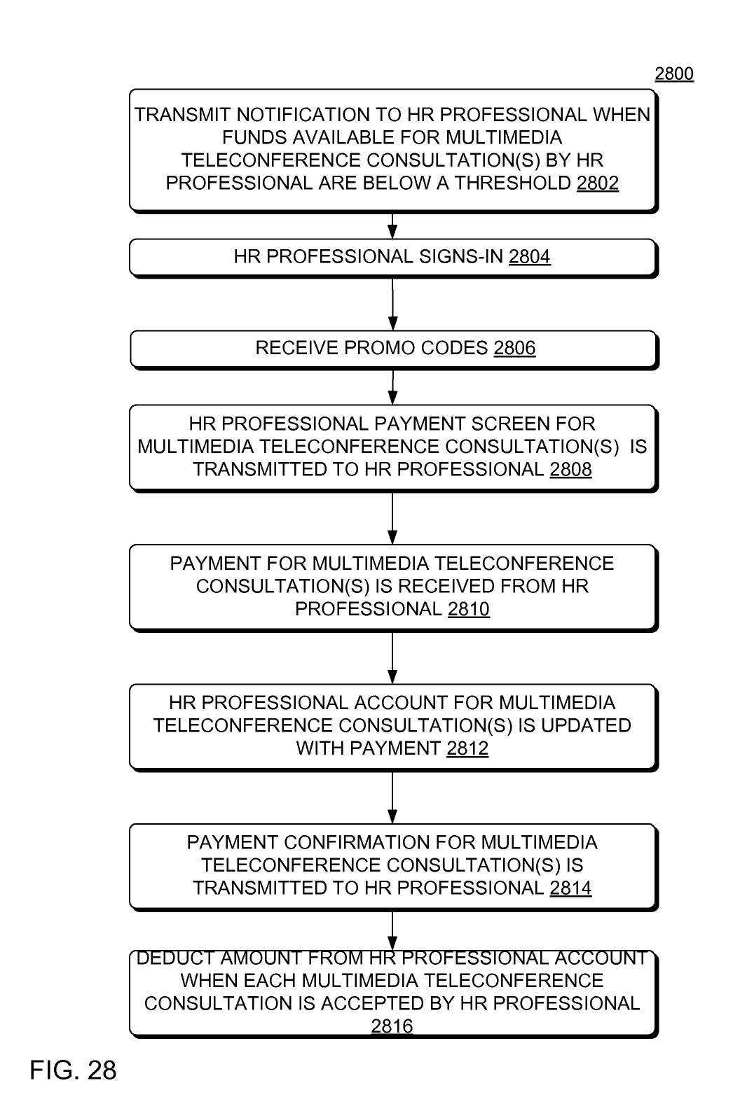

FIG. 28 is a flowchart of a method 2800 of performing SKU and inventory management of multimedia teleconference consultation(s) for a Job and Career Applicant, according to an implementation. Method 2800 can be performed by SKU/inventory management 1024 and the controller 1010 of business-logic-and-rules-and-Job-and-Career-Applicant-display in FIG. 10.

Method 2800 includes transmitting a notification to a Job and Career Applicant when funds available for multimedia teleconference consultation(s) by Job and Career Applicant are below a threshold, at block 2802. The notification indicates that funds available for multimedia teleconference consultation(s) by the Job and Career Applicant are low. The notification can be email, text message or other push notification.

Method 2800 also includes the Job and Career Applicant accessing the controller 1010 of business-logic-and-rules-and-Job-and-Career-Applicant-display by signing-in to the controller 1010 of business-logic-and-rules-and-Job-and-Career-Applicant-display, at block 2804.

Because credit card processors do not allow for discount codes, at block 2806, the SKU/inventory management 1024 can receive and include promotion codes in the payment screen, as described in greater detail in conjunction with block 2006 in FIG. 20.

Method 2800 also includes transmitting a Job and Career Applicant payment screen for multimedia teleconference consultation(s) to the Veterinarian by the controller 1010 of business-logic-and-rules-and-Job-and-Career-Applicant, at block 2808. The controller 1010 of business-logic-and-rules-and-Job-and-Career-Applicant-display transmits the Job and Career Applicant payment screen. The payment screen can provide options on the multimedia teleconference consultation(s) such as location (city, state) of the customer, specialty area (sub categories), cost per multimedia teleconference consultation, quantity of multimedia teleconference consultation(s), ability to adjust multimedia teleconference consultation(s) based on demand/need. The price can be listed by location/category and quantity. The payment screen can include the current amount of multimedia teleconference consultation(s) in the account of the Job and Career Applicant.

Method 2800 also includes receiving payment for multimedia teleconference consultation(s) from the Job and Career Applicant at the controller 1010 of business-logic-and-rules-and-Property-Agent/Real Estate-Agent-display, at block 2810.

Method 2800 also includes updating the Job and Career Applicant account for multimedia teleconference consultation(s) with the payment, at block 2812. Method 2800 also includes transmitting a confirmation of the payment for the multimedia teleconference consultation(s) to the Job and Career Applicant, at block 2814. Method 2800 also includes deducting an amount for each multimedia teleconference consultation from the Job and Career Applicant account when each multimedia teleconference consultation is accepted by the Job and Career Applicant, at block 2816, such as in block 1910 in FIG. 19.

### 5. USER FLOW DIAGRAMS OF MULTIMEDIA STREAMING BETWEEN HETEROGENEOUS COMPUTER SYSTEMS

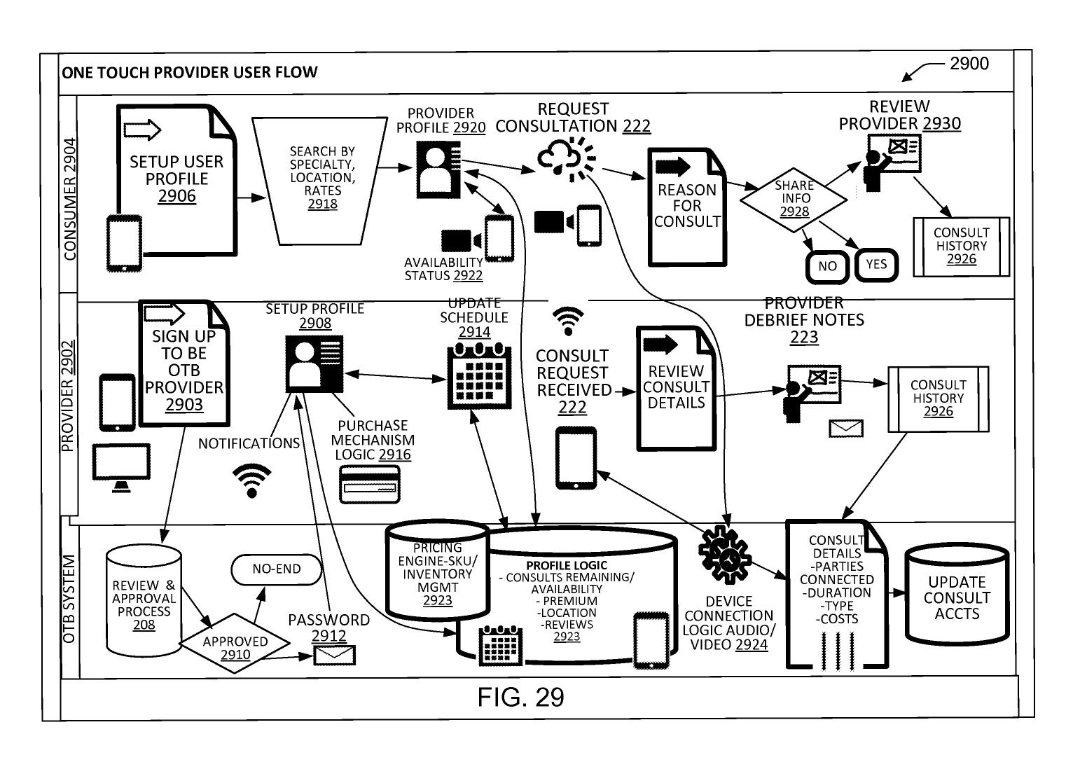

FIG. 29 is a user flow diagram of a process 2900 of interaction between a server, provider and a consumer in multimedia streaming between heterogeneous computer systems, according to an implementation.

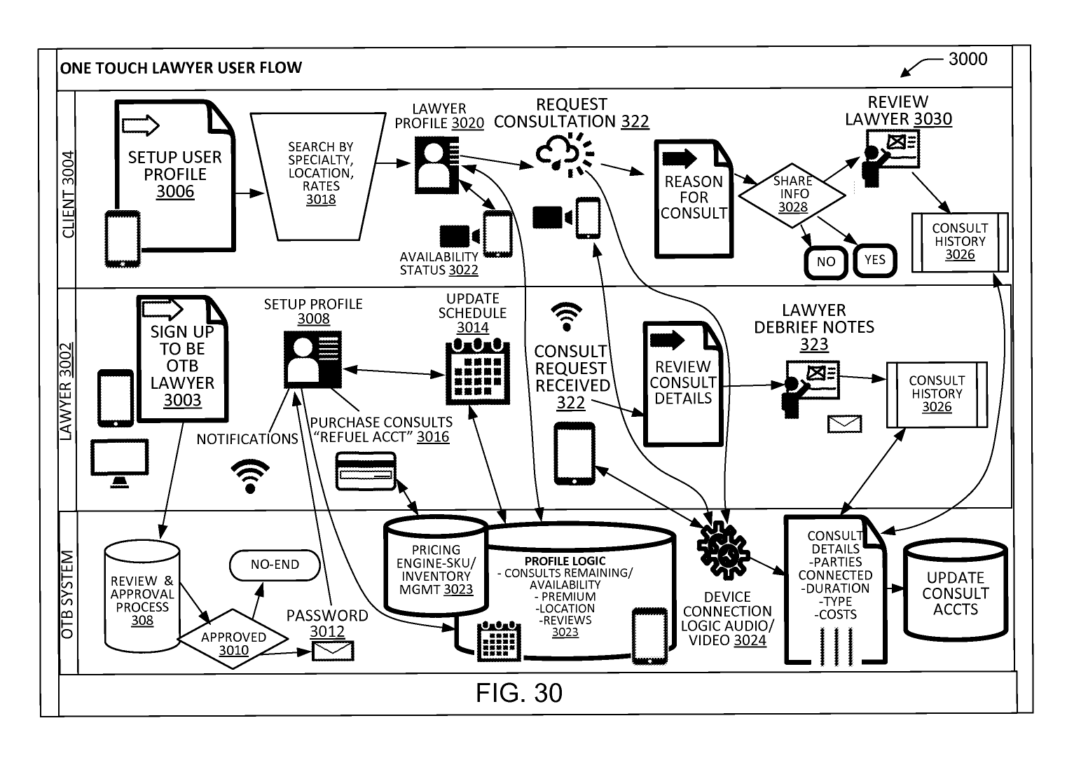

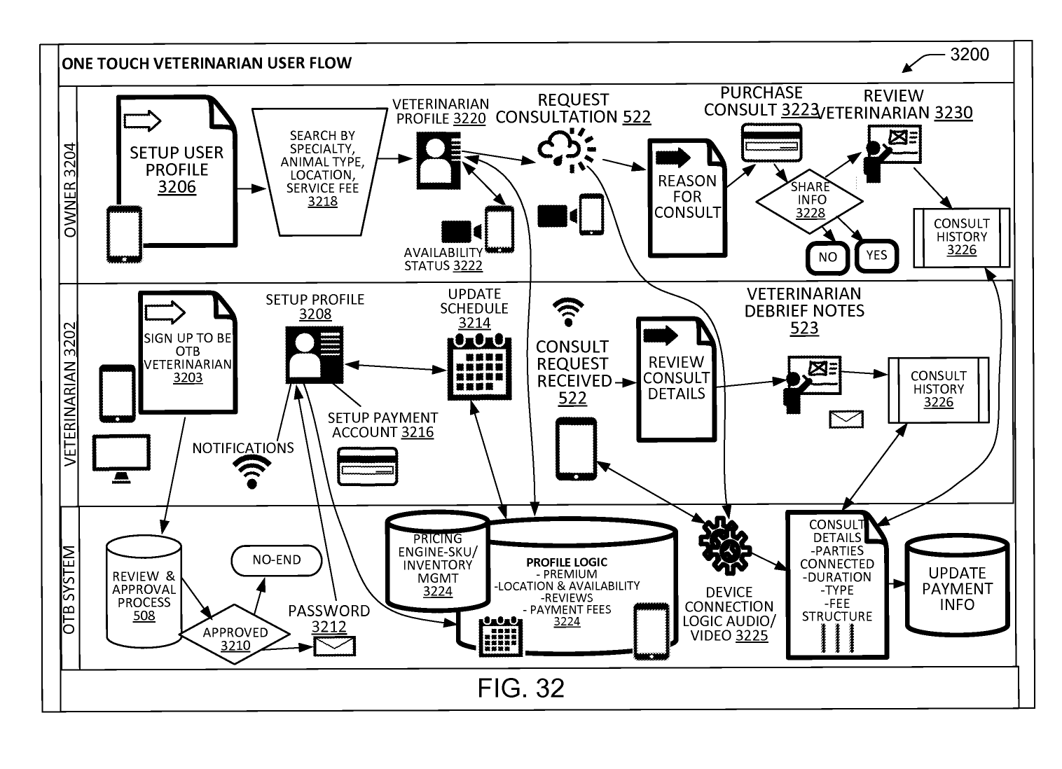

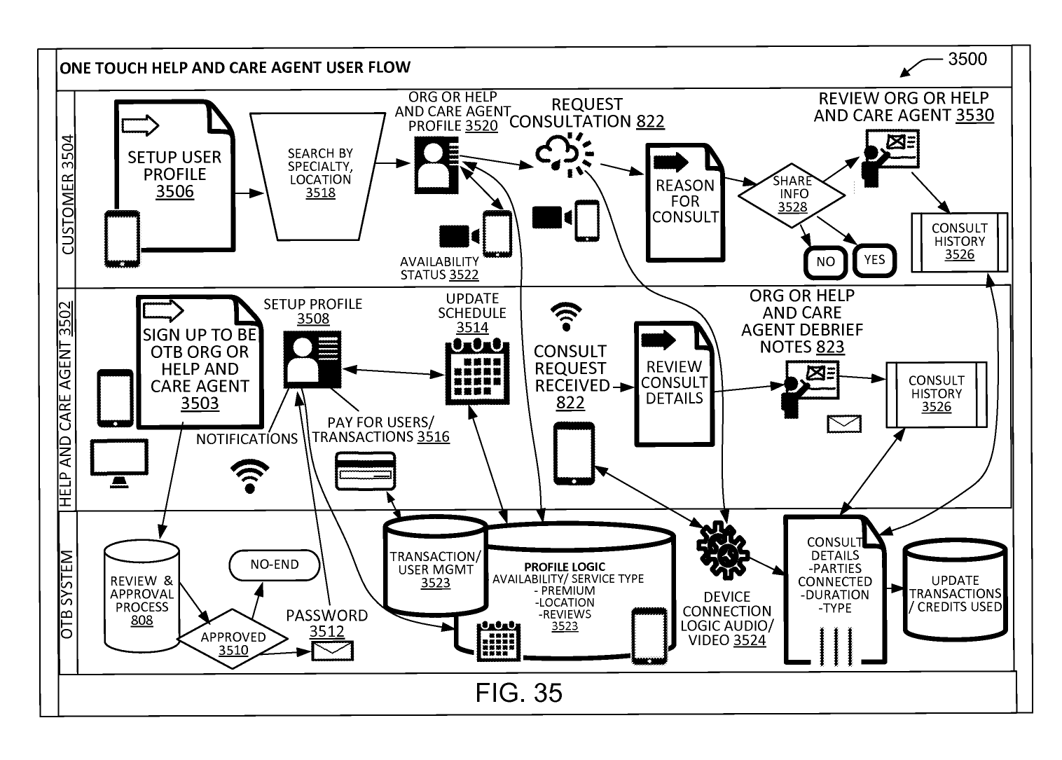

The process 2900 of multimedia streaming between heterogeneous computer systems includes the provider 2902 completing the subscription process 2903 (also known as a sign-up process) that is associated with a multimedia computing system 204. The process 2900 of multimedia streaming between heterogeneous computer systems includes the consumer 2904 completing the subscription process 2904 that is associated with a multimedia computing system 206. The subscription process 2906 includes creating and populating a record that includes fields that describe or represent of the consumer 2904, a first name, a last name, a state, a zip code, an email address, a phone number, a password, and a checkbox indicating consent by the consumer 2904 to the terms and conditions of the process 2900. A login from a social media website will also populate the record. The subscription process 2906 is also performed for the client in FIGS. 30-31 and 33-34, the owner in FIG. 32 and the customer in FIG. 35-37.

Quite commonly, the multimedia computing systems 204 and 206 are heterogeneous computing systems with significant differences in all capabilities, including differences in operating systems and performance of the hardware that can have significant effects on the multimedia interaction with other computing systems.

A profile of the provider 2902 is set-up (created) 2908 and is associated with the multimedia computing system 204. The provider profile is subject to a provider approval/review process 208 that can include review of any applicable licensing of the provider 2902. The provider approval/review process 208 can include rejecting a provider 2902 as a subscriber to the process 2900 of multimedia streaming between heterogeneous computer systems. The approval/review process 2910 also includes status of rejected and suspended status of each approved provider. Each approved provider is assigned a password 2912.

The provider profile is updated 2914 with a schedule of available times and dates of the provider 2902. The provider 2902 purchases assistance 2916 (as described in FIG. 20), which are recorded in the provider profile. The payment for assistance varies from industry to industry and from one particular contractual relationship to another particular contractual relationship. For example, in some situations, the payment for assistance is a consultation, in some situations the assistance is transaction and in other situations the assistance is pre-paid by the purchaser.

The process 2900 includes the consumer 2904 searching 2918 the profile 2920 of the provider 2902 in reference to the availability 2922 of the provider 2902 and other providers. When the provider 2902 is selected, a teleconference consultation request 222 and consultation notes are transmitted to the provider 2902 without delay. The immediacy of the transmission of the teleconference consultation request 222 and the consultation notes is a very important aspect because the immediacy helps support real-time consultation, in order to provide immediate consultation. In some implementations, the teleconference consultation request 222 expires within a predetermined time limit, such as 2 minutes, to further support immediate consultation.

When the provider 2902 accepts the teleconference consultation request, the process 2900 of multimedia streaming between heterogeneous computer systems performs processes 2923 in accordance with FIG. 20 and initiates a multimedia teleconference 2924 between the multimedia computing systems 204 and 206.

At the termination of the multimedia teleconference 2924 debrief notes 223 are transmitted from the multimedia computing system 204 to a consultation history 2926.

At the termination of the multimedia teleconference 2924, the consumer 2904 is queried to consent 2928 to share their information with the provider 2902 and the consumer 2904 is queried to complete a review 2930 with which the consultation history 2926 is updated.

In regards to the significant differences in operating systems and performance of the hardware in the heterogeneous computing systems of the multimedia computing system 204 and the multimedia computing system 206, capabilities detection of the multimedia computing system 204 and the multimedia computing system 206 is performed, such as detection of the model, microphone, video controls, camera, processor speed, bus speed, amount of cache memory, amount of non-cache memory, telecom carrier and operating system are performed. The possible parameters of the multimedia teleconference 2924 are determined based in the detected capabilities. For example, if no camera is detected at least one of the multimedia computing system 204 and the multimedia computing system 206, then the multimedia teleconference 2924 can be established but is limited to an audio teleconference 2924. If a camera is detected, but the image resolution that is detected on one of the multimedia computing system 204 and the multimedia computing system 206 is low resolution, then the multimedia teleconference 2924 can be established but is limited to a low-res video teleconference 2924. If no microphone is detected on either the multimedia computing system 204 or the multimedia computing system 206, then the multimedia teleconference 2924 is not allowed until a microphone is detected on the multimedia computing system 204 and the multimedia computing system 206. When the multimedia teleconference 2924 can be established, the communication between the multimedia computing system 204 and the multimedia computing system 206 is highly interactive and information is exchanged in real-time between the multimedia computing system 204 and the multimedia computing system 206, in comparison to slower email-based systems of communication between the multimedia computing system 204 and the multimedia computing system 206.

FIG. 30 is a user flow diagram of a process 3000 of interaction between a server, attorney and a client in multimedia streaming between heterogeneous computer systems, according to an implementation.

The process 3000 of multimedia streaming between heterogeneous computer systems includes the attorney 3002 completing the subscription process 3003 (also known as a sign-up process) that is associated with a multimedia computing system 304. The process 3000 of multimedia streaming between heterogeneous computer systems includes the client 3004 completing the subscription process 3006 that is associated with a multimedia computing system 306. The subscription process 3006 includes creating and populating a record that includes fields that describe or represent of the client 3004, a first name, a last name, a state, a zip code, an email address, a phone number, a password, and a checkbox indicating consent by the client 3004 to the terms and conditions of the process 3000. A login from a social media website will also populate the record. The subscription process 3003 is also performed for the client in FIGS. 30-31 and 33-34, the owner in FIG. 32 and the customer in FIG. 35-37.

Quite commonly, the multimedia computing systems 304 and 306 are heterogeneous computing systems with significant differences in all capabilities, including differences in operating systems and performance of the hardware that can have significant effects on the multimedia interaction with other computing systems.

A profile of the attorney 3002 is set-up (created) 3008 and is associated with the multimedia computing system 304. The attorney profile is subject to an attorney approval/review process 308 that can include review of any applicable licensing of the attorney 3002. The attorney approval/review process 308 can include rejecting an attorney 3002 as a subscriber to the process 3000 of multimedia streaming between heterogeneous computer systems. The approval/review process 3010 also includes status of rejected and suspended status of each approved attorney. Each approved attorney is assigned a password 3012.

The attorney profile is updated 3014 with a schedule of available times and dates of the attorney 3002. The attorney 3002 purchases consultations 3016 (as described in FIG. 21), which are recorded in the attorney profile.

The process 3000 includes the client 3004 searching 3018 the profile 3020 of the attorney 3002 in reference to the availability 3022 of the attorney 3002 and other attorneys. When the attorney 3002 is selected, a teleconference consultation request 322 and consultation notes are transmitted to the attorney 3002 without delay. The immediacy of the transmission of the teleconference consultation request 322 and the consultation notes is a very important aspect because the immediacy helps support real-time consultation, in order to provide immediate consultation. In some implementations, the teleconference consultation request 322 expires within a predetermined time limit, such as 2 minutes, to further support immediate consultation.

When the attorney 3002 accepts the teleconference consultation request, the process 3000 of multimedia streaming between heterogeneous computer systems performs processes 3023 in accordance with FIG. 21 and initiates a multimedia teleconference 3024 between the multimedia computing systems 304 and 306.

At the termination of the multimedia teleconference 3024 debrief notes 323 are transmitted from the multimedia computing system 304 to a consultation history 3026.

At the termination of the multimedia teleconference 3024, the client 3004 is queried to consent 3028 to share their information with the attorney 3002 and the client 3004 is queried to complete a review 3030 with which the consultation history 3026 is updated.

In regards to the significant differences in operating systems and performance of the hardware in the heterogeneous computing systems of the multimedia computing system 304 and the multimedia computing system 306, capabilities detection of the multimedia computing system 304 and the multimedia computing system 306 is performed, such as detection of the model, microphone, video controls, camera, processor speed, bus speed, amount of cache memory, amount of non-cache memory, telecom carrier and operating system are performed. The possible parameters of the multimedia teleconference 3024 are determined based in the detected capabilities. For example, if no camera is detected at least one of the multimedia computing system 304 and the multimedia computing system 306, then the multimedia teleconference 3024 can be established but is limited to an audio teleconference 3024. If a camera is detected, but the image resolution that is detected on one of the multimedia computing system 304 and the multimedia computing system 306 is low resolution, then the multimedia teleconference 3024 can be established but is limited to a low-res video teleconference 3024. If no microphone is detected on either the multimedia computing system 304 or the multimedia computing system 306, then the multimedia teleconference 3024 is not allowed until a microphone is detected on the multimedia computing system 304 and the multimedia computing system 306. When the multimedia teleconference 3024 can be established, the communication between the multimedia computing system 304 and the multimedia computing system 306 is highly interactive and information is exchanged in real-time between the multimedia computing system 304 and the multimedia computing system 306, in comparison to slower email-based systems of communication between the multimedia computing system 304 and the multimedia computing system 306.

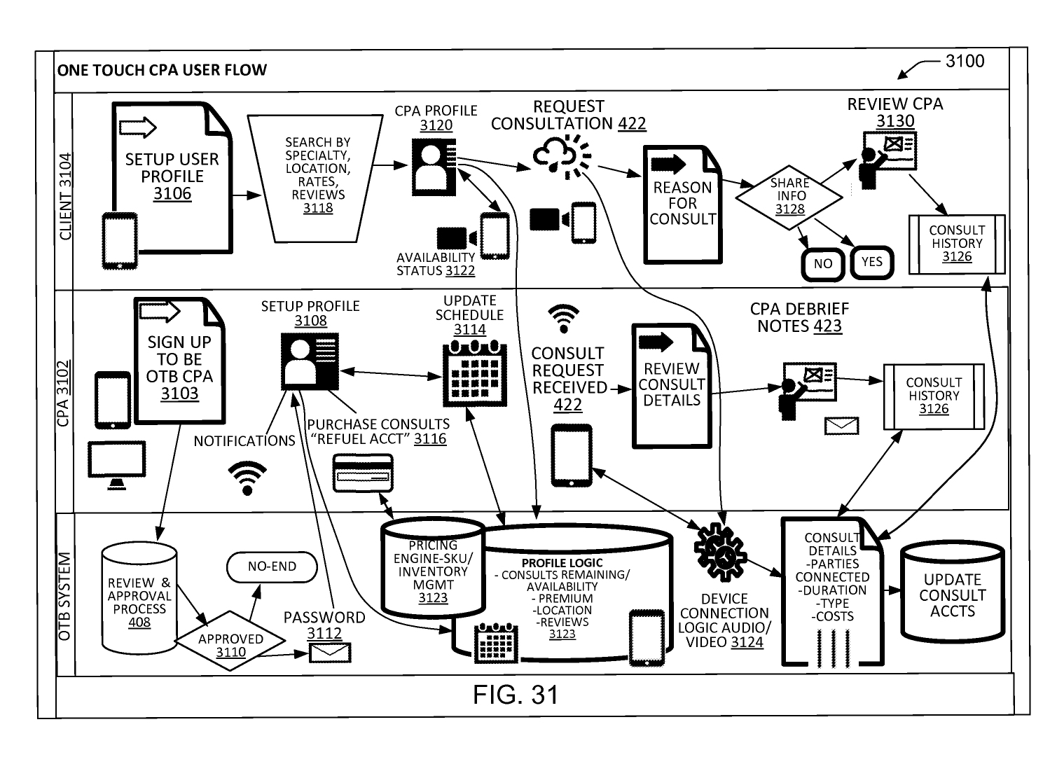

FIG. 31 is a user flow diagram of a process 3100 of interaction between a server. CPA and a client in multimedia streaming between heterogeneous computer systems, according to an implementation.

The process 3100 of multimedia streaming between heterogeneous computer systems includes the CPA 3102 completing the subscription process 3103 (also known as a sign-up process) that is associated with a multimedia computing system 404. The process 3100 of multimedia streaming between heterogeneous computer systems includes the client 3104 completing the subscription process 3106 that is associated with a multimedia computing system 406. The subscription process 3106 includes creating and populating a record that includes fields that describe or represent of the client 3104, a first name, a last name, a state, a zip code, an email address, a phone number, a password, and a checkbox indicating consent by the client 3104 to the terms and conditions of the process 3100. A login from a social media website will also populate the record. The subscription process 3103 is also performed for the client in FIGS. 20-21 and 23-24, the owner in FIG. 22 and the customer in FIG. 25-27.

Quite commonly, the multimedia computing systems 404 and 406 are heterogeneous computing systems with significant differences in all capabilities, including differences in operating systems and performance of the hardware that can have significant effects on the multimedia interaction with other computing systems.

A profile of the CPA 3102 is set-up (created) 3108 and is associated with the multimedia computing system 404. The CPA profile is subject to a CPA approval/review process 408 that can include review of any applicable licensing of the CPA 3102. The CPA approval/review process 408 can include rejecting a CPA 3102 as a subscriber to the process 3100 of multimedia streaming between heterogeneous computer systems. The approval/review process 3110 also includes status of rejected and suspended status of each approved CPA. Each approved CPA is assigned a password 3112.

The CPA profile is updated 3114 with a schedule of available times and dates of the CPA 3102. The CPA 3102 purchases consultations 3116 (as described in FIG. 22), which are recorded in the CPA profile.

The process 3100 includes the client 3104 searching 3118 the profile 3120 of the CPA 3102 in reference to the availability 3122 of the CPA 3102 and other CPAs. When the CPA 3102 is selected, a teleconference consultation request 422 and consultation notes are transmitted to the CPA 3102 without delay. The immediacy of the transmission of the teleconference consultation request 422 and the consultation notes is a very important aspect because the immediacy helps support real-time consultation, in order to provide immediate consultation. In some implementations, the teleconference consultation request 422 expires within a predetermined time limit, such as 2 minutes, to further support immediate consultation.

When the CPA 3102 accepts the teleconference consultation request, the process 3100 of multimedia streaming between heterogeneous computer systems performs processes 3123 in accordance with FIG. 22 and initiates a multimedia teleconference 3124 between the multimedia computing systems 404 and 406.

At the termination of the multimedia teleconference 3124 debrief notes 423 are transmitted from the multimedia computing system 404 to a consultation history 3126.

At the termination of the multimedia teleconference 3124, the client 3104 is queried to consent 3128 to share their information with the CPA 3102 and the client 3104 is queried to complete a review 3130 with which the consultation history 3126 is updated.

In regards to the significant differences in operating systems and performance of the hardware in the heterogeneous computing systems of the multimedia computing system 404 and the multimedia computing system 406, capabilities detection of the multimedia computing system 404 and the multimedia computing system 406 is performed, such as detection of the model, microphone, video controls, camera, processor speed, bus speed, amount of cache memory, amount of non-cache memory, telecom carrier and operating system are performed. The possible parameters of the multimedia teleconference 3124 are determined based in the detected capabilities. For example, if no camera is detected at least one of the multimedia computing system 404 and the multimedia computing system 406, then the multimedia teleconference 3124 can be established but is limited to an audio teleconference 3124. If a camera is detected, but the image resolution that is detected on one of the multimedia computing system 404 and the multimedia computing system 406 is low resolution, then the multimedia teleconference 3124 can be established but is limited to a low-res video teleconference 3124. If no microphone is detected on either the multimedia computing system 404 or the multimedia computing system 406, then the multimedia teleconference 3124 is not allowed until a microphone is detected on the multimedia computing system 404 and the multimedia computing system 406. When the multimedia teleconference 3124 can be established, the communication between the multimedia computing system 404 and the multimedia computing system 406 is highly interactive and information is exchanged in real-time between the multimedia computing system 404 and the multimedia computing system 406, in comparison to slower email-based systems of communication between the multimedia computing system 404 and the multimedia computing system 406.

FIG. 32 is a user flow diagram of a process 3200 of interaction between a server, veterinarian and an owner in multimedia streaming between heterogeneous computer systems, according to an implementation.

The process 3200 of multimedia streaming between heterogeneous computer systems includes the veterinarian 3202 completing the subscription process 3203 (also known as a sign-up process) that is associated with a multimedia computing system 504. The process 3200 of multimedia streaming between heterogeneous computer systems includes the owner 3204 completing the subscription process 3206 that is associated with a multimedia computing system 506. The subscription process 3206 includes creating and populating a record that includes fields that describe or represent of the owner 3204, a first name, a last name, a state, a zip code, an email address, a phone number, a password, and a checkbox indicating consent by the owner 3204 to the terms and conditions of the process 3200. The owner will be asked to enter their credit card information prior to a consultation with the Vet in order to connect a consultation. A login from a social media website will also populate the record.

Quite commonly, the multimedia computing systems 504 and 506 are heterogeneous computing systems with significant differences in all capabilities, including differences in operating systems and performance of the hardware that can have significant effects on the multimedia interaction with other computing systems.

A profile of the veterinarian 3202 is set-up (created) 3208 and is associated with the multimedia computing system 504. The veterinarian profile is subject to a veterinarian approval/review process 508 that can include review of any applicable licensing of the veterinarian 3202. The veterinarian approval/review process 508 can include rejecting a veterinarian 3202 as a subscriber to the process 3200 of multimedia streaming between heterogeneous computer systems. The approval/review process 3210 also includes status of rejected and suspended status of each approved veterinarian. Each approved veterinarian is assigned a password 3212.

The veterinarian profile is updated 3214 with a schedule of available times and dates of the veterinarian 3202. The veterinarian 3202 sets consultation pricing (within a defined range based on animal type and location) 3216 (as described in FIG. 23), which are recorded in the veterinarian profile.

The process 3200 includes the owner 3204 searching 3218 the profile 3220 of the veterinarian 3202 in reference to the availability 3222 of the veterinarian 3202 and other veterinarians. When the veterinarian 3202 is selected and the owner purchases 3223 a teleconference consultation, a teleconference consultation request 522 and consultation notes are transmitted to the veterinarian 3202 without delay. The immediacy of the transmission of the teleconference consultation request 522 and the consultation notes is a very important aspect because the immediacy helps support real-time consultation, in order to provide immediate consultation. In some implementations, the teleconference consultation request 522 expires within a predetermined time limit, such as 2 minutes, to further support immediate consultation.

When the veterinarian 3202 accepts the teleconference consultation request, the process 3200 of multimedia streaming between heterogeneous computer systems performs pricing processes 3224 in accordance with FIG. 23 and initiates a multimedia teleconference 3225 between the multimedia computing systems 504 and 506; and the veterinarian is paid a portion of the purchase price of the 3223 from the pricing processes 3224.

At the termination of the multimedia teleconference 3224 debrief notes 523 are transmitted from the multimedia computing system 504 to a consultation history 3226.

At the termination of the multimedia teleconference 3225, the owner 3204 is queried to consent 3228 to share their information with the veterinarian 3202 and the owner 3204 is queried to complete a review 3230 with which the consultation history 3226 is updated.

In regards to the significant differences in operating systems and performance of the hardware in the heterogeneous computing systems of the multimedia computing system 504 and the multimedia computing system 506, capabilities detection of the multimedia computing system 504 and the multimedia computing system 506 is performed, such as detection of the model, microphone, video controls, camera, processor speed, bus speed, amount of cache memory, amount of non-cache memory, telecom carrier and operating system are performed. The possible parameters of the multimedia teleconference 3225 are determined based in the detected capabilities. For example, if no camera is detected at least one of the multimedia computing system 504 and the multimedia computing system 506, then the multimedia teleconference 3225 can be established but is limited to an audio teleconference 3225. If a camera is detected, but the image resolution that is detected on one of the multimedia computing system 504 and the multimedia computing system 506 is low resolution, then the multimedia teleconference 3225 can be established but is limited to a low-res video teleconference 3225. If no microphone is detected on either the multimedia computing system 504 or the multimedia computing system 506, then the multimedia teleconference 3225 is not allowed until a microphone is detected on the multimedia computing system 504 and the multimedia computing system 506. When the multimedia teleconference 3225 can be established, the communication between the multimedia computing system 504 and the multimedia computing system 506 is highly interactive and information is exchanged in real-time between the multimedia computing system 504 and the multimedia computing system 506, in comparison to slower email-based systems of communication between the multimedia computing system 504 and the multimedia computing system 506.

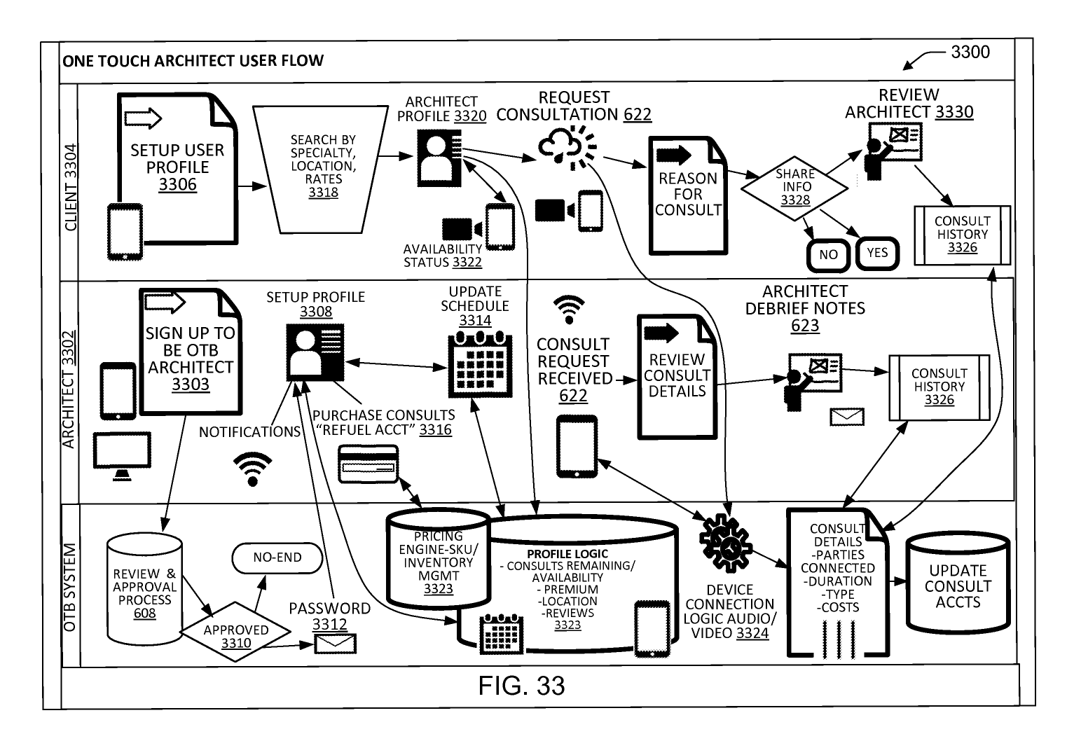

FIG. 33 is a user flow diagram of a process 3300 of interaction between a server, architect and a client in multimedia streaming between heterogeneous computer systems, according to an implementation.

The process 3300 of multimedia streaming between heterogeneous computer systems includes the architect 3302 completing the subscription process 3303 (also known as a sign-up process) that is associated with a multimedia computing system 604. The process 3300 of multimedia streaming between heterogeneous computer systems includes the client 3304 completing the subscription process 3304 that is associated with a multimedia computing system 606. The subscription process 3306 includes creating and populating a record that includes fields that describe or represent of the client 3304, a first name, a last name, a state, a zip code, an email address, a phone number, a password, and a checkbox indicating consent by the client 3304 to the terms and conditions of the process 3300. A login from a social media website will also populate the record.

Quite commonly, the multimedia computing systems 604 and 606 are heterogeneous computing systems with significant differences in all capabilities, including differences in operating systems and performance of the hardware that can have significant effects on the multimedia interaction with other computing systems.

A profile of the architect 3302 is set-up (created) 3308 and is associated with the multimedia computing system 604. The architect profile is subject to an architect approval/review process 608 that can include review of any applicable licensing of the architect 3302. The architect approval/review process 608 can include rejecting an architect 3302 as a subscriber to the process 3300 of multimedia streaming between heterogeneous computer systems. The approval/review process 3310 also includes status of rejected and suspended status of each approved architect. Each approved architect is assigned a password 3312.

The architect profile is updated 3314 with a schedule of available times and dates of the architect 3302. The architect 3302 purchases consultations 3316 (as described in FIG. 24), which are recorded in the architect profile.

The process 3300 includes the client 3304 searching 3318 the profile 3320 of the architect 3302 in reference to the availability 3322 of the architect 3302 and other architects. When the architect 3302 is selected, a teleconference consultation request 622 and consultation notes are transmitted to the architect 3302 without delay. The immediacy of the transmission of the teleconference consultation request 622 and the consultation notes is a very important aspect because the immediacy helps support real-time consultation, in order to provide immediate consultation. In some implementations, the teleconference consultation request 622 expires within a predetermined time limit, such as 2 minutes, to further support immediate consultation.

When the architect 3302 accepts the teleconference consultation request, the process 3300 of multimedia streaming between heterogeneous computer systems performs processes 3323 in accordance with FIG. 24 and initiates a multimedia teleconference 3324 between the multimedia computing systems 604 and 606.

At the termination of the multimedia teleconference 3324 debrief notes 623 are transmitted from the multimedia computing system 604 to a consultation history 3326.

At the termination of the multimedia teleconference 3324, the client 3304 is queried to consent 3328 to share their information with the architect 3302 and the client 3304 is queried to complete a review 3330 with which the consultation history 3326 is updated.

In regards to the significant differences in operating systems and performance of the hardware in the heterogeneous computing systems of the multimedia computing system 604 and the multimedia computing system 606, capabilities detection of the multimedia computing system 604 and the multimedia computing system 606 is performed, such as detection of the model, microphone, video controls, camera, processor speed, bus speed, amount of cache memory, amount of non-cache memory, telecom carrier and operating system are performed. The possible parameters of the multimedia teleconference 3324 are determined based in the detected capabilities. For example, if no camera is detected at least one of the multimedia computing system 604 and the multimedia computing system 606, then the multimedia teleconference 3324 can be established but is limited to an audio teleconference 3324. If a camera is detected, but the image resolution that is detected on one of the multimedia computing system 604 and the multimedia computing system 606 is low resolution, then the multimedia teleconference 3324 can be established but is limited to a low-res video teleconference 3324. If no microphone is detected on either the multimedia computing system 604 or the multimedia computing system 606, then the multimedia teleconference 3324 is not allowed until a microphone is detected on the multimedia computing system 604 and the multimedia computing system 606. When the multimedia teleconference 3324 can be established, the communication between the multimedia computing system 604 and the multimedia computing system 606 is highly interactive and information is exchanged in real-time between the multimedia computing system 604 and the multimedia computing system 606, in comparison to slower email-based systems of communication between the multimedia computing system 604 and the multimedia computing system 606.

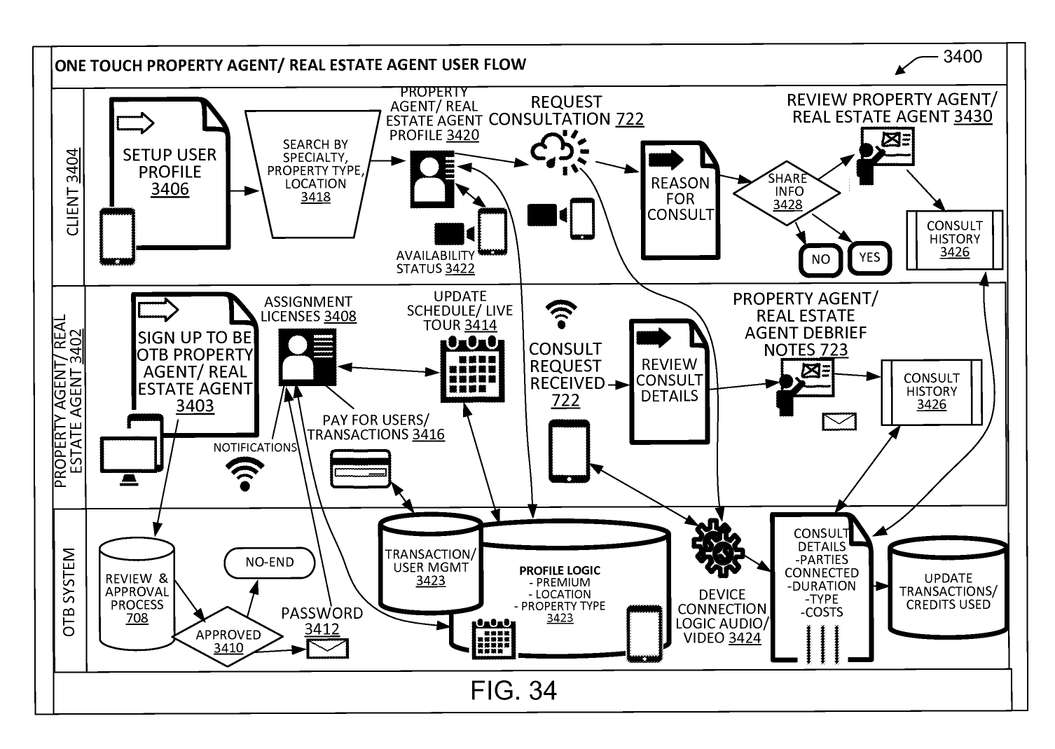

FIG. 34 is a user flow diagram of a process 3400 of interaction between a server, property agent and real estate agent and a client in multimedia streaming between heterogeneous computer systems, according to an implementation.

The process 3400 of multimedia streaming between heterogeneous computer systems includes the property agent and real estate agent 3402 completing the subscription process 3403 (also known as a sign-up process) that is associated with a multimedia computing system 704. The process 3400 of multimedia streaming between heterogeneous computer systems includes the client 3404 completing the subscription process 3406 that is associated with a multimedia computing system 706. The subscription process 3406 includes creating and populating a record that includes fields that describe or represent of the client 3404, a first name, a last name, a state, a zip code, an email address, a phone number, a password, and a checkbox indicating consent by the client 3404 to the terms and conditions of the process 3400. A login from a social media website will also populate the record.

Quite commonly, the multimedia computing systems 704 and 706 are heterogeneous computing systems with significant differences in all capabilities, including differences in operating systems and performance of the hardware that can have significant effects on the multimedia interaction with other computing systems.

Users and licensees are assigned 3408 and are associated with the multimedia computing system 704. The property agent and real estate agent profile is subject to a property agent and real estate agent approval/review process 708 that can include review of any applicable licensing of the property agent and real estate agent 3402. The property agent and real estate agent approval/review process 708 can include rejecting a property agent and real estate agent 3402 as a subscriber to the process 3400 of multimedia streaming between heterogeneous computer systems. The approval/review process 3410 also includes status of rejected and suspended status of each approved property agent and real estate agent. Each approved property agent and real estate agent is assigned a password 3412.

The property agent and real estate agent profile is updated 3414 with a schedule of available times and dates of the property agent and real estate agent 3402. The property agent and real estate agent 3402 purchases consultations 3416 (as described in FIG. 25), which are recorded in the property agent and real estate agent profile.

The process 3400 includes the client 3404 searching 3418 the profile 3420 of the property agent and real estate agent 3402 in reference to the availability 3422 of the property agent and real estate agent 3402 and other property agent and real estate agents. When the property agent and real estate agent 3402 is selected, a teleconference consultation request 722 and consultation notes are transmitted to the property agent and real estate agent 3402 without delay. The immediacy of the transmission of the teleconference consultation request 722 and the consultation notes is a very important aspect because the immediacy helps support real-time consultation, in order to provide immediate consultation. In some implementations, the teleconference consultation request 722 expires within a predetermined time limit, such as 2 minutes, to further support immediate consultation.

When the property agent and real estate agent 3402 accepts the teleconference consultation request, the process 3400 of multimedia streaming between heterogeneous computer systems performs processes 3423 in accordance with FIG. 25 and initiates a multimedia teleconference 3424 between the multimedia computing systems 704 and 706.

At the termination of the multimedia teleconference 3424 debrief notes 723 are transmitted from the multimedia computing system 704 to a consultation history 3426.

At the termination of the multimedia teleconference 3424, the client 3404 is queried to consent 3428 to share their information with the property agent and real estate agent 3402 and the client 3404 is queried to complete a review 3430 with which the consultation history 3426 is updated.

In regards to the significant differences in operating systems and performance of the hardware in the heterogeneous computing systems of the multimedia computing system 704 and the multimedia computing system 706, capabilities detection of the multimedia computing system 704 and the multimedia computing system 706 is performed, such as detection of the model, microphone, video controls, camera, processor speed, bus speed, amount of cache memory, amount of non-cache memory, telecom carrier and operating system are performed. The possible parameters of the multimedia teleconference 3424 are determined based in the detected capabilities. For example, if no camera is detected at least one of the multimedia computing system 704 and the multimedia computing system 706, then the multimedia teleconference 3424 can be established but is limited to an audio teleconference 3424. If a camera is detected, but the image resolution that is detected on one of the multimedia computing system 704 and the multimedia computing system 706 is low resolution, then the multimedia teleconference 3424 can be established but is limited to a low-res video teleconference 3424. If no microphone is detected on either the multimedia computing system 704 or the multimedia computing system 706, then the multimedia teleconference 3424 is not allowed until a microphone is detected on the multimedia computing system 704 and the multimedia computing system 706. When the multimedia teleconference 3424 can be established, the communication between the multimedia computing system 704 and the multimedia computing system 706 is highly interactive and information is exchanged in real-time between the multimedia computing system 704 and the multimedia computing system 706, in comparison to slower email-based systems of communication between the multimedia computing system 704 and the multimedia computing system 706.

FIG. 35 is a user flow diagram of a process 3500 of interaction between a server, Help and Care Agent and a customer in multimedia streaming between heterogeneous computer systems, according to an implementation.

The process 3500 of multimedia streaming between heterogeneous computer systems includes the Help and Care Agent 3502 completing the subscription process 3503 (also known as a sign-up process) that is associated with a multimedia computing system 804. The process 3500 of multimedia streaming between heterogeneous computer systems includes the customer 3504 completing the subscription process 3506 that is associated with a multimedia computing system 806. The subscription process 3506 includes creating and populating a record that includes fields that describe or represent of the customer 3504, a first name, a last name, a state, a zip code, an email address, a phone number, a password, and a checkbox indicating consent by the customer 3504 to the terms and conditions of the process 3500. A login from a social media website will also populate the record.

Quite commonly, the multimedia computing systems 804 and 806 are heterogeneous computing systems with significant differences in all capabilities, including differences in operating systems and performance of the hardware that can have significant effects on the multimedia interaction with other computing systems.

A profile of the Help and Care Agent 3502 is set-up (created) 3508 and is associated with the multimedia computing system 804. The Help and Care Agent profile is subject to a Help and Care Agent approval/review process 808 that can include review of any applicable licensing of the Help and Care Agent 3502. The Help and Care Agent approval/review process 808 can include rejecting a Help and Care Agent 3502 as a subscriber to the process 3500 of multimedia streaming between heterogeneous computer systems. The approval/review process 3510 also includes status of rejected and suspended status of each approved Help and Care Agent. Each approved Help and Care Agent is assigned a password 3512.

The Help and Care Agent profile is updated 3514 with a schedule of available times and dates of the Help and Care Agent 3502. The Help and Care Agent 3502 purchases a subscription/license 3516 (as described in FIG. 26), which are recorded in the Help and Care Agent profile.

The process 3500 includes the customer 3504 searching 3518 the profile 3520 of the Help and Care Agent 3502 in reference to the availability 3522 of the Help and Care Agent 3502 and other Help and Care Agents. When the Help and Care Agent 3502 are selected, a teleconference consultation request 822 and consultation notes are transmitted to the Help and Care Agent 3502 without delay. The immediacy of the transmission of the teleconference consultation request 822 and the consultation notes is a very important aspect because the immediacy helps support real-time consultation, in order to provide immediate consultation. In some implementations, the teleconference consultation request 822 expires within a predetermined time limit, such as 2 minutes, to further support immediate consultation.

When the Help and Care Agent 3502 accepts the teleconference consultation request, the process 3500 of multimedia streaming between heterogeneous computer systems performs processes 3523 in accordance with FIG. 26 and initiates a multimedia teleconference 3524 between the multimedia computing systems 804 and 806.

At the termination of the multimedia teleconference 3524 debrief notes 823 are transmitted from the multimedia computing system 804 to a consultation history 3526.

At the termination of the multimedia teleconference 3524, the customer 3504 is queried to consent 3528 to share their information with the Help and Care Agent 3502 and the customer 3504 is queried to complete a review 3530 with which the consultation history 3526 is updated.

In regards to the significant differences in operating systems and performance of the hardware in the heterogeneous computing systems of the multimedia computing system 804 and the multimedia computing system 806, capabilities detection of the multimedia computing system 804 and the multimedia computing system 806 is performed, such as detection of the model, microphone, video controls, camera, processor speed, bus speed, amount of cache memory, amount of non-cache memory, telecom carrier and operating system are performed. The possible parameters of the multimedia teleconference 3524 are determined based in the detected capabilities. For example, if no camera is detected at least one of the multimedia computing system 804 and the multimedia computing system 806, then the multimedia teleconference 3524 can be established but is limited to an audio teleconference 3524. If a camera is detected, but the image resolution that is detected on one of the multimedia computing system 804 and the multimedia computing system 806 is low resolution, then the multimedia teleconference 3524 can be established but is limited to a low-res video teleconference 3524. If no microphone is detected on either the multimedia computing system 804 or the multimedia computing system 806, then the multimedia teleconference 3524 is not allowed until a microphone is detected on the multimedia computing system 804 and the multimedia computing system 806. When the multimedia teleconference 3524 can be established, the communication between the multimedia computing system 804 and the multimedia computing system 806 is highly interactive and information is exchanged in real-time between the multimedia computing system 804 and the multimedia computing system 806, in comparison to slower email-based systems of communication between the multimedia computing system 804 and the multimedia computing system 806.

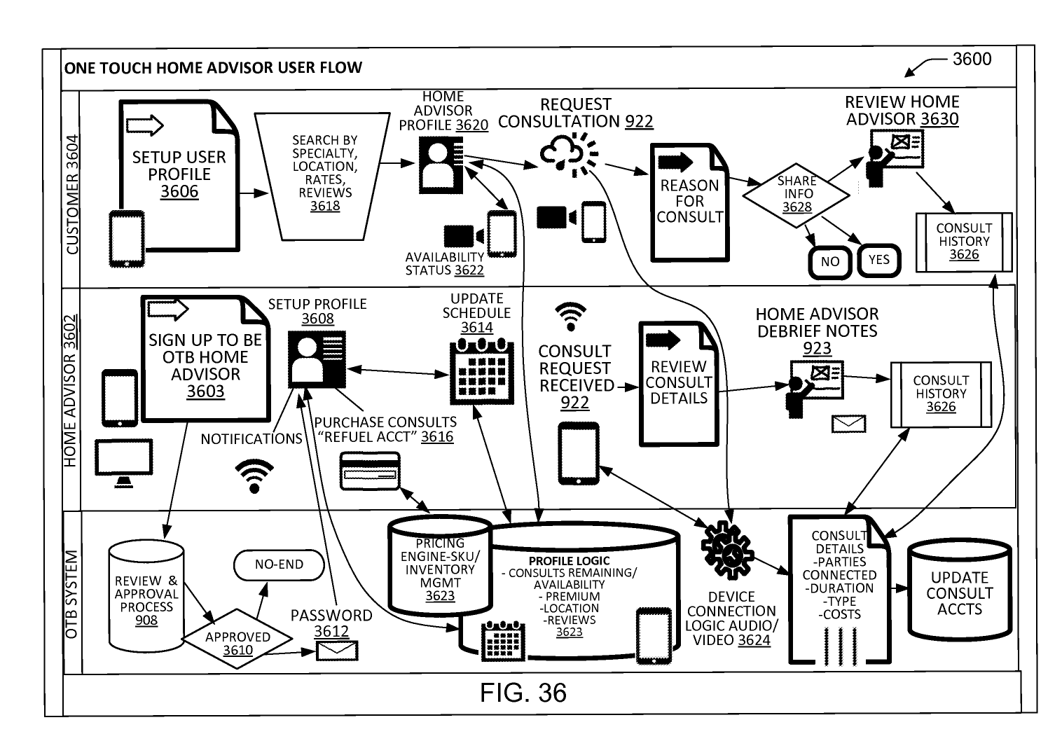

FIG. 36 is a user flow diagram of a process 3600 of interaction between a server, Home Advisor and a customer in multimedia streaming between heterogeneous computer systems, according to an implementation.

The process 3600 of multimedia streaming between heterogeneous computer systems includes the Home Advisor 3602 completing the subscription process 3603 (also known as a sign-up process) that is associated with a multimedia computing system 904. The process 3600 of multimedia streaming between heterogeneous computer systems includes the customer 3604 completing the subscription process 3606 that is associated with a multimedia computing system 906. The subscription process 3606 includes creating and populating a record that includes fields that describe or represent of the customer 3604, a first name, a last name, a state, a zip code, an email address, a phone number, a password, and a checkbox indicating consent by the customer 3604 to the terms and conditions of the process 3600. A login from a social media website will also populate the record.

Quite commonly, the multimedia computing systems 904 and 906 are heterogeneous computing systems with significant differences in all capabilities, including differences in operating systems and performance of the hardware that can have significant effects on the multimedia interaction with other computing systems.

A profile of the Home Advisor 3602 is set-up (created) 3608 and is associated with the multimedia computing system 904. The Home Advisor profile is subject to a Home Advisor approval/review process 908 that can include review of any applicable licensing of the Home Advisor 3602. The Home Advisor approval/review process 908 can include rejecting a Home Advisor 3602 as a subscriber to the process 3600 of multimedia streaming between heterogeneous computer systems. The approval/review process 3610 also includes status of rejected and suspended status of each approved Home Advisor. Each approved Home Advisor is assigned a password 3612.

The Home Advisor profile is updated 3614 with a schedule of available times and dates of the Home Advisor 3602. The Home Advisor 3602 purchases consultations 3616 (as described in FIG. 27), which are recorded in the Home Advisor profile.

The process 3600 includes the customer 3604 searching 3618 the profile 3620 of the Home Advisor 3602 in reference to the availability 3622 of the Home Advisor 3602 and other Home Advisors. When the Home Advisor 3602 is selected, a teleconference consultation request 922 and consultation notes are transmitted to the Home Advisor 3602 without delay. The immediacy of the transmission of the teleconference consultation request 922 and the consultation notes is a very important aspect because the immediacy helps support real-time consultation, in order to provide immediate consultation. In some implementations, the teleconference consultation request 922 expires within a predetermined time limit, such as 2 minutes, to further support immediate consultation.

When the Home Advisor 3602 accepts the teleconference consultation request, the process 3600 of multimedia streaming between heterogeneous computer systems performs processes 3623 in accordance with FIG. 27 and initiates a multimedia teleconference 3624 between the multimedia computing systems 904 and 906.

At the termination of the multimedia teleconference 3624 debrief notes 923 are transmitted from the multimedia computing system 904 to a consultation history 3626.

At the termination of the multimedia teleconference 3624, the customer 3604 is queried to consent 3628 to share their information with the Home Advisor 3602 and the customer 3604 is queried to complete a review 3630 with which the consultation history 3626 is updated.

In regards to the significant differences in operating systems and performance of the hardware in the heterogeneous computing systems of the multimedia computing system 904 and the multimedia computing system 906, capabilities detection of the multimedia computing system 904 and the multimedia computing system 906 is performed, such as detection of the model, microphone, video controls, camera, processor speed, bus speed, amount of cache memory, amount of non-cache memory, telecom carrier and operating system are performed. The possible parameters of the multimedia teleconference 3624 are determined based in the detected capabilities. For example, if no camera is detected at least one of the multimedia computing system 904 and the multimedia computing system 906, then the multimedia teleconference 3624 can be established but is limited to an audio teleconference 3624. If a camera is detected, but the image resolution that is detected on one of the multimedia computing system 904 and the multimedia computing system 906 is low resolution, then the multimedia teleconference 3624 can be established but is limited to a low-res video teleconference 3624. If no microphone is detected on either the multimedia computing system 904 or the multimedia computing system 906, then the multimedia teleconference 3624 is not allowed until a microphone is detected on the multimedia computing system 904 and the multimedia computing system 906. When the multimedia teleconference 3624 can be established, the communication between the multimedia computing system 904 and the multimedia computing system 906 is highly interactive and information is exchanged in real-time between the multimedia computing system 904 and the multimedia computing system 906, in comparison to slower email-based systems of communication between the multimedia computing system 904 and the multimedia computing system 906.

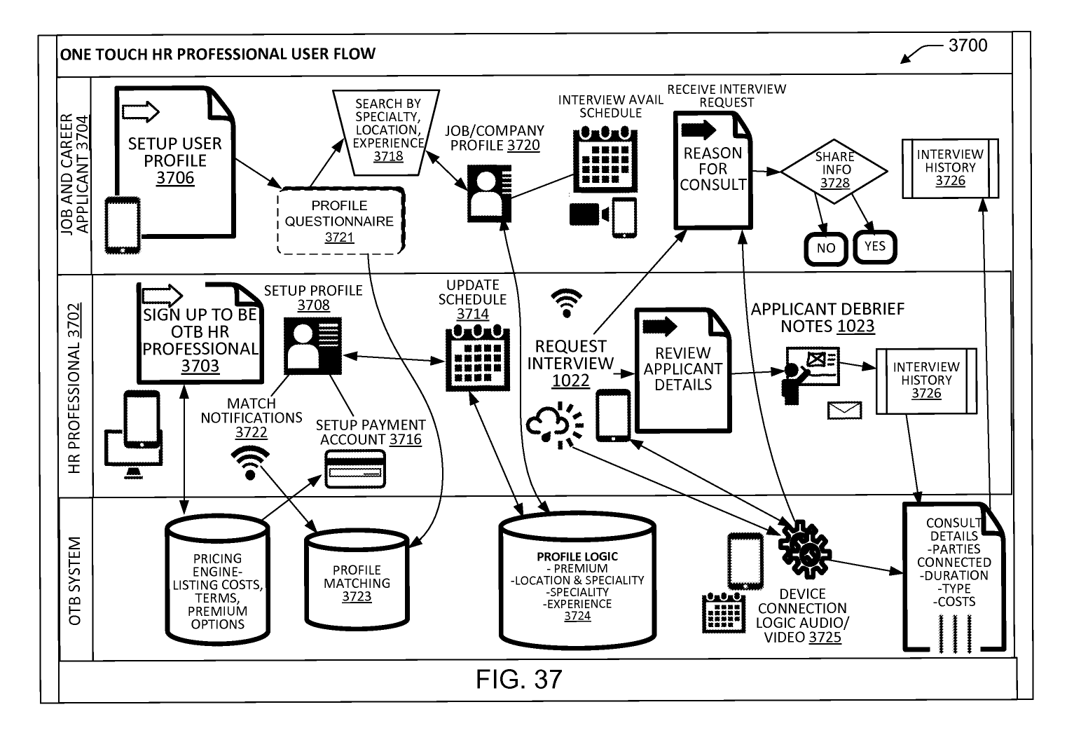

FIG. 37 is a user flow diagram of a process 3700 of interaction between a server, HR Professional and a Job and Career Applicant in multimedia streaming between heterogeneous computer systems, according to an implementation.

The process 3700 of multimedia streaming between heterogeneous computer systems includes the HR Professional 3702 completing the subscription process 3703 (also known as a sign-up process) that is associated with a multimedia computing system 1004. The process 3700 of multimedia streaming between heterogeneous computer systems includes the Job and Career Applicant 3704 completing the subscription process 3706 that is associated with a multimedia computing system 1006. The subscription process 3706 includes creating and populating a record that includes fields that describe or represent of the Job and Career Applicant 3704, a first name, a last name, a state, a zip code, an email address, a phone number, a password, and a checkbox indicating consent by the Job and Career Applicant 3704 to the terms and conditions of the process 3700. A login from a social media website will also populate the record.

Quite commonly, the multimedia computing systems 1004 and 1006 are heterogeneous computing systems with significant differences in all capabilities, including differences in operating systems and performance of the hardware that can have significant effects on the multimedia interaction with other computing systems.

A profile of the HR Professional 3702 is set-up (created) 3708 and is associated with the multimedia computing system 1004. The HR Professional profile is subject to a HR Professional approval/review process 1008 that can include review of any applicable licensing of the HR Professional 3702. The HR Professional approval/review process 1008 can include rejecting a HR Professional 3702 as a subscriber to the process 3700 of multimedia streaming between heterogeneous computer systems.

The HR Professional profile is updated 3714 with a schedule of available times and dates of the HR Professional 3702. The HR Professional 3702 purchases consultations 3716 (as described in FIG. 28), which are recorded in the HR Professional profile. The purchased consultations 3716 can be used by the HR Professional or the purchased consultations 3716 can designated to be used by other HR Professionals associated to the HR Professional, such as in the same organization.

The process 3700 includes the Job and Career Applicant 3704 searching 3718 the profile 3720 of the HR Professional 3702 in reference to a profile 3721 of the Job and Career Applicant 3704. When the profile 3721 of the Job and Career Applicant 3704 is determined to match the setup profiled 3708 of the HR Professional 3702, a notification 3722 is transmitted and a database of profile matches 3723 is updated with the newly determined match.

When the HR Professional 3702 is selected, a teleconference consultation request 1022 and consultation notes are transmitted to the HR Professional 3702 without delay. The immediacy of the transmission of the teleconference consultation request 1022 and the consultation notes is a very important aspect because the immediacy helps support real-time consultation, in order to provide immediate consultation. In some implementations, the teleconference consultation request 1022 expires within a predetermined time limit, such as 2 minutes, to further support immediate consultation.

When the HR Professional 3702 accepts the teleconference consultation request, the process 3700 of multimedia streaming between heterogeneous computer systems performs processes 3724 in accordance with FIG. 28 and initiates a multimedia teleconference 3725 between the multimedia computing systems 1004 and 1006.

At the termination of the multimedia teleconference 3725 debrief notes 1023 are transmitted from the multimedia computing system 1004 to a Interview History 3726.

At the termination of the multimedia teleconference 3724, the Job and Career Applicant 3704 is queried to consent 3728 to share their information with the HR Professional 3702.

In regards to the significant differences in operating systems and performance of the hardware in the heterogeneous computing systems of the multimedia computing system 1004 and the multimedia computing system 1006, capabilities detection of the multimedia computing system 1004 and the multimedia computing system 1006 is performed, such as detection of the model, microphone, video controls, camera, processor speed, bus speed, amount of cache memory, amount of non-cache memory, telecom carrier and operating system are performed. The possible parameters of the multimedia teleconference 3725 are determined based in the detected capabilities. For example, if no camera is detected at least one of the multimedia computing system 1004 and the multimedia computing system 1006, then the multimedia teleconference 3725 can be established but is limited to an audio teleconference 3725. If a camera is detected, but the image resolution that is detected on one of the multimedia computing system 1004 and the multimedia computing system 1006 is low resolution, then the multimedia teleconference 3725 can be established but is limited to a low-res video teleconference 3725. If no microphone is detected on either the multimedia computing system 1004 or the multimedia computing system 1006, then the multimedia teleconference 3725 is not allowed until a microphone is detected on the multimedia computing system 1004 and the multimedia computing system 1006. When the multimedia teleconference 3725 can be established, the communication between the multimedia computing system 1004 and the multimedia computing system 1006 is highly interactive and information is exchanged in real-time between the multimedia computing system 1004 and the multimedia computing system 1006, in comparison to slower email-based systems of communication between the multimedia computing system 1004 and the multimedia computing system 1006.

### 6. HARDWARE AND OPERATING ENVIRONMENTS

Hand-held device 3800, personal computer 3900 and tablet computer 4100 are examples of the heterogeneous computer systems 108 and the multimedia computing system 204, 206, 304, 306, 404, 406, 504, 506, 604, 606, 704, 706, 804, 806, 904, 906, 1004 and 1006.

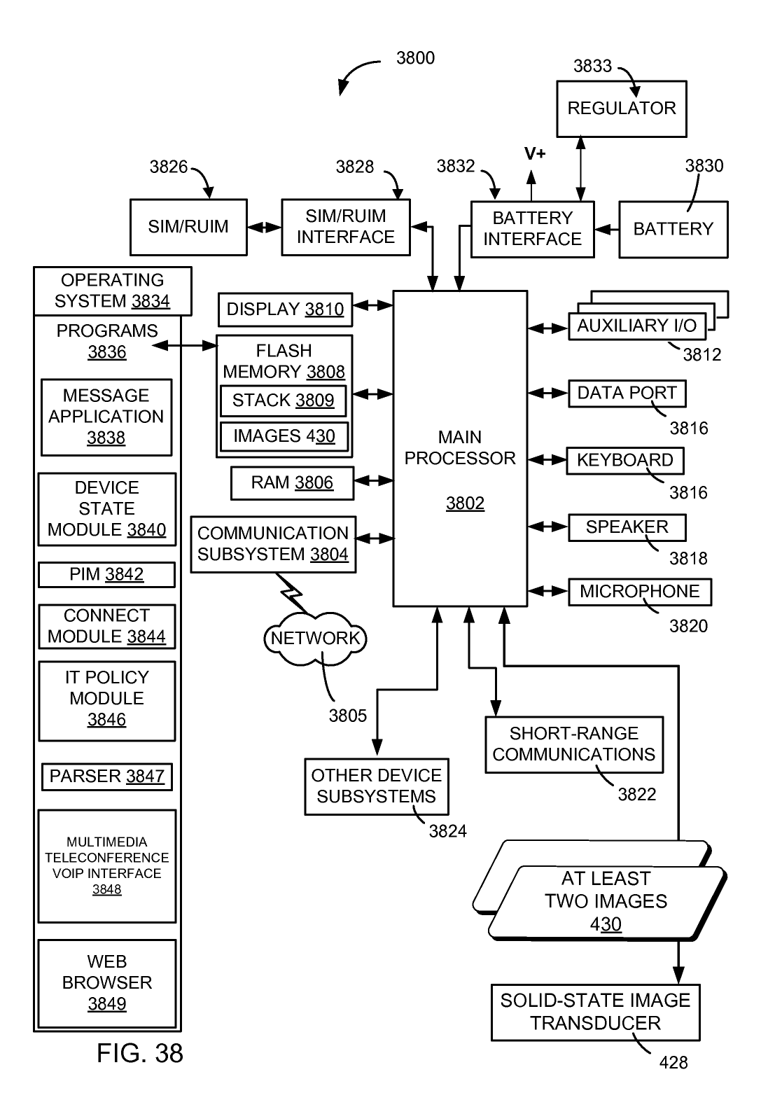

FIG. 38 is a block diagram of a hand-held device 3800, according to an implementation. The hand-held device 3800 may also have the capability to allow voice communication. Depending on the functionality provided by the hand-held device 3800, the hand-held device 3800 may be referred to as a data messaging device, a two-way pager, a cellular telephone with data messaging capabilities, a wireless Internet appliance, or a data communication device (with or without telephony capabilities).

The hand-held device 3800 includes a number of modules such as a main processor 3802 that controls the overall operation of the hand-held device 3800. Communication functions, including data and voice communications, are performed through a communication subsystem 3804. The communication subsystem 3804 receives messages from and sends messages to wireless networks 3805. In other implementations of the hand-held device 3800, the communication subsystem 3804 can be configured in accordance with the Global System for Mobile Communication (GSM), General Packet Radio Services (GPRS), Enhanced Data GSM Environment (EDGE), Universal Mobile Telecommunications Service (UMTS), data-centric wireless networks, voice-centric wireless networks, and dual-mode networks that can support both voice and data communications over the same physical base stations. Combined dual-mode networks include, but are not limited to, Code Division Multiple Access (CDMA) or CDMA2000 networks, GSM/GPRS networks (as mentioned above), and future third-generation (3G) networks like EDGE and UMTS. Some other examples of data-centric networks include Mobitex™ and DataTAC™ network communication systems. Examples of other voice-centric data networks include Personal Communication Systems (PCS) networks like GSM and Time Division Multiple Access (TDMA) systems.

The wireless link connecting the communication subsystem 3804 with the wireless network 3805 represents one or more different Radio Frequency (RF) channels. With newer network protocols, these channels are capable of supporting both circuit switched voice communications and packet switched data communications.

The main processor 3802 also interacts with additional subsystems such as a Random Access Memory (RAM) 3806, a flash memory 3808, a display 3810, an auxiliary input/output (I/O) subsystem 3812, a data port 3814, a keyboard 3816, a speaker 3818, a microphone 3820, short-range communications subsystem 3822 and other device subsystems 3824. In some implementations, the flash memory 3808 includes a hybrid femtocell/Wi-Fi protocol stack 3809. The hybrid femtocell/Wi-Fi protocol stack 3809 supports authentication and authorization between the hand-held device 3800 into a shared Wi-Fi network and both a 3G and 4G mobile networks.

Some of the subsystems of the hand-held device 3800 perform communication-related functions, whereas other subsystems may provide “resident” or on-device functions. By way of example, the display 3810 and the keyboard 3816 may be used for both communication-related functions, such as entering a text message for transmission over the wireless network 3805, and device-resident functions such as a calculator or task list.

The hand-held device 3800 can transmit and receive communication signals over the wireless network 3805 after required network registration or activation procedures have been completed. Network access is associated with a subscriber or user of the hand-held device 3800. To identify a subscriber, the hand-held device 3800 requires a SIM card/RUIM 3826 (i.e. Subscriber Identity Module or a Removable User Identity Module) to be inserted into a SIM/RUIM interface 3828 in order to communicate with a network. The SIM card/RUIM or 3826 is one type of a conventional “smart card” that can be used to identify a subscriber of the hand-held device 3800 and to personalize the hand-held device 3800, among other things. Without the SIM card/RUIM 3826, the hand-held device 3800 is not fully operational for communication with the wireless network 3805. By inserting the SIM card/RUIM 3826 into the SIM/RUIM interface 3828, a subscriber can access all subscribed services. Services may include: web browsing and messaging such as e-mail, voice mail, Short Message Service (SMS), and Multimedia Messaging Services (MMS). More advanced services may include: point of sale, field service and sales force automation. The SIM card/RUIM 3826 includes a processor and memory for storing information. Once the SIM card/RUIM 3826 is inserted into the SIM/RUIM interface 3828, the SIM is coupled to the main processor 3802. In order to identify the subscriber, the SIM card/RUIM 3826 can include some user parameters such as an International Mobile Subscriber Identity (IMSI). An advantage of using the SIM card/RUIM 3826 is that a subscriber is not necessarily bound by any single physical mobile device. The SIM card/RUIM 3826 may store additional subscriber information for the hand-held device 3800 as well, including datebook (or calendar) information and recent call information. Alternatively, user identification information can also be programmed into the flash memory 3808.

The hand-held device 3800 is a battery-powered device and includes a battery interface 3832 for receiving one or more batteries 3830. In one or more implementations, the battery 3830 can be a smart battery with an embedded microprocessor. The battery interface 3832 is coupled to a regulator 3833, which assists the battery 3830 in providing power V+ to the hand-held device 3800. Although current technology makes use of a battery, future technologies such as micro fuel cells may provide the power to the hand-held device 3800.

The hand-held device 3800 also includes an operating system 3834 and modules 3836 to 3849 which are described in more detail below. The operating system 3834 and the modules 3836 to 3849 that are executed by the main processor 3802 are typically stored in a persistent nonvolatile medium such as the flash memory 3808, which may alternatively be a read-only memory (ROM) or similar storage element (not shown). Those skilled in the art will appreciate that portions of the operating system 3834 and the modules 3836 to 3849, such as specific device applications, or parts thereof, may be temporarily loaded into a volatile store such as the RAM 3806. Other modules can also be included.

The subset of modules 3836 that control basic device operations, including data and voice communication applications, will normally be installed on the hand-held device 3800 during its manufacture. Other modules include a message application 3838 that can be any suitable module that allows a user of the hand-held device 3800 to transmit and receive electronic messages. Various alternatives exist for the message application 3838 as is well known to those skilled in the art. Messages that have been sent or received by the user are typically stored in the flash memory 3808 of the hand-held device 3800 or some other suitable storage element in the hand-held device 3800. In one or more implementations, some of the sent and received messages may be stored remotely from the hand-held device 3800 such as in a data store of an associated host system with which the hand-held device 3800 communicates.

The modules can further include a device state module 3840, a Personal Information Manager (PIM) 3842, and other suitable modules (not shown). The device state module 3840 provides persistence, i.e. the device state module 3840 ensures that important device data is stored in persistent memory, such as the flash memory 3808, so that the data is not lost when the hand-held device 3800 is turned off or loses power.

The PIM 3842 includes functionality for organizing and managing data items of interest to the user, such as, but not limited to, e-mail, contacts, calendar events, voice mails, appointments, and task items. A PIM application has the ability to transmit and receive data items via the wireless network 3805. PIM data items may be seamlessly integrated, synchronized, and updated via the wireless network 3805 with the hand-held device 3800 subscriber's corresponding data items stored and/or associated with a host computer system. This functionality creates a mirrored host computer on the hand-held device 3800 with respect to such items. This can be particularly advantageous when the host computer system is the hand-held device 3800 subscriber's office computer system.

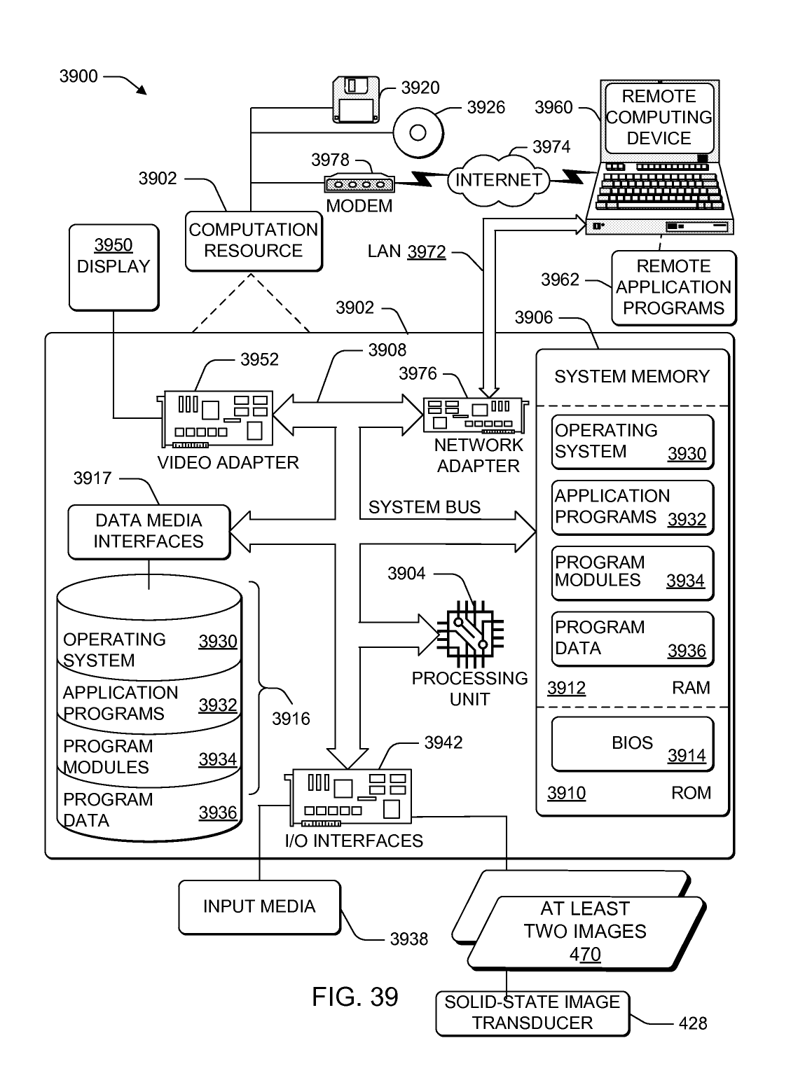

The hand-held device 3800 also includes a connect module 3844, and an IT policy module 3846. The connect module 3844 implements the communication protocols that are required for the hand-held device 3800 to communicate with the wireless infrastructure and any host system, such as an enterprise system, with which the hand-held device 3800 is authorized to interface. Examples of a wireless infrastructure and an enterprise system are given in FIGS. 38 and 39, which are described in more detail below.

The connect module 3844 includes a set of APIs that can be integrated with the hand-held device 3800 to allow the hand-held device 3800 to use any number of services associated with the enterprise system. The connect module 3844 allows the hand-held device 3800 to establish an end-to-end secure, authenticated communication pipe with the host system. A subset of applications for which access is provided by the connect module 3844 can be used to pass IT policy commands from the host system to the hand-held device 3800. This can be done in a wireless or wired manner. These instructions can then be passed to the IT policy module 3846 to modify the configuration of the hand-held device 3800. Alternatively, in some cases, the IT policy update can also be done over a wired connection.

The IT policy module 3846 receives IT policy data that encodes the IT policy. The IT policy module 3846 then ensures that the IT policy data is authenticated by the hand-held device 3800. The IT policy data can then be stored in the RAM 3806 in its native form. After the IT policy data is stored, a global notification can be sent by the IT policy module 3846 to all of the applications residing on the hand-held device 3800. Applications for which the IT policy may be applicable then respond by reading the IT policy data to look for IT policy rules that are applicable.

The IT policy module 3846 can include a parser 3847, which can be used by the applications to read the IT policy rules. In some cases, another module or application can provide the parser. Grouped IT policy rules, described in more detail below, are retrieved as byte streams, which are then sent (recursively) into the parser to determine the values of each IT policy rule defined within the grouped IT policy rule. In one or more implementations, the IT policy module 3846 can determine which applications are affected by the IT policy data and transmit a notification to only those applications. In either of these cases, for applications that are not being executed by the main processor 3802 at the time of the notification, the applications can call the parser or the IT policy module 3846 when the applications are executed to determine if there are any relevant IT policy rules in the newly received IT policy data.

All applications that support rules in the IT Policy are coded to know the type of data to expect. For example, the value that is set for the “WEP User Name” IT policy rule is known to be a string; therefore the value in the IT policy data that corresponds to this rule is interpreted as a string. As another example, the setting for the “Set Maximum Password Attempts” IT policy rule is known to be an integer, and therefore the value in the IT policy data that corresponds to this rule is interpreted as such.

After the IT policy rules have been applied to the applicable applications or configuration files, the IT policy module 3846 sends an acknowledgement back to the host system to indicate that the IT policy data was received and successfully applied.

The programs 3837 can also include a multimedia teleconference VOIP interface 3848 and a web browser 3849. In some implementations, the multimedia teleconference VOIP interface 3848 includes interfaces to at least one of the protocols described in section 2 herein.

Other types of modules can also be installed on the hand-held device 3800. These modules can be third party modules, which are added after the manufacture of the hand-held device 3800. Examples of third party applications include games, calculators, utilities, etc.

The additional applications can be loaded onto the hand-held device 3800 through of the wireless network 3805, the auxiliary I/O subsystem 3812, the data port 3814, the short-range communications subsystem 3822, or any other suitable device subsystem 3824. This flexibility in application installation increases the functionality of the hand-held device 3800 and may provide enhanced on-device functions, communication-related functions, or both. For example, secure communication applications may enable electronic commerce functions and other such financial transactions to be performed using the hand-held device 3800.

The data port 3814 enables a subscriber to set preferences through an external device or module and extends the capabilities of the hand-held device 3800 by providing for information or module downloads to the hand-held device 3800 other than through a wireless communication network. The alternate download path may, for example, be used to load an encryption key onto the hand-held device 3800 through a direct and thus reliable and trusted connection to provide secure device communication.

The data port 3814 can be any suitable port that enables data communication between the hand-held device 3800 and another computing device. The data port 3814 can be a serial or a parallel port. In some instances, the data port 3814 can be a USB port that includes data lines for data transfer and a supply line that can provide a charging current to charge the battery 3830 of the hand-held device 3800.

The short-range communications subsystem 3822 provides for communication between the hand-held device 3800 and different systems or devices, without the use of the wireless network 3805. For example, the short-range communications subsystem 3822 may include an infrared device and associated circuits and modules for short-range communication. Examples of short-range communication standards include standards developed by the Infrared Data Association (IrDA), Bluetooth, and the 802.11 family of standards developed by IEEE

Bluetooth is a wireless technology standard for exchanging data over short distances (using short-wavelength radio transmissions in the ISM band from 2400-2480 MHz) from fixed and mobile devices, creating personal area networks (PANs) with high levels of security. Created by telecom vendor Ericsson in 1994, Bluetooth was originally conceived as a wireless alternative to RS-232 data cables. Bluetooth can connect several devices, overcoming problems of synchronization. Bluetooth operates in the range of 2400-2483.5 MHz (including guard bands), which is in the globally unlicensed Industrial, Scientific and Medical (ISM) 2.4 GHz short-range radio frequency band. Bluetooth uses a radio technology called frequency-hopping spread spectrum. The transmitted data is divided into packets and each packet is transmitted on one of the 79 designated Bluetooth channels. Each channel has a bandwidth of 1 MHz. The first channel starts at 2402 MHz and continues up to 2480 MHz in 1 MHz steps. The first channel usually performs 2000 hops per second, with Adaptive Frequency-Hopping (AFH) enabled. Originally Gaussian frequency-shift keying (GFSK) modulation was the only modulation scheme available; subsequently, since the introduction of Bluetooth 2.0+EDR, π/4-DQPSK and 8DPSK modulation may also be used between compatible devices. Devices functioning with GFSK are said to be operating in basic rate (BR) mode where an instantaneous data rate of 1 Mbit/s is possible. The term Enhanced Data Rate (EDR) is used to describe π/4-DPSK and 8DPSK schemes, each giving 2 and 3 Mbit/s respectively. The combination of these (BR and EDR) modes in Bluetooth radio technology is classified as a “BR/EDR radio”. Bluetooth is a packet-based protocol with a master-slave structure. One master may communicate with up to 7 slaves in a piconet; all devices share the master's clock. Packet exchange is based on the basic clock, defined by the master, which ticks at 312.5 μs intervals. Two clock ticks make up a slot of 625 μs; two slots make up a slot pair of 1250 μs. In the simple case of single-slot packets the master transmits in even slots and receives in odd slots; the slave, conversely, receives in even slots and transmits in odd slots. Packets may be 1, 3 or 5 slots long but in all cases the master transmit will begin in even slots and the slave transmits in odd slots. A master Bluetooth device can communicate with a maximum of seven devices in a piconet (an ad-hoc computer network using Bluetooth technology), though not all devices reach this maximum. The devices can switch roles, by agreement, and the slave can become the master (for example, a headset initiating a connection to a phone will necessarily begin as master, as initiator of the connection; but may subsequently prefer to be slave). The Bluetooth Core Specification provides for the connection of two or more piconets to form a scatter net, in which certain devices simultaneously play the master role in one piconet and the slave role in another. At any given time, data can be transferred between the master and one other device (except for the little-used broadcast mode. The master chooses which slave device to address; typically, the master switches rapidly from one device to another in a round-robin fashion. Since the master chooses which slave to address, whereas a slave is (in theory) supposed to listen in each receive slot, being a master is a lighter burden than being a slave. Being a master of seven slaves is possible; being a slave of more than one master is difficult. Many of the services offered over Bluetooth can expose private data or allow the connecting party to control the Bluetooth device. For security reasons it is necessary to be able to recognize specific devices and thus enable control over which devices are allowed to connect to a given Bluetooth device. At the same time, it is useful for Bluetooth devices to be able to establish a connection without user intervention (for example, as soon as the Bluetooth devices of each other are in range). To resolve this conflict, Bluetooth uses a process called bonding, and a bond is created through a process called pairing. The pairing process is triggered either by a specific request from a user to create a bond (for example, the user explicitly requests to “Add a Bluetooth device”), or the pairing process is triggered automatically when connecting to a service where (for the first time) the identity of a device is required for security purposes. These two cases are referred to as dedicated bonding and general bonding respectively. Pairing often involves some level of user interaction; this user interaction is the basis for confirming the identity of the devices. Once pairing successfully completes, a bond will have been formed between the two devices, enabling those two devices to connect to each other in the future without requiring the pairing process in order to confirm the identity of the devices. When desired, the bonding relationship can later be removed by the user. Secure Simple Pairing (SSP): This is required by Bluetooth v2.1, although a Bluetooth v2.1 device may only use legacy pairing to interoperate with a v2.0 or earlier device. Secure Simple Pairing uses a form of public key cryptography, and some types can help protect against man in the middle, or MI™ attacks. SSP has the following characteristics: Just works: As implied by the name, this method just works. No user interaction is required; however, a device may prompt the user to confirm the pairing process. This method is typically used by headsets with very limited IO capabilities, and is more secure than the fixed PIN mechanism which is typically used for legacy pairing by this set of limited devices. This method provides no man in the middle (MITM) protection. Numeric comparison: If both devices have a display and can accept a binary Yes/No user input, both devices may use Numeric Comparison. This method displays a 6-digit numeric code on each device. The user should compare the numbers to ensure that the numbers are identical. If the comparison succeeds, the user(s) should confirm pairing on the device(s) that can accept an input. This method provides MI™ protection, assuming the user confirms on both devices and actually performs the comparison properly. Passkey Entry: This method may be used between a device with a display and a device with numeric keypad entry (such as a keyboard), or two devices with numeric keypad entry. In the first case, the display is used to show a 6-digit numeric code to the user, who then enters the code on the keypad. In the second case, the user of each device enters the same 6-digit number. Both of these cases provide MITM protection. Out of band (OOB): This method uses an external means of communication, such as Near Field Communication (NFC) to exchange some information used in the pairing process. Pairing is completed using the Bluetooth radio, but requires information from the OOB mechanism. This provides only the level of MITM protection that is present in the OOB mechanism. SSP is considered simple for the following reasons: In most cases, SSP does not require a user to generate a passkey. For use-cases not requiring MITM protection, user interaction can be eliminated. For numeric comparison. MITM protection can be achieved with a simple equality comparison by the user. Using OOB with NFC enables pairing when devices simply get close, rather than requiring a lengthy discovery process.

In use, a received signal such as a text message, an e-mail message, or web page download will be processed by the communication subsystem 3804 and input to the main processor 3802. The main processor 3802 will then process the received signal for output to the display 3810 or alternatively to the auxiliary I/O subsystem 3812. A subscriber may also compose data items, such as e-mail messages, for example, using the keyboard 3816 in conjunction with the display 3810 and possibly the auxiliary I/O subsystem 3812. The auxiliary I/O subsystem 3812 may include devices such as: a touch screen, mouse, track ball, infrared fingerprint detector, or a roller wheel with dynamic button pressing capability. The keyboard 3816 is preferably an alphanumeric keyboard and/or telephone-type keypad. However, other types of keyboards may also be used. A composed item may be transmitted over the wireless network 3805 through the communication subsystem 3804.

For voice communications, the overall operation of the hand-held device 3800 is substantially similar, except that the received signals are output to the speaker 3818, and signals for transmission are generated by the microphone 3820. Alternative voice or audio I/O subsystems, such as a voice message recording subsystem, can also be implemented on the hand-held device 3800. Although voice or audio signal output is accomplished primarily through the speaker 3818, the display 3810 can also be used to provide additional information such as the identity of a calling party, duration of a voice call, or other voice call related information.

FIG. 39 is a block diagram of a hardware and operating personal computer 3900 in which different implementations can be practiced. The description of FIG. 39 provides an overview of computer hardware and a suitable computing environment in conjunction with which some implementations can be implemented. Implementations are described in terms of a computer executing computer-executable instructions. However, some implementations can be implemented entirely in computer hardware in which the computer-executable instructions are implemented in read-only memory. Some implementations can also be implemented in client/server computing environments where remote devices that perform tasks are linked through a communications network. Program modules can be located in both local and remote memory storage devices in a distributed computing environment.

FIG. 39 illustrates an example of a personal computer 3900 useful in the context of the environment of FIG. 1-37, in accordance with an implementation. The personal computer 3900 includes a computation resource 3902 capable of implementing the processes described herein. It will be appreciated that other devices can alternatively be used that include more modules, or fewer modules, than those illustrated in FIG. 39.

The illustrated operating personal computer 3900 is only one example of a suitable operating environment, and the example described with reference to FIG. 39 is not intended to suggest any limitation as to the scope of use or functionality of the implementations of this disclosure. Other well-known computing systems, environments, and/or configurations can be suitable for implementation and/or application of the subject matter disclosed herein.

The computation resource 3902 includes one or more processors or processing units 3904, a system memory 3906, and a system bus 3908 that couples various system modules including the system memory 3906 to processing unit 3904 and other elements in the personal computer 3900. The system bus 3908 represents one or more of any of several types of bus structures, including a memory bus or memory controller, a peripheral bus, an accelerated graphics port and a processor or local bus using any of a variety of bus architectures, and can be compatible with SCSI (small computer system interconnect), or other conventional bus architectures and protocols.

The system memory 3906 includes nonvolatile read-only memory (ROM) 3910 and random access memory (RAM) 3912, which can or can not include volatile memory elements. A basic input/output system (BIOS) 3914, containing the elementary routines that help to transfer information between elements within computation resource 3902 and with external items, typically invoked into operating memory during start-up, is stored in ROM 3910.

The computation resource 3902 further can include a non-volatile read/write memory 3916, represented in FIG. 39 as a hard disk drive, coupled to system bus 3908 via a data media interface 3917 (e.g., a SCSI, ATA, or other type of interface); a magnetic disk drive (not shown) for reading from, and/or writing to, a removable magnetic disk 3920 and an optical disk drive (not shown) for reading from, and/or writing to, a removable optical disk 3926 such as a CD, DVD, or other optical media.

The non-volatile read/write memory 3916 and associated computer-readable media provide nonvolatile storage of computer-readable instructions, data structures, program modules and other data for the computation resource 3902. Although the personal computer 3900 is described herein as employing a non-volatile read/write memory 3916, a removable magnetic disk 3920 and a removable optical disk 3926, it will be appreciated by those skilled in the art that other types of computer-readable media which can store data that is accessible by a computer, such as magnetic cassettes, FLASH memory cards, random access memories (RAMs), read only memories (ROM), and the like, can also be used in the exemplary operating environment.

A number of program modules can be stored via the non-volatile read/write memory 3916, removable magnetic disk 3920, removable optical disk 3926, ROM 3910, or RAM 3912, including an operating system 3930, one or more application programs 3932, program modules 3934 and program data 3936. Examples of computer operating systems conventionally employed include the NUCLEUS® operating system, the LINUX® operating system, and others, for example, providing capability for supporting application programs 3932 using, for example, code modules written in the C++® computer programming language. The application programs 3932 and/or the program modules 3934 can also include a VOIP application program, such as Skype™ and can also include a multimedia teleconference VOIP interface.

A user can enter commands and information into computation resource 3902 through input devices such as input media 3938 (e.g., keyboard/keypad, tactile input or pointing device, mouse, foot-operated switching apparatus, joystick, touchscreen or touchpad, microphone, antenna etc.). Such input media 3938 are coupled to the processing unit 3904 through a conventional input/output interface 3942 that is, in turn, coupled to the system bus 3908. Display 3950 or other type of display device is also coupled to the system bus 3908 via an interface, such as a video adapter 3952.

The computation resource 3902 can include capability for operating in a networked environment using logical connections to one or more remote computers, such as a remote computer 3960. The remote computer 3960 can be a personal computer, a server, a router, a network PC, a peer device or other common network node, and typically includes many or all of the elements described above relative to the computation resource 3902. In a networked environment, program modules depicted relative to the computation resource 3902, or portions thereof, can be stored in a remote memory storage device such as can be associated with the remote computer 3960. By way of example, remote application programs 3962 reside on a memory device of the remote computer 3960. The logical connections represented in FIG. 39 can include interface capabilities, e.g., such as interface capabilities in FIG. 16, a storage area network (SAN, not illustrated in FIG. 39), local area network (LAN) 3972 and/or a wide area network (WAN) 3974, but can also include other networks.

Such networking environments are commonplace in modern computer systems, and in association with intranets and the Internet. In certain implementations, the computation resource 3902 executes an Internet Web browser program (which can optionally be integrated into the operating system 3930), such as the “Internet Explorer®” Web browser manufactured and distributed by the Microsoft Corporation of Redmond, Wash.

When used in a LAN-coupled environment, the computation resource 3902 communicates with or through the local area network 3972 via a network interface or adapter 3976 and typically includes interfaces, such as a modem 3978, or other apparatus, for establishing communications with or through the WAN 3974, such as the Internet. The modem 3978, which can be internal or external, is coupled to the system bus 3908 via a serial port interface.

In a networked environment, program modules depicted relative to the computation resource 3902, or portions thereof, can be stored in remote memory apparatus. It will be appreciated that the network connections shown are exemplary, and other means of establishing a communications link between various computer systems and elements can be used.

A user of a computer can operate in a networked environment using logical connections to one or more remote computers, such as a remote computer 3960, which can be a personal computer, a server, a router, a network PC, a peer device or other common network node. Typically, a remote computer 3960 includes many or all of the elements described above relative to the personal computer 3900 of FIG. 39.

The computation resource 3902 typically includes at least some form of computer-readable media. Computer-readable media can be any available media that can be accessed by the computation resource 3902. By way of example, and not limitation, computer-readable media can comprise computer storage media and communication media.

Computer storage media include volatile and nonvolatile, removable and non-removable media, implemented in any method or technology for storage of information, such as computer-readable instructions, data structures, program modules or other data. The term “computer storage media” includes, but is not limited to, RAM, ROM, EEPROM, FLASH memory or other memory technology, CD, DVD, or other optical storage, magnetic cassettes, magnetic tape, magnetic disk storage or other magnetic storage devices, or any other media which can be used to store computer-intelligible information and which can be accessed by the computation resource 3902.

Communication media typically embodies computer-readable instructions, data structures, program modules or other data, represented via, and determinable from, a modulated data signal, such as a carrier wave or other transport mechanism, and includes any information delivery media. The term “modulated data signal” means a signal that has one or more of its characteristics set or changed in such a manner as to encode information in the signal in a fashion amenable to computer interpretation.

By way of example, and not limitation, communication media include wired media, such as wired network or direct-wired connections, and wireless media, such as acoustic, RF, infrared and other wireless media. The scope of the term computer-readable media includes combinations of any of the above.

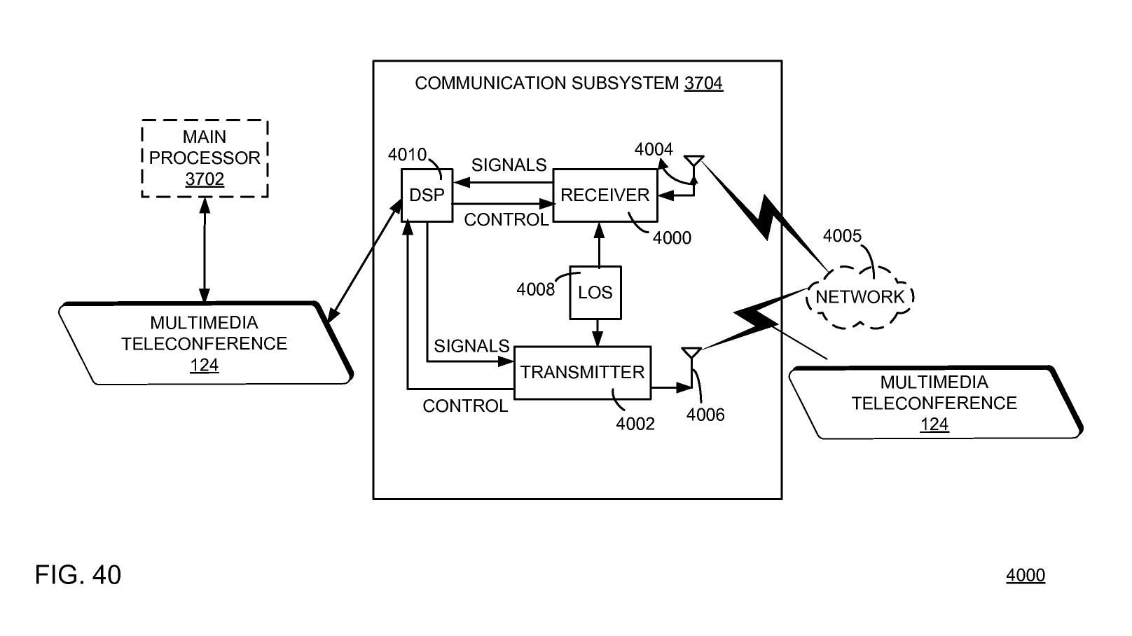

FIG. 40 is a block diagram of the wireless communication subsystem 3804, according to an implementation. The wireless communication subsystem 3804 includes a receiver 4000, a transmitter 4002, as well as associated components such as one or more embedded or antennas 4004 and 4006, Local Oscillators (LOs) 4008, and a processing module such as a digital signal processor (DSP) 4010. The particular implementation of the wireless communication subsystem 3804 is dependent upon communication protocols of a wireless network 4005 with which the mobile device is intended to operate. Thus, it should be understood that the implementation illustrated in FIG. 40 serves only as one example. Examples of the wireless network 4005 include network 3805 in FIG. 38.

Signals received by the antenna 4004 through the wireless network 4005 are input to the receiver 4000, which may perform such common receiver functions as signal amplification, frequency down conversion, filtering, channel selection, and analog-to-digital (A/D) conversion. A/D conversion of a received signal allows more complex communication functions such as demodulation and decoding to be performed in the DSP 4010. In a similar manner, signals to be transmitted are processed, including modulation and encoding, by the DSP 4010. These DSP-processed signals are input to the transmitter 4002 for digital-to-analog (D/A) conversion, frequency up conversion, filtering, amplification and transmission over the wireless network 4005 via the antenna 4006. The DSP 4010 not only processes communication signals, but also provides for receiver and transmitter control. For example, the gains applied to communication signals in the receiver 4000 and the transmitter 4002 may be adaptively controlled through automatic gain control algorithms implemented in the DSP 4010.

The wireless link between the hand-held device 3800 and the wireless network 4005 can contain one or more different channels, typically different RF channels, and associated protocols used between the hand-held device 3800 and the wireless network 4005. An RF channel is a limited resource that must be conserved, typically due to limits in overall bandwidth and limited battery power of the hand-held device 3800.

When the hand-held device 3800 is fully operational, the transmitter 4002 is typically keyed or turned on only when it is transmitting to the wireless network 4005 and is otherwise turned off to conserve resources. Similarly, the receiver 4000 is periodically turned off to conserve power until the receiver 4000 is needed to receive signals or information (if at all) during designated time periods.

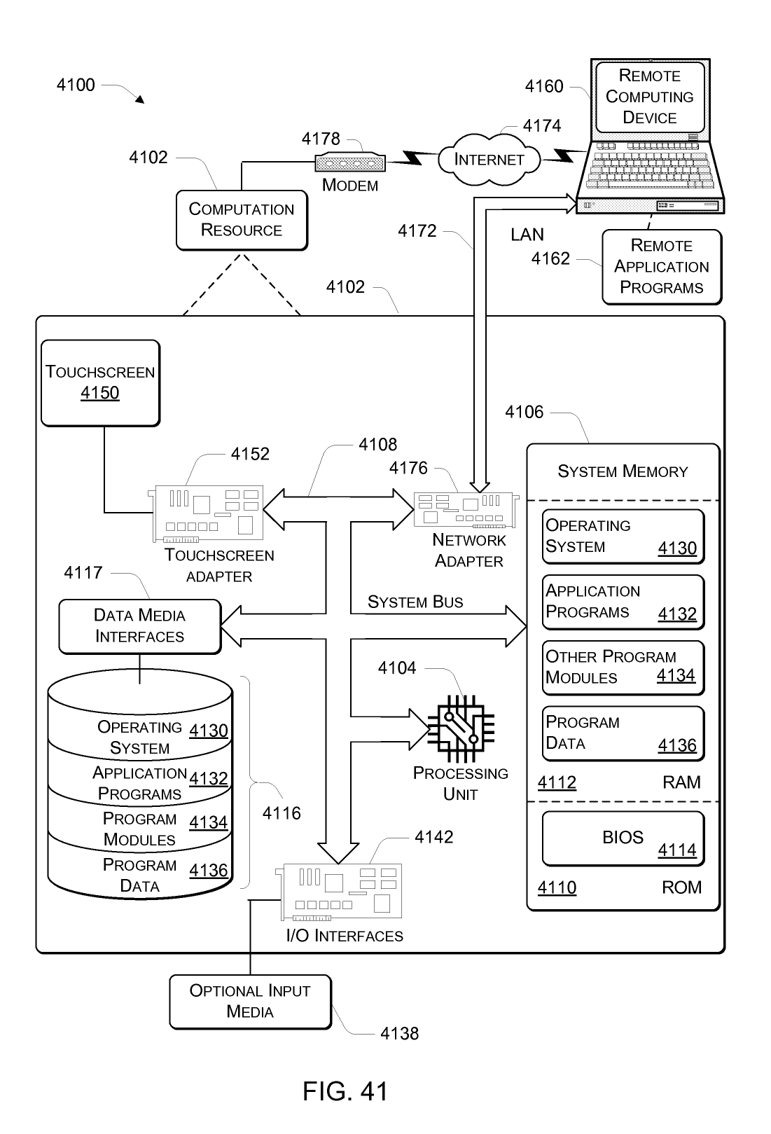

FIG. 41 is a block diagram of a tablet computer 4100, according to an implementation. The description of FIG. 41 provides an overview of computer hardware and a suitable computing environment in conjunction with which some implementations can be implemented. Implementations are described in terms of a computer executing computer-executable instructions. However, some implementations can be implemented entirely in computer hardware in which the computer-executable instructions are implemented in read-only memory. Some implementations can also be implemented in client/server computing environments where remote devices that perform tasks are linked through a communications network. Program modules can be located in both local and remote memory storage devices in a distributed computing environment.

FIG. 41 illustrates an example of a tablet computer 4100 useful in the context of the processes and components in FIGS. 1-37, in accordance with an implementation. The tablet computer 4100 includes a computation resource 4102 capable of implementing the processes described herein. It will be appreciated that other devices can alternatively used that include more components, or fewer components, than those illustrated in FIG. 41.

The illustrated tablet computer 4100 is only one example of a suitable operating environment, and the example described with reference to FIG. 41 is not intended to suggest any limitation as to the scope of use or functionality of the implementations of this disclosure. Other well-known computing systems, environments, and/or configurations can be suitable for implementation and/or application of the subject matter disclosed herein.

The computation resource 4102 includes one or more processors or processing units 4104, a system memory 4106, and a bus 4108 that couples various system components including the system memory 4106 to processors or processing units 4104 and other elements in the tablet computer 4100. The bus 4108 represents one or more of any of several types of bus structures, including a memory bus or memory controller, a peripheral bus, an accelerated graphics port and a processor or local bus using any of a variety of bus architectures, and can be compatible with SCSI (small computer system interconnect), or other conventional bus architectures and protocols.

The system memory 4106 includes nonvolatile read-only memory (ROM) 4110 and random access memory (RAM) 4112, which can or can not include volatile memory elements. A basic input/output system (BIOS) 4114, containing the elementary routines that help to transfer information between elements within computation resource 4102 and with external items, typically invoked into operating memory during start-up, is stored in ROM 4110.

The tablet computer 4100 further can include a FLASH memory 4116 that is coupled to bus 4108 via a data media interface 4117 (e.g., a SCSI, ATA, or other type of interface); a magnetic disk drive (not shown) for reading from, and/or writing to, a removable magnetic disk (not shown) and an optical disk drive (not shown) for reading from, and/or writing to, a removable optical disk (not shown) such as a CD, DVD, or other optical media.

The FLASH memory 4116 and associated computer-readable media provide nonvolatile storage of computer-readable instructions, data structures, program modules and other data for the computation resource 4102.

A number of program modules can be stored via the FLASH memory 4116, magnetic disk (not shown), optical disk (not shown), ROM 4110, or RAM 4112, including an operating system 4130, one or more application programs 4132, other program modules 4134 and program data 4136. Examples of computer operating systems conventionally employed include the NUCLEUS® operating system, the LINUX® operating system, and others, for example, providing capability for supporting application programs 4132 using, for example, code modules written in the C++® computer programming language. The application programs 4132 and/or the program modules 3934 can also include a VOIP application program, such as Skype™ and can also include a multimedia teleconference VOIP interface.

A user can optionally enter commands and information into computation resource 4102 through input devices such as external input media 4138 (e.g., keyboard/keypad, tactile input or pointing device, mouse, foot-operated switching apparatus, joystick, touchscreen or touchpad, microphone, antenna etc.). Such input devices 4138 are coupled to the processors or processing units 4104 through a conventional input/output interface 4142 that is, in turn, coupled to the system bus. A touchscreen 4150 or other type of display device is also coupled to the system bus 4108 via an interface, such as a touchscreen adapter 4152.

The computation resource 4102 can include capability for operating in a networked environment using logical connections to one or more remote computers, such as a remote computer 4160. The remote computer 4160 can be a personal computer, a server, a router, a network PC, a peer device or other common network node, and typically includes many or all of the elements described above relative to the computation resource 4102. In a networked environment, program modules depicted relative to the computation resource 4102, or portions thereof, can be stored in a remote memory storage device such as can be associated with the remote computer 4160. By way of example, remote application programs 4162 reside on a memory device of the remote computer 4160. The logical connections represented in FIG. 41 can include interface capabilities, e.g., such as interface capabilities in FIG. 7, a storage area network (SAN, not illustrated in FIG. 41), local area network (LAN) 4172 and/or a wide area network (WAN) 4174, but can also include other networks.

Such networking environments are commonplace in modern computer systems, and in association with intranets and the Internet. In certain implementations, the computation resource 4102 executes an Internet Web browser program (which can optionally be integrated into the operating system 4130), such as the “Internet Explorer®” Web browser manufactured and distributed by the Microsoft Corporation of Redmond, Wash. When used in a LAN-coupled environment, the computation resource 4102 communicates with or through the local area network 4172 via a network interface or adapter 4176. When used in a WAN-coupled environment, the computation resource 4102 typically includes interfaces, such as a modem 4178, or other apparatus, for establishing communications with or through the WAN 4174, such as the Internet. The modem 4178, which can be internal or external, is coupled to the system bus 4108 via a serial port interface. In a networked environment, program modules depicted relative to the computation resource 4102, or portions thereof, can be stored in remote memory apparatus. It will be appreciated that the network connections shown are exemplary, and other means of establishing a communications link between various computer systems and elements can be used. A user of a computer can operate in a networked environment using logical connections to one or more remote computers, such as a remote computer 4160, which can be a personal computer, a server, a router, a network PC, a peer device or other common network node. Typically, a remote computer 4160 includes many or all of the elements described above relative to the tablet computer 4100 of FIG. 41. The computation resource 4102 typically includes at least some form of computer-readable media. Computer-readable media can be any available media that can be accessed by the computation resource 4102. By way of example, and not limitation, computer-readable media can comprise computer storage media and communication media. Computer storage media include volatile and nonvolatile, removable and non-removable media, implemented in any method or technology for storage of information, such as computer-readable instructions, data structures, program modules or other data. The term “computer storage media” includes, but is not limited to, RAM, ROM, EEPROM, FLASH memory or other memory technology, CD, DVD, or other optical storage, magnetic cassettes, magnetic tape, magnetic disk storage or other magnetic storage devices, or any other media which can be used to store computer-intelligible information and which can be accessed by the computation resource 4102. The computer 4102 can function as one or more of the control segments, via implementation of the processes and components in FIGS. 1-35, respectively, as one or more computer program modules.

### 7. CONCLUSION

A real-time multimedia teleconference system is disclosed herein. A technical effect of the apparatus and methods disclosed herein is near-immediate connectively between an initiator of the multimedia teleconference and another party to the multimedia teleconference. Another technical effect of the apparatus and methods disclosed herein is selection of multimedia teleconference based on the technical and performance capabilities of the two computer systems that will participate in the multimedia teleconference. Although specific implementations are illustrated and described herein, it will be appreciated by those of ordinary skill in the art that any arrangement which is generated to achieve the same purpose may be substituted for the specific implementations shown. This application is intended to cover any adaptations or variations.

In particular, one of skill in the art will readily appreciate that the names of the methods and apparatus are not intended to limit implementations. Furthermore, additional methods and apparatus can be added to the modules, functions can be rearranged among the modules, and new modules to correspond to future enhancements and physical devices used in implementations can be introduced without departing from the scope of implementations. One of skill in the art will readily recognize that implementations are applicable to future non-touch temperature sensing devices, different temperature measuring sites on humans or animals and new display devices.

The terminology used in this application meant to include all temperature sensors, processors and operator environments and alternate technologies which provide the same functionality as described herein.

1. A device comprising:
a detector of a plurality of capabilities of each of a plurality of heterogeneous computing systems, the plurality of capabilities of each of the plurality of heterogeneous computing systems including a model, existence of a microphone, video controls, specifications of a camera, a processor speed, a bus speed, an amount of cache memory, an amount of non-cache memory, a telecom carrier and an operating system;
a determiner of a minimum sufficiency of the plurality of capabilities of the each of the plurality of heterogeneous computing systems; the determiner being operably coupled to the detector, the determiner being operable to set a state in a memory location indicating an affirmative or a negative state of the minimum sufficiency of the plurality of capabilities of the each of the plurality of heterogeneous computing systems;
an initiator of a multimedia teleconference between the heterogeneous computing systems, the initiator being operably coupled to the codec and the determiner, the initiator being operable to initiate the multimedia teleconference via Session Initiation Protocol (SIP) in reference to the memory location indicating an affirmative or a negative state of the minimum sufficiency of the plurality of capabilities of the each of the plurality of heterogeneous computing systems, the multimedia teleconference employing Session Description Protocol (SDP), Real-time Transport Protocol (RTP) and Secure Real-time Transport Protocol (SRTP), the multimedia teleconference selected from a group consisting of a teleconference in conformity with an MPEG standard and a teleconference in conformance with a VOIP standard.

2. A device comprising:
a detector of a plurality of capabilities of each of a plurality of heterogeneous computing systems, the plurality of capabilities of each of the plurality of heterogeneous computing systems including a model, existence of a microphone, video controls, specifications of a camera, a processor speed, a bus speed, an amount of cache memory, an amount of non-cache memory, a telecom carrier and an operating system;
a determiner of a minimum sufficiency of the plurality of capabilities of the each of the plurality of heterogeneous computing systems; the determiner being operably coupled to the detector, the determiner being operable to set a state in a memory location indicating an affirmative or a negative state of the minimum sufficiency of the plurality of capabilities of the each of the plurality of heterogeneous computing systems;
an initiator of a multimedia teleconference between the heterogeneous computing systems, the initiator being operably coupled to the codec and the determiner, the initiator being operable in reference to the memory location indicating an affirmative or a negative state of the minimum sufficiency of the plurality of capabilities of the each of the plurality of heterogeneous computing systems, the multimedia teleconference in conformance with a VOIP standard.
